(19) United States
(12) Patent Application Publication
(10) Pub. No.: US 2025/0378436 A1
(43) Pub. Date: Dec. 11, 2025

(54) METHODS AND SYSTEMS FOR FACILITATING COLLECTION OF ROAD USER CHARGES USING A DIGITAL CURRENCY BASED ON A DISTRIBUTED LEDGER TECHNOLOGY

(71) Applicant: Taylor William Paul Lochrane, Washington, DC (US)

(72) Inventor: Taylor William Paul Lochrane, Washington, DC (US)

(21) Appl. No.: 19/309,277

(22) Filed: Aug. 25, 2025

Related U.S. Application Data
(63) Continuation-in-part of application No. 18/173,631, filed on Feb. 23, 2023.
Application No. 18/173,631 is a continuation-in-part of application No. 17/829,748, filed on Jun. 1, 2022, now abandoned.
(60) Provisional application No. 63/209,109, filed on Jun. 10, 2021.

(51) Int. Cl. G06Q 20/36

(52) U.S. Cl. CPC G06Q 20/367; G06Q 2240/00

(57) ABSTRACT

A system and method for facilitating collection of Road User Charges (RUC) using a digital currency within a Distributed Ledger Technology (DLT) network are disclosed. The system generates secure digital wallets for Road Users and Facility Owners, receives trip, position, distance, and cost data from vehicles, sensors, and facility systems, and encodes settlement logic into smart contracts. These contracts automatically execute jurisdiction-specific disbursements across blockchain, directed acyclic graph (DAG), or hashgraph frameworks, ensuring scalability and auditability without reliance on centralized tolling infrastructure. An AI Activity Module processes multi-source telemetry—including vehicle sensors, GNSS/PNT data, roadside infrastructure, and third-party traffic feeds—to detect congestion, forecast conditions, optimize routing, and dynamically adjust segment-level RUC pricing in real time. The integration of AI-driven adaptive pricing with distributed ledger settlement provides a decentralized, infrastructure-agnostic framework for secure, transparent, and verifiable road use fee collection across multiple jurisdictions, distinct from conventional tolling systems.

### FIELD OF THE INVENTION

The present invention relates generally to data processing. More specifically, the present invention includes methods and systems for facilitating the collection of a Road User Charges (RUC) using a digital currency based on a Distributed Ledger Technology (DLT).

### BACKGROUND OF THE INVENTION

The field of data processing is technologically important to multiple industries, government agencies, and individual users.

In the United States and globally, roadway funding is predominantly derived from federal, state, and local motor fuel taxes, commonly referred to as the “gas tax.” This tax model assumes petroleum-based fuel consumption. As alternative vehicle energy sources—such as biodiesel, electricity, ethanol, hydrogen, natural gas, and propane—become more prevalent, no universal system exists to collect equivalent road-use fees from vehicles that do not consume petroleum fuels.

Current techniques for collecting road-use fees are deficient in multiple respects. They fail to provide a standardized method for charging vehicles using non-petroleum energy sources and do not facilitate the use of a digital currency normalized across all propulsion types. Furthermore, traditional tolling systems are geographically fixed and infrastructure-dependent, relying on physical assets such as toll plazas or gantries to assess fees for specific, limited-access roads. These systems are static, centralized, and constrained to predefined facilities, often under the control of a single jurisdiction or toll authority.

In contrast, the present invention introduces a decentralized, infrastructure-agnostic framework for assessing and collecting Road User Charges (RUC)—also known as Vehicle Miles Traveled (VMT) fees, Mileage-Based User Fees (MBUF), Road Pricing, and similar terms—across any roadway in any jurisdiction. Each trip is algorithmically segmented into jurisdiction-specific segments, and digital currency is transferred to each facility owner's digital wallet through smart contracts executed on a Distributed Ledger Technology (DLT) network. This architecture enables global applicability, supporting both fixed and variable pricing models, including congestion-based and time-of-day rates, without the geographic or infrastructure limitations of tolling.

The disclosed system is not bound to a single ledger type but operates across multiple distributed ledger paradigms—including blockchain, directed acyclic graph (DAG) ledgers, and hashgraph frameworks. Each of these technologies provides a distinct consensus pathway, yet all are integrated into the same RUC settlement architecture to achieve secure, auditable, and scalable disbursement across jurisdictions.

To further enhance settlement and compliance, an artificial intelligence (AI) activity module may perform predictive fuel and road-use modeling, congestion forecasting, route optimization, and multi-jurisdictional payment routing. The AI component can analyze multi-source telemetry—including vehicle sensors, GNSS or complementary PNT data, roadside infrastructure feeds, and third-party traffic APIs—in real time to dynamically adjust segment-level RUC pricing and settlement. This AI-enhanced capability enables peer-to-peer compliance, proactive congestion management, and automated, jurisdiction-aware settlement without reliance on a centralized toll authority.

Accordingly, an objective of the present invention is to provide a method and system for facilitating the collection of road-use fees using a digital currency based on a DLT network. Another objective is to support trip-based segmentation and multi-jurisdictional payment routing using AI-enhanced smart contracts, enabling multiple facility owners to receive digital payments for road usage associated with their respective segments in real time or through post-trip settlement.

However, existing RUC and tolling systems often rely on centralized billing, manual reporting, or generic blockchain transactions. These approaches suffer from high latency, excessive communication overhead, and an inability to operate efficiently on resource-constrained in-vehicle devices. Prior systems also fail to provide bounded memory and latency performance guarantees, nor do they enable compact cryptographic proofs that can be verified in real time on constrained hardware. Accordingly, there is a technical need for a system and method that securely facilitates RUC collection by managing jurisdiction-specific digital currency transactions with bounded memory, bounded latency, and cryptographic verification across multiple forms of distributed ledger technology, including blockchain, DAG, and hashgraph implementations.

### SUMMARY OF THE INVENTION

The following description provides details of embodiments of the invention, which should not be interpreted as limiting the scope of the claimed subject matter. Where possible, like reference numbers are used to identify similar elements.

In general, the invention discloses a computer-implemented Road User Charging (RUC) Application for securely collecting and disbursing digital currency payments across jurisdictions using a distributed ledger technology (DLT) framework. The RUC Application may be deployed on in-vehicle hardware, mobile devices, roadside units, fueling/charging platforms, or cloud and edge servers.

The RUC Application comprises a set of coordinated software components, including:
a Trip Manager configured to segment trips into jurisdiction-specific portions using sensor fusion, GNSS or complementary Position, Navigation, and Timing (PNT) sources, odometer readings, inertial measurement unit (IMU) inputs, and map-matching algorithms;
a Coin Manager configured to calculate segment-specific charges using static, variable, or dynamic pricing policies, incorporating artificial intelligence (AI) and machine learning (ML) models such as recurrent neural networks for congestion forecasting, convolutional neural networks for roadway imaging, reinforcement learning agents for dynamic pricing, and gradient boosting methods for rate optimization;
a Trip Calculator configured to aggregate real-time segment costs, predict future digital currency requirements, and initiate wallet refill alerts based on usage patterns, fueling/charging behavior, or time-of-day conditions;
a Contract Manager configured to generate deterministic, fixed-size smart contracts incorporating explicit fields (segment ID, geofence hash, route commitment, rate version, calculated amount, timestamp, nonce), digitally sign the contracts using hardware-secured cryptographic keys, and transmit the contracts to the DLT network for execution and verification.
   The Contract Manager may also generate multi-party smart contracts that encode proportional disbursement logic to multiple Facility Owner wallets based on jurisdictional boundaries crossed during a trip, ensuring jurisdiction-specific settlement without reliance on a central clearinghouse.
a Fuel Manager configured to record fueling or charging events, including energy type, volume, and estimated tax; to calculate RUC token equivalents where motor fuel tax is absent or deferred; and to synchronize fueling data with Trip Manager and Coin Manager modules for settlement. This enables the system to incorporate fuel and energy purchases directly into the digital RUC accounting framework.

The invention supports integration with a Trip Exchange platform and fueling/charging station platforms. The Trip Exchange allows conversion between fiat currency and Road User Digital Currency (RUDC), while fueling or charging stations may automatically record fuel or energy purchases, calculate corresponding RUC obligations, and log events to the distributed ledger. In this way, Road Users may acquire RUC currency during fueling or charging events or via a dedicated exchange, ensuring flexible and inclusive participation.

The invention supports multi-layered execution and verification infrastructure, including in-vehicle processors, roadside edge devices, fog computing nodes, and cloud computing platforms. Smart contracts may be generated locally and cross-validated across tiers using Byzantine fault-tolerant consensus, ensuring resilience, fault tolerance, and regulatory integrity.

To ensure robust operation in the presence of intermittent connectivity, the RUC Application further supports offline caching and peer-to-peer synchronization of smart contracts. Cached contracts are stored in encrypted form with secure-boot validation, enabling tamper-evident resubmission to the DLT network once connectivity is restored.

In some embodiments, the invention allows Road Users to initiate manual trip submissions from Approved Designated Locations (ADLs). ADLs may be kiosks, fueling stations, or certified mobile applications where users can report trip details, which are validated by the system and transformed into corresponding smart contracts. At an ADL, the system may connect to the RUC Rates Service to calculate charges, and to the Trip Exchange platform to issue digital currency for Road Users without pre-existing wallets, ensuring inclusivity for manual or offline participation.

The invention further includes Graphical User Interfaces (GUIs) for transparency and user control. The Road User interface may present a real-time digital map displaying jurisdictional boundaries, segment-level costs, current wallet balances, upcoming handoffs to facility owners, and historical transaction logs. The digital map may further display applicable RUC rates per jurisdictional segment, enabling users to visualize cost implications in real time. Each smart contract execution is displayed visibly to the user, ensuring auditability and transparency. The Facility Owner interface provides jurisdiction-level dashboards, including revenue reports, traffic segmentation data, and regulator-facing attestations. These attestations may be presented through authenticated APIs and verified via zero-knowledge proofs or homomorphic encryption, thereby enabling compliance verification without revealing individual trip details.

All communications between devices, nodes, and ledgers are secured using multi-protocol options including cellular, Wi-Fi, telematics channels (LTE/5G/6G), and V2X standards such as C-V2X or 5G-V2X, with end-to-end protection using TLS, IPSec, or authenticated encryption with associated data (AEAD).

Each transaction is cryptographically signed, immutably recorded in the DLT ledger, and verified using compact cryptographic proofs constrained to ≤S bytes in size. These bounded proof structures enable validation on resource-constrained in-vehicle processors, while compact settlement proofs (e.g., Merkle, Verkle, or vector commitments) reduce gas cost and latency across blockchain, DAG, and hashgraph frameworks. Consensus verification may be achieved via Byzantine Fault Tolerant (BFT) protocols, proof-of-stake validation, DAG milestone confirmations, or hashgraph gossip and virtual voting, with compact proof structures ensuring efficient validation.

Collectively, these features enable a scalable, interoperable, and regulator-compliant RUC framework that operates in real time, supports dynamic policy enforcement, preserves user privacy, and ensures accurate jurisdictional disbursement of road use fees across heterogeneous distributed ledger infrastructures.

### BRIEF DESCRIPTION OF THE DRAWINGS

The accompanying drawings, which are incorporated in and constitute a part of this disclosure, illustrate various embodiments of the present disclosure. The drawings contain representations of various trademarks and copyrights owned by the Applicants. In addition, the drawings may contain other marks owned by third parties and are being used for illustrative purposes only. All rights to various trademarks and copyrights represented herein, except those belonging to their respective owners, are vested in and the property of the applicants. The applicants retain and reserve all rights in their trademarks and copyrights included herein, and grant permission to reproduce the material only in connection with reproduction of the granted patent and for no other purpose.

Furthermore, the drawings may contain text or captions that may explain certain embodiments of the present disclosure. This text is included for illustrative, non-limiting, explanatory purposes of certain embodiments detailed in the present disclosure.

FIG. 1A flowchart illustrating the overall process for collecting Road User Charges (RUC) using a digital currency over a DLT network, starting from data receipt to transaction storage on the ledger.

FIG. 2A block diagram of a DLT node's architecture showing communication, processing, input/output, and storage components used for implementing the RUC system.

FIG. 2a A flow diagram of the AI-Enhanced Real-Time Traffic and Dynamic RUC Optimization Process showing steps from traffic condition detection to post-trip cost recalculation for automated DLT settlement.

FIG. 3A schematic overview of how various entities (Road User, Fuel Station, Facility Owner, ADL) interact via DLT and the Trip Exchange Platform to process RUC.

FIG. 3a. A block diagram of the AI Activity Module integrated with the Road User RUC Application, illustrating data flows from input devices through AI process components to RUC management modules and external DLT services.

FIG. 4A detailed system diagram of the Trip Exchange platform architecture for Road Users and Facility Owners, including wallet management, exchange engines, and DLT interface components.

FIG. 5A decision-based flow diagram outlining how RUC is applied at the fuel station during a fueling event, with branching logic for fuel tax vs. RUC and smart contract execution.

FIG. 6A component architecture showing how fuel data is processed by Fuel Manager, Coin Manager, and Contract Manager across vehicle/mobile and station platforms to generate a RUC smart contract.

FIG. 7A parallel system architecture for the fuel station and vehicle platforms showing how RUC-related data is captured, processed, and submitted to DLT including offline ADL submissions.

FIG. 8A flowchart for receiving trip distance data, facility cost data, and retrieving Coin Manager and Trip Calculator data for dynamic pricing.

FIG. 9A component diagram of the Road User platform showing all major modules (Trip Manager, Calculator, Coin Manager, Contract Manager) and how they interface with facility and DLT systems.

FIG. 10A logic flow within the Road User Trip Manager for creating and managing trip segments, identifying facility changes, calculating RUC costs per segment, and generating/submitting smart contracts.

FIG. 11A fully-integrated system diagram showing how trip segments are routed to corresponding facility owners through digital currency-based smart contracts and how balances are distributed and audited.

FIG. 12A user interface screenshot from the Road User platform showing a digital map with trip data, wallet balance, trip statistics, and cost breakdown across segments and authorities

FIG. 13A Facility Owner GUI interface showing pricing control tools, rate setting (fixed/dynamic), segment-level earnings, and transaction logs.

FIG. 14A system diagram for Facility Owner infrastructure including RUC receipt monitoring, pricing management, local validation, telemetry capture, and allocation of received RUDC funds.

FIG. 15A schematic of the RUC rate management ecosystem showing the Rate Publisher, Rule Resolver, Versioning Engine, and validation of rate queries on the DLT.

FIG. 16A flowchart describing the subprocess for receiving a payment alert, crediting the Road User digital wallet, and transmitting a transfer alert to both user and Facility Owner.

FIG. 17A functional diagram of an ADL-based RUC Application system for submitting trip data manually, verifying it, generating smart contracts, and executing digital currency-based transfers.

FIG. 18A conceptual block diagram of the RUC system showing DLT nodes, edge devices, data sources, entity accounts, and smart contract components in a connected architecture.

FIG. 19A high-level block diagram of the computing infrastructure supporting the RUC system across Road Users, Facility Owners, Fuel Stations, and ADLs, including memory, OS, and DLT nodes.

FIGS. 20A-20C illustrate alternative distributed ledger settlement pathways.

FIG. 20A shows a blockchain flow where smart contracts are recorded into sequential blocks validated by consensus and secured with Merkle proofs.

FIG. 20B shows a DAG flow where transactions reference tips and are finalized by milestone confirmation.

FIG. 20C shows a hashgraph flow where transactions propagate by gossip protocols, achieve consensus through virtual voting, and finalize with state proofs.

In each embodiment, the inventive concept remains the same: Road User Charges (RUC) are calculated, encoded into smart contracts, transmitted to the distributed ledger, and immutably disbursed to Facility Owner wallets, with the underlying ledger technology adaptable to jurisdictional, performance, or policy requirements.

In certain embodiments, the following parameters define technical performance bounds and resource constraints of the disclosed Road User Charge (RUC) system. These variables provide measurable thresholds to ensure reproducibility, efficiency, and deterministic operation across distributed implementations:
Q—maximum memory capacity (kilobytes) allocated to Trip Manager buffers (e.g., segment metadata ring buffer).
T—processing latency threshold (milliseconds) for per-fix computations such as map-matching, sensor fusion, or AI/ML inference.
α—accuracy target (percentage) for AI/ML predictions (e.g., congestion detection, trip forecasting) relative to baseline models.
B—beam width parameter limiting candidate map-matching states in Trip Manager processing.
M—maximum entries permitted in the Contract Manager's nonce buffer, ensuring bounded replay protection.
G—gas cost threshold (units) for on-chain smart contract verification, bounding transaction verification resources.
D—maximum depth parameter for DAG tip selection algorithms, constraining traversal depth to reduce orphan rates.
τ—threshold (minimum quorum size) for milestone node signatures in DAG-based consensus.
Z—maximum local snapshot size (megabytes) for DAG state commitments and milestone signatures.
S—maximum size (bytes) of gossip metadata or state proof per round in hashgraph, ensuring lightweight propagation and verification.

These parameters may be configured based on device class, network performance, and jurisdictional policy. Values may be dynamically negotiated or statically defined in system profiles, providing explicit bounds on computational efficiency, latency, storage, and verification overhead across the distributed ledger network.

### DETAILED DESCRIPTION OF THE INVENTION

All illustrations of the drawings are for the purpose of describing selected versions of the present invention and are not intended to limit the scope of the present invention.

As a preliminary matter, it will readily be understood by one having ordinary skill in the relevant art that the present disclosure has broad utility and application. As should be understood, any embodiment may incorporate only one or a plurality of the above-disclosed aspects of the disclosure and may further incorporate only one or a plurality of the above-disclosed features. Furthermore, any embodiment discussed and identified as being “preferred” is considered to be part of a best mode contemplated for carrying out the embodiments of the present disclosure. Other embodiments also may be discussed for additional illustrative purposes in providing a full and enabling disclosure. Moreover, many embodiments, such as adaptations, variations, modifications, and equivalent arrangements, will be implicitly disclosed by the embodiments described herein and fall within the scope of the present disclosure.

Accordingly, while embodiments are described herein in detail in relation to one or more embodiments, it is to be understood that this disclosure is illustrative and exemplary of the present disclosure and are made merely for the purposes of providing a full and enabling disclosure. The detailed disclosure herein of one or more embodiments is not intended, nor is to be construed, to limit the scope of patent protection afforded in any claim of a patent issuing here from, which scope is to be defined by the claims and the equivalents thereof. It is not intended that the scope of patent protection be defined by reading into any claim a limitation found herein that does not explicitly appear in the claim itself.

Thus, for example, any sequence(s) and temporal order of steps of various processes or methods that are described herein are illustrative and not restrictive. Accordingly, it should be understood that, although steps of various processes or methods may be shown and described as being in a sequence or temporal order, the steps of any such processes or methods are not limited to being carried out in any particular sequence or order, absent an indication otherwise. Indeed, the steps in such processes or methods generally may be carried out in various different sequences and orders while still falling within the scope of the present invention. Accordingly, it is intended that the scope of patent protection is to be defined by the issued claim(s) rather than the description set forth herein.

Additionally, it is important to note that each term used herein refers to that which an ordinary artisan would understand such term to mean based on the contextual use of such term herein. To the extent that the meaning of a term used herein—as understood by the ordinary artisan based on the contextual use of such term—differs in any way from any particular dictionary definition of such term, it is intended that the meaning of the term as understood by the ordinary artisan should prevail.

Furthermore, it is important to note that, as used herein, “a” and “an” each generally denotes “at least one,” but does not exclude a plurality unless the contextual use dictates otherwise. When used herein to join a list of items, “or” denotes “at least one of the items,” but does not exclude a plurality of items of the list. Finally, when used herein to join a list of items, “and” denotes “all of the items of the list.”

The following detailed description refers to the accompanying drawings. Wherever possible, the same reference numbers are used in the drawings and the following description to refer to the same or similar elements. While many embodiments of the disclosure may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the disclosure. Instead, the proper scope of the disclosure is defined by the appended claims. The present disclosure contains headers. It should be understood that these headers are used as references and are not to be construed as limiting upon the subjected matter disclosed under the header.

The present disclosure includes many aspects and features. Moreover, while many aspects and features relate to, and are described in the context of methods and systems for facilitating the collection of Road User Charges (RUC) using a digital currency, including, but not limited to, coins, tokens, and cryptographic assets, within a Distributed Ledger Technology (DLT) network, which may include, without limitation, Directed Acyclic Graph (DAG) architectures, Hyperledger frameworks, Blockchain protocols, and distributed hash graph technologies, embodiments of the present disclosure are not limited to use only in this context and may be applied to other secure transactional ecosystems requiring verifiable, multi-party settlement.

The invention specifically leverages advanced artificial intelligence (AI) technologies, including machine learning algorithms such as deep neural networks (DNNs), convolutional neural networks (CNNs), support vector machines (SVMs), gradient boosting frameworks (including XGBoost, LightGBM, CatBoost), reinforcement learning agents, and hybrid AI rule-based optimizers to perform predictive analytics, anomaly detection, and adaptive control of digital currency usage for RUC settlement.

In some embodiments, the AI or ML module comprises a Long Short-Term Memory (LSTM) recurrent neural network trained on time-series transportation and payment datasets to forecast RUC digital currency demand and congestion pricing fluctuations. In other embodiments, a CNN processes traffic camera feeds or vehicle sensor imagery to classify congestion patterns, while reinforcement learning agents dynamically adjust rate policies by simulating Road User behavior under varying pricing strategies.

These models may operate on sliding time windows and represent traffic flows using graph adjacency lists for efficient updates. Performance targets include inference latency of ≤T milliseconds per segment update and prediction accuracy of ≥α % relative to baseline statistical models.

Furthermore, the invention integrates sophisticated multi-access edge computing (MEC), distributed edge analytics frameworks, localized artificial intelligence processors such as AI accelerators, TPUs, and NPUs, and federated learning architectures to facilitate efficient, privacy-preserving, real-time data processing closer to the data source, significantly enhancing system responsiveness, reliability, and jurisdictional compliance.

The DLT network 200 comprises individual entities referred to as nodes 201, which include integrated software and hardware execution environments connected to one another to form a secure, peer-to-peer network for encrypted, consensus-driven data exchange. Each node maintains a locally synchronized ledger state which is replicated and validated across the network using consensus protocols such as Proof-of-Stake, Byzantine Fault Tolerance, Practical Byzantine Fault Tolerance, or Proof-of-Authority, ensuring immutable transaction records in the form of policies and smart contracts. Advanced cryptographic methods such as zero-knowledge proofs (ZKPs), homomorphic encryption, threshold signatures, secure multi-party computation (sMPC), and decentralized identifiers (DIDs) are integrated into the system to enable secure identity management, enforce transaction privacy, and guarantee ledger data integrity across both permissioned and permissionless DLT deployments. Within the DLT framework, ledger accounts are managed by digital wallets 401, which require secure key material stored in hardware security modules (HSMs), trusted platform modules (TPMs), or secure enclaves such as Intel SGX or ARM TrustZone to authenticate, sign, and authorize transactions.

In some embodiments, the system may further incorporate advanced privacy-preserving cryptographic techniques to ensure that RUC settlement transactions are verifiable without disclosing sensitive user or trip information. These techniques may include zero-knowledge proofs (ZKPs) such as zk-SNARKs, Bulletproofs, or range proofs, which enable validation of identity, balance sufficiency, or trip segment length without revealing the underlying data. For example, a zero-knowledge range proof may validate that a trip distance falls within a defined jurisdictional threshold while preventing disclosure of specific location points. Such proofs reduce disclosure bandwidth to ≤S bytes per proof, thereby lowering communication overhead while maintaining regulatory compliance. These privacy-preserving methods are integrated into the RUC workflow such that settlement on the DLT Network 200 can only occur upon successful cryptographic validation of a proof, enhancing both security and user privacy.

In the embodiments described herein, the inventive concept is directed to facilitating secure, automated Road User Charge (RUC) settlement over a distributed ledger, independent of the specific ledger architecture employed. While exemplary embodiments are illustrated using blockchain structures with block-based consensus and Merkle proofs, the same inventive framework is equally applicable to directed acyclic graph (DAG) ledgers, in which transactions reference multiple prior tips and reach finality through milestone confirmation, and to hashgraph ledgers, in which transactions propagate via gossip protocols and achieve consensus through virtual voting and state proofs. In each case, the distributed ledger technology (DLT) is used to anchor smart contracts, validate integrity of RUC-related data, and immutably update wallet balances for Road Users and Facility Owners. Accordingly, the inventive methods and systems disclosed herein are not limited to a single ledger design but rather encompass multiple DLT paradigms that achieve the same technical effect of secure, auditable, and scalable RUC settlement across jurisdictions

In some embodiments, the Distributed Ledger Technology (DLT) consensus mechanism may include Byzantine Fault Tolerant (BFT) protocols (e.g., PBFT, HotStuff, Tendermint), Nakamoto-style Proof-of-Work, Proof-of-Stake, or hybrid consensus protocols optimized for vehicular networks. Inclusion of a transaction within the DLT ledger may be verified through cryptographic membership proofs such as Merkle tree proofs, Patricia-Merkle tries, or vector commitments. To enhance privacy and security, the system may further incorporate zero-knowledge proofs (ZKPs), homomorphic encryption schemes, or decentralized identifiers (DIDs) for validating transaction authenticity without exposing sensitive user data. The Trip Manager may utilize geospatial algorithms including Hidden Markov Model (HMM) map-matching with Viterbi decoding, Extended Kalman Filters for sensor fusion of GNSS or complimentary PNT and odometer/IMU signals, and point-in-polygon or polygon clipping operations over S2/H3 jurisdictional tiles to reduce noise, detect boundary crossings, and segment trips into jurisdictionally distinct segments. Data structures such as fixed-capacity ring buffers may be employed to maintain segment metadata with bounded memory use, while smart contracts generated by the Contract Manager may embed explicit fields (segment ID, geofence hash, Merkle root of the committed route, nonce, rate table version, timestamp) together with on-chain safeguards including replay protection, reentrancy guards, and access control lists. Settlement efficiency may be enhanced by requiring compact Merkle proofs of route commitments rather than per-vertex submissions, reducing verification gas and on-chain storage overhead. These technical implementations provide concrete improvements in accuracy, latency, scalability, and security of geospatial processing and distributed contract execution compared to generic computer execution.

In some embodiments, the Distributed Ledger Technology (DLT) network may be implemented as a directed acyclic graph (DAG) rather than a block-based chain. In such configurations, each transaction message directly references at least two parent tips, thereby validating prior transactions as the DAG grows. A tip selection algorithm, such as Uniform Random Tip Selection with a maximum depth constraint, may be employed to ensure balanced referencing and prevent orphaned messages. Transaction finality may be attested by a milestone confirmation issued by designated milestone nodes or equivalent finality managers, wherein the milestone cryptographically signs a confirmation cone of included messages. In some embodiments, the DAG ledger may utilize a UTXO model with outputs configured as alias outputs or non-fungible token (NFT) outputs, allowing atomic disbursement of Road User inputs into multiple Facility Owner wallets within a single transaction.

To reduce resource requirements, a computing device may maintain a local snapshot of the DAG state and perform light-client verification by validating milestone signatures without storing the full transaction history. Associated alerts and receipts may be stored in content-addressable storage (e.g., IPFS, IOTA Streams) with content identifiers anchored in the DAG metadata for immutable auditability.

The DLT network 200 may leverage a tiered compute topology incorporating cloud 930, fog 931, and edge computing 932 resources to ensure scalable, low-latency operation. Cloud computing 930 hosts primary DLT validators and archival nodes providing consensus computation, policy verification, and historical transaction storage. Fog computing 904 supports regional and jurisdictional DLT nodes that cache and preprocess RUC transaction data for facility owners, reducing backhaul latency. Edge computing 905 operates directly at the Road User or roadside infrastructure level to perform real-time smart contract execution, local validation, and rapid settlement triggers for high-frequency microtransactions. This architecture enables dynamic workload orchestration where AI-driven resource management agents determine whether a given smart contract is executed at the edge, fog, or cloud layer, based on network latency, jurisdictional rules, or operational urgency.

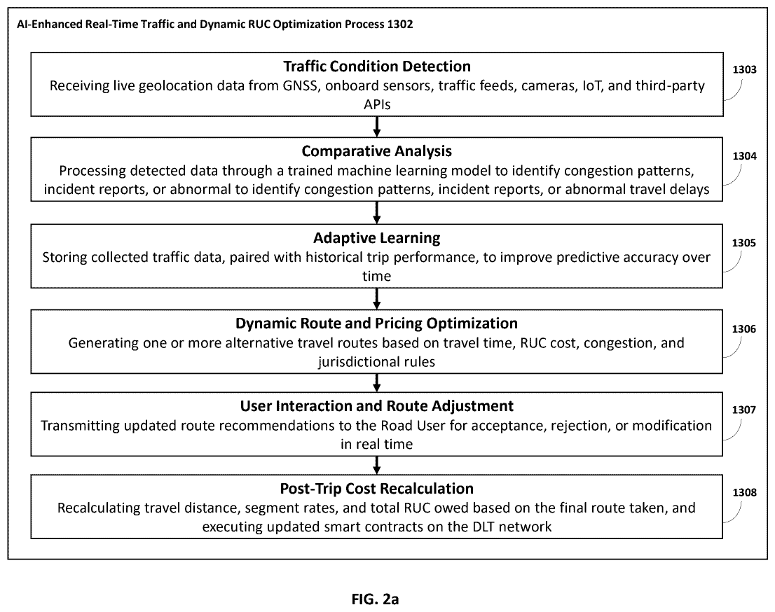

The invention incorporates dynamic, multi-variable RUC pricing algorithms based on real-time congestion data from roadside sensors, predictive traffic modeling from historical datasets, live weather and incident reports, and user behavior analytics, creating economically incentivized routing and enabling jurisdictional compliance without manual intervention. In some embodiments, an AI-driven analytics pipeline (“AI Process 870a”) augments the Trip Manager 878 to predict congestion, optimize routing, and adjust segment-level RUC pricing dynamically. The AI Process 870a consumes multi-source telemetry data including vehicle-based sensors, GNSS, complementary PNT, roadside units, and IoT infrastructure, and interfaces directly with the Coin Manager 871, Trip Calculator 877, and Contract Manager 872 for real-time, jurisdiction-aware settlement processing. FIG. 2A illustrates this AI-driven RUC optimization process, showing data ingestion from distributed sources, on-device inference at the edge, federated model updates at the fog layer, and compliance validation at the cloud and DLT layers.

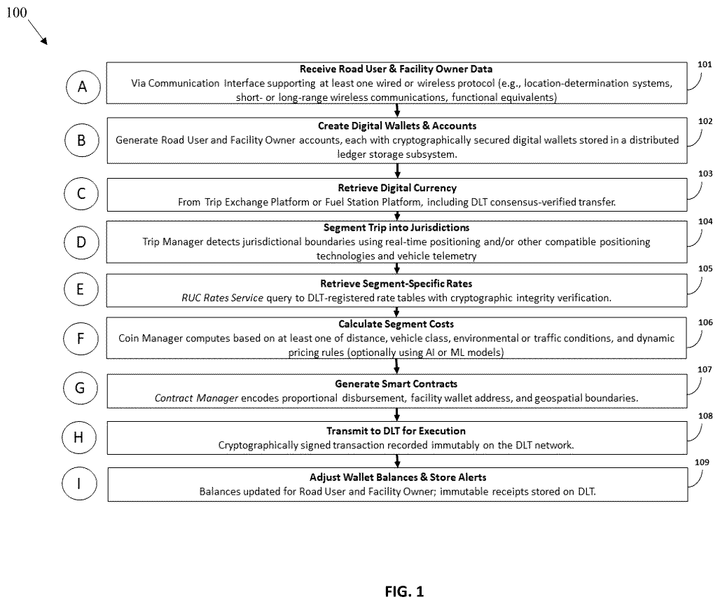

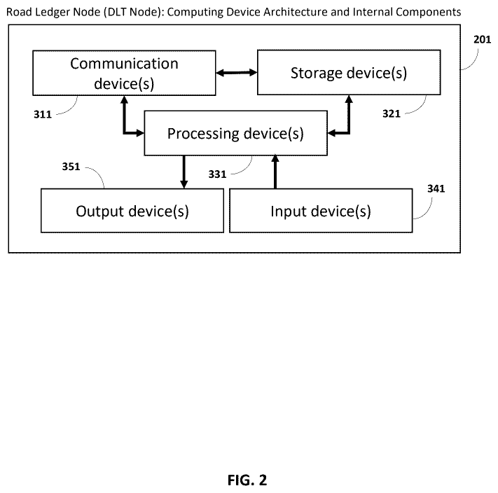

As seen in FIG. 1 through FIG. 19, the system used to execute method 100 of the present invention enables secure, automated interaction among Road Users and Facility Owners for Road User Charge (RUC) settlement over a Distributed Ledger Technology (DLT) network 200. At step A 101, a communication device receives Road User digital data from at least one Road User device associated with a Secure Unique Digital Identifier (SUDI) and Facility Owner digital data from at least one Facility Owner device associated with a SUDI via a communication interface supporting at least one wired or wireless protocol (e.g., location-determination systems, short- or long-range wireless communications, functional equivalents). The communication device(s) 311 may include multi-protocol radios, one or more positioning and timing system receivers including Global Navigation Satellite Systems (GNSS) such as GPS, Galileo, BeiDou, or GLONASS, and complementary Position, Navigation, and Timing (PNT) sources such as cLoran, 5G NR timing signals, Wi-Fi RTT, ultra-wideband (UWB) ranging, terrestrial radio beacons, LiDAR simultaneous localization and mapping (SLAM), or other equivalent technologies. These complementary PNT sources ensure availability and accuracy in environments where GNSS signals are unavailable or degraded (e.g., tunnels, urban canyons, or indoors), secure elements (TPM, HSM), and software-defined radios (SDR) with beamforming capability, supporting low-latency, low-power, multi-link operation across Personal Area Network protocols (e.g. Bluetooth, Bluetooth Low Energy (BLE), NFC, RFID, ANT/ANT+, and etc.), Dedicated Short Range Communications (DSRC), IEEE 802.11p and 802.11bd, Cellular Vehicle-to-Everything (C-V2X), PC5 and NR V2X, Local Area Network and Wireless LAN protocols (e.g. Wi-Fi, Wi-Fi 6/6E/7, Ethernet, Time-Sensitive Networking (TSN), and etc.), Wide Arca Network protocols (e.g. LoRaWAN, Sigfox, NB-IoT, LTE-M, LTE, 4G, 5G, 6G, 7G, 8G, mmWave, and etc.), Mesh protocols (e.g. Zigbee, Z-Wave, Thread, 6LoWPAN, and etc.), and satellite communications including GEO, LEO, and MEO/GNSS services (e.g. GPS, Galileo, BeiDou, GLONASS, IRNSS, and etc.) with complementary Position, Navigation, and Timing (PNT) integration. Specialized interfaces may include IEEE 1609 WAVE, SAE J2735, ISO 20022, Open Charge Point Protocol (OCPP), and VHF Data Exchange System (VDES). Emerging technologies such as Ultra-Wideband (UWB) for fine-grained positioning, Quantum Key Distribution (QKD) for secure key exchange, Time-Sensitive Networking for deterministic timing, and AI-driven Radio Access Network (AI-RAN) optimization may be orchestrated by edge agents using reinforcement learning, federated learning, or intent-driven networking to optimize communication paths and jurisdictional handoffs.

At step B 102, a processing device generates at least one Road User account and at least one Facility Owner account, each including a cryptographically secured digital wallet stored in a distributed ledger storage subsystem. The processing device may comprise multi-core CPUs, GPUs, FPGAs, TPUs, NPUs, or SoCs with integrated AI accelerators, and may run real-time operating systems or containerized microservices hosting the RUC Application components including a Trip Manager, Coin Manager, Trip Calculator, and Contract Manager. Wallet management may utilize decentralized identifiers (DIDs), verifiable credentials, hierarchical deterministic (HD) wallet key derivation (e.g. BIP32/BIP44/BIP39, and etc.), multi-signature schemes, threshold cryptography, or secure enclaves (e.g. Intel SGX, AMD SEV, ARM TrustZone, and etc.) for key isolation and signing protection. AI models such as neural networks, gradient boosting, reinforcement learning, and time-series predictors may optimize token use, forecast segment conditions, and adapt dynamic pricing strategies.

At step C 103, the storage subsystem retrieves digital currency for the Road User wallet from at least one Trip Exchange platform or fueling station platform wallet, including cryptographic validation via a DLT consensus mechanism. The Trip Exchange may convert fiat currency to RUC-specific tokens (RUDC), mint tokens, or transfer stablecoins, with settlement rules encoded on-chain. Supported DLTs may include blockchain platforms (e.g. Ethereum, Hyperledger Fabric, Quorum, Corda, and etc.), directed acyclic graphs (e.g. IOTA, Nano, and etc.), hashgraph systems (Hedera), and hybrid architectures. Consensus protocols may include proof-of-stake (POS), proof-of-authority (PoA), Byzantine fault tolerance (BFT), PBFT, or DAG tip selection. Storage devices may include NVMe SSDs, persistent memory, zoned namespace SSDs, decentralized storage (e.g. IPFS, Filecoin, Arweave, Storj, and etc.), and cloud/fog/edge storage layers with encryption (AES-256-GCM), Merkle tree verification, zk-SNARKs, or other zero-knowledge proof mechanisms for integrity validation.

At step D 104, the Trip Manager segments a trip into jurisdictional segments using real-time positioning and/or other compatible positioning technologies data, onboard IMUs, wheel sensors, and geofencing logic based on multi-layer digital maps that include jurisdiction boundaries, segment ownership, and traffic overlays. Positioning may be enhanced with RTK corrections, dead reckoning, and LiDAR SLAM in urban canyons, with map-matching performed on edge computing units (e.g., NVIDIA Jetson Orin, Qualcomm Snapdragon Ride, and etc.) for low-latency jurisdiction detection.

In some embodiments, the Trip Manager executes geospatial algorithms comprising Hidden Markov Model (HMM) map-matching with Viterbi decoding over an R-tree-indexed road graph, Extended Kalman Filter (EKF) sensor fusion combining GNSS signals, complementary Position, Navigation, and Timing (PNT) inputs, odometer data, and inertial measurement unit (IMU) updates executed at an IMU sampling rate of at least 100 Hz with GNSS corrections at least 1 Hz. Geofencing may be performed by point-in-polygon checks on tiled jurisdiction polygons with polygon clipping at boundary intersections.

The Trip Manager maintains a fixed-capacity circular (ring) buffer for segment metadata and prunes candidate map-matching states to a beam width B, thereby bounding working memory to ≤Q kilobytes and ensuring per-fix processing latency to ≤T milliseconds, suitable for in-vehicle edge devices.

In some embodiments, transmission of smart contracts and related transactions may employ secure transport protocols such as gRPC with mutual TLS authentication, HTTPS/2 with TLS 1.3, or QUIC-based secure channels, with serialization using compact binary formats such as CBOR or Protocol Buffers. To address intermittent connectivity, contracts may be cached in embedded databases such as LevelDB or append-only log files, cryptographically validated prior to submission, and resubmitted in batch or streaming modes upon reconnection. Immutable storage of alerts and receipts may be achieved through content-addressable storage systems such as IPFS, Filecoin, or IOTA Streams, with each record hashed using algorithms such as SHA3-256 or BLAKE3, and the resulting content hash committed into the DLT ledger metadata for auditability. In some embodiments, storage references may be aggregated in Merkle trees or Verkle trees to enable compact proofs of storage integrity.

At step E 105, the processing device retrieves segment-specific RUC rates from a DLT-registered RUC Rates Service. Rates may be stored in on-chain key-value databases or decentralized storage with hash-anchoring for authenticity. Queries may be performed using GraphQL, REST, or gRPC over secure channels (e.g. TLS 1.3, QUIC, and etc.). Rate models may be fixed, variable, congestion-based, or dynamically adjusted based on traffic conditions, vehicle class, fuel type, emissions class, and time-of-day parameters. Integrity verification may employ cryptographic hashes (e.g. SHA-3, BLAKE3, and etc.) or digital signatures from the publishing authority.

At step F 106, the Coin Manager calculates the digital currency cost for each segment using distance traveled, vehicle mass or class, congestion indices, emission factors, and jurisdictional rules, optionally using AI or ML models. Calculation algorithms may employ weighted summation, regression, gradient boosting, or reinforcement learning models for optimized pricing. Data inputs may be sourced from vehicle CAN bus (e.g. J1939, OBD-II, and etc.), telematics APIs, and third-party traffic providers (e.g. HERE, TomTom, INRIX, and etc.).

At step G 107, the Contract Manager generates a smart contract for each segment, encoded as a deterministic fixed-size data structure with bounded memory≤Q kilobytes and O(1) replay-check capability. Each contract incorporates proportional disbursement logic, Facility Owner wallet addresses, time-lock constraints, and geospatial boundary conditions. Smart contracts may be authored in Solidity, Rust, Go, or AssemblyScript depending on the target DLT, and may undergo formal verification (e.g., Certora, KEVM, and etc.), static analysis (e.g., Slither, MythX, and etc.), and fuzz testing for security assurance.

In some embodiments, the smart contract includes explicit fields such as segment ID, geofence hash, route commitment encoded as a polyline hash or Merkle root, rate table version, calculated amount, timestamp, and nonce. The Contract Manager encodes the route commitment as a fixed-size hash and stores per-segment nonces in a fixed-capacity circular (ring) buffer keyed by segment ID, ensuring O(1) replay detection and bounding on-chain storage overhead to at most M entries.

Settlement efficiency is achieved by requiring a single compact Merkle proof of the committed route polyline instead of per-vertex submissions, reducing verification gas cost to ≤G units. Each contract is digitally signed using an EIP-712 domain and configured with replay protection, access controls, and reentrancy guards, ensuring secure execution and resistance to replay or injection attacks.

At step H 108, each smart contract is transmitted to a DLT node for execution over secure transport (e.g. TLS 1.3, DTLS, QUIC, and etc.) with potential VPN/IPsec tunnels for inter-jurisdictional routing. The system may employ full nodes, light clients, or relay nodes, with multi-path TCP and automatic failover to alternate DLT endpoints to maintain transaction continuity.

In some embodiments, transmission of smart contracts and related transactions may employ secure transport protocols such as gRPC with mutual TLS authentication, HTTPS/2 with TLS 1.3, QUIC-based secure channels, or WebSocket Secure (WSS). Transactions may be serialized using compact formats such as CBOR or Protocol Buffers, and may be batched, streamed, or prioritized based on contract expiration times. In environments with intermittent connectivity, contracts may be cached locally using LevelDB, SQLite, or append-only log structures, cryptographically validated upon reconnection, and resubmitted in the correct sequence order to maintain compliance.

At step I 109, wallet balances for the Road User and Facility Owner are updated in accordance with the executed contract terms, and transfer alerts are generated. Alerts may be delivered via MQTT, WebPush, SMPP SMS, or WebSocket events, each cryptographically signed for authenticity. Immutable receipts containing timestamps, transaction IDs, and segment metadata are stored on the DLT and optionally replicated to decentralized archives with erasure coding for long-term durability. Privacy-preserving techniques such as zero-knowledge proofs may be used to enable regulator audits without revealing personally identifiable information.

In some embodiments, immutable storage of alerts and receipts may be achieved through content-addressable storage systems such as IPFS, Filecoin, or IOTA Streams, with each record hashed using algorithms such as SHA3-256, BLAKE3, or equivalent. The resulting content identifiers may be anchored in DLT ledger metadata, ensuring durable and tamper-evident auditability. In certain deployments, audit artifacts may be aggregated into Merkle trees or Verkle trees to support compact inclusion proofs of stored receipts. In further embodiments, retention policies may be enforced using distributed storage contracts, with automatic replication across nodes and expiration timers to balance durability with storage efficiency.

In reference to FIG. 2, a block diagram of a system for facilitating the collecting of the RUC using a digital currency, based on a DLT network 200, which comprises of DLT network node(s) 201 that may include communication device 311, storage device 321 and processing device 331 with data from input devices 341, transmit data to output devices 351 in accordance with some embodiments is illustrated. Accordingly, the system may include the communication device 311 configured for receiving Road User data from at least one Road User device associated with the at least one Road User. Preferably, the communication device(s) 311 may be any electronic device that can connect to the distributed ledger network through a wired and wireless communication module(s). Examples of communication protocols which include, but are not limited to Personal Area Network (PAN) Protocols (e.g. Bluetooth, Bluetooth Low Energy (BLE), NFC (Near Field Communication), RFID (Radio Frequency Identification), ANT/ANT+, Dedicated Short-Range Communications (DSRC), Light Fidelity (Li-Fi), and etc.); Local Area Network (LAN) Protocols (i.e. Wi-Fi); Wide Area Network (WAN) Protocols (i.e. Long-Range Wide Area Network (LoRaWAN), Signal for X (Sigfox), NB-IoT, Cellular Vehicle-to-Everything (C-V2X), PC5 Sidelink, Long Term Evolution (LTE), LTE-M, 5G, 6G, 7G, next generation cellular and wireless, etc.); Mesh Network Protocols (e.g. Zigbec, Z-Wave, Thread, 6LoWPAN, etc.); Satellite Communications Protocols which include Geostationary Earth Orbit (GEO) protocols (e.g. HughesNet, Viasat, Inmarsat, Thuraya, and etc.); Low Earth orbit (LEO) protocols (e.g OneWeb, Telesat, Starlink, Iridium, Globalstar, and etc.); Medium Earth orbit (MEO) protocols (e.g. GPS (Global Positioning System), Global Navigation Satellite System (GNSS), BeiDou, Galileo, GLONASS, IRNSS, and etc.), etc. Accordingly, the functionalities of the communication device (RUC communication device 331 may comprise the following. The communication device 331 may be configured for receiving distance data from at least one input device. Preferably, the input device 341 may include a smart dashboard module both removable and integrated onboard a vehicle operating system, the vehicle that may be disposed on the vehicle of the at least one Road User. The input device(s) 341 may further include fueling station interfaces, onboard diagnostics (OBD-II) systems, GPS modules, ADL submission portals, and sensors capable of detecting fuel type and volume, which provide telemetry, fueling data, and manual trip declarations for off-network processing.

In an embodiment, the input device 341 may include the at least one Road User device. Further, the communication device 311 may be configured for receiving cost data from at least one Facility Owner device and account/address associated with the at least one Facility Owner. Further, the communication device 311 may be configured for transmitting a transaction(s) in the form of the policy and a smart contract on the DLT network 201. Further, the communication device 311 may be configured for receiving a payment alert based on the policy and a smart contract from the at least one Road User device. Furthermore, the communication device 311 may be configured for transmitting a transfer alert to at least one of the at least one Road User device and the at least one Facility Owner device and account/address.

In the preferred embodiment, the processing device 331 of the system comprises a Coin Manager associated with a RUC Application (an exemplary embodiment of a software platform associated with the disclosed system). The storage device 400 may include local memory on edge devices, fog nodes, or cloud storage integrated within DLT nodes to ensure low-latency access and distributed redundancy of RUC transaction data. It may store digital wallet metadata, policy and smart contract templates, RUC Rate schedules, trip segments, and cryptographic audit logs. This enables real-time synchronization and historical traceability across all participating DLT nodes. Accordingly, the functionalities of the processing device 331 may comprise the following. The processing device 331 is configured for processing the Road User data to generate the Road User account, and the Facility Owner data to generate Facility Owner account. Further, the processing device 331 may be configured for analyzing the position and distance data, the digital map data, RUC Rates, and the cost data based on the Trip Calculator to generate a transaction(s) in the form of the policy and a smart contract in a Contract Manager. Further, the processing device 331 may be configured for adding the digital currency corresponding to the payment alert to the digital wallet of the Road User. Further, the processing device 331 may be configured for adding the digital currency to a digital wallet of a Facility Owner account/address based on the policy and smart contract to generate the transfer alert. Further, the Facility Owner account may be associated with the at least Facility Owner. Further, the transfer alert may notify the at least one Facility Owner of receiving of the digital currency corresponding to the policy and smart contract, using the DLT network 201. The output devices 351 may include display modules, graphical user interfaces (GUIs), and alert systems that present real-time information such as account balances, trip cost breakdowns, transaction statuses, refueling summaries, and alerts related to RUC settlements to Road Users and Facility Owners, enabling transparency, usability, and compliance.

In reference to FIG. 2A, an embodiment of the present invention extends the system of FIG. 2 by incorporating an AI Activity Module 1300 executed by the processing device 331 in coordination with the communication device 311, storage device 321, and RUC Application components. The AI Activity Module 1300 is configured to perform real-time adjustment of Road User Charges (RUC) based on changing roadway conditions and Road User interactions during an active trip. In some embodiments, the AI Activity Module 1300 includes a Real-Time Traffic Analysis and Dynamic Pricing Engine 1301 integrated with the Trip Manager 878, Coin Manager 871, Trip Calculator 877, and Contract Manager 872.

The AI Activity Module 1300 continuously ingests environmental telemetry-such as traffic conditions, congestion patterns, and fuel station usage-alongside Road User activity data, including route acceptance or rejection, manual trip submissions, and issue reports. This combined dataset undergoes feature extraction, anonymization, and normalization before being stored in the storage device 321 as a training dataset for incremental model updates via online or federated learning across edge, fog, and cloud nodes of the DLT network 200.

The AI Process 1301 begins with Traffic Condition Detection 1302, which collects live geolocation data from the vehicle's GNSS or complementary PNT system and onboard sensors, supplemented with real-time traffic feeds from roadway cameras and sensors, IoT infrastructure, and third-party traffic APIs. The process continues with Comparative Analysis 1303, in which the detected data is processed through a trained machine learning model, such as neural networks, gradient boosting frameworks, or reinforcement learning agents, to compare current traffic conditions against predicted conditions for upcoming segments, enabling the identification of congestion patterns, incidents, or abnormal delays. Adaptive Learning 1304 then stores collected traffic and activity data along with historical trip performance to incrementally improve predictive accuracy using online or federated learning methods deployed across distributed nodes in the network.

Dynamic Route and Pricing Optimization 1305 generates one or more alternative travel routes using a multi-objective optimization framework that reduces estimated travel time and RUC cost while considering dynamic segment rates, congestion levels, and jurisdictional rules. These optimized route recommendations are then delivered to the Road User during the User Interaction and Route Adjustment 1306 stage, where they can be reviewed through a mobile application or in-vehicle navigation system, with acceptance, rejection, or modifications captured as feedback for further optimization cycles. At the conclusion of a trip, Post-Trip Cost Recalculation 1307 recalculates the actual travel distance, applicable segment rates, and total RUC owed based on the final route taken, and instructs the Contract Manager 872 to generate and execute an updated smart contract on the DLT network 200, ensuring accurate and auditable settlement with all Facility Owner accounts.

In certain embodiments, the AI Activity Module 1300 further incorporates predictive incident detection using edge-based federated learning, enabling proactive token allocation adjustments before congestion occurs. This feedback-driven architecture delivers a measurable technical improvement over static pricing and routing systems by reducing decision latency, improving predictive accuracy, and enhancing cost efficiency through adaptive, user-aware decision-making.

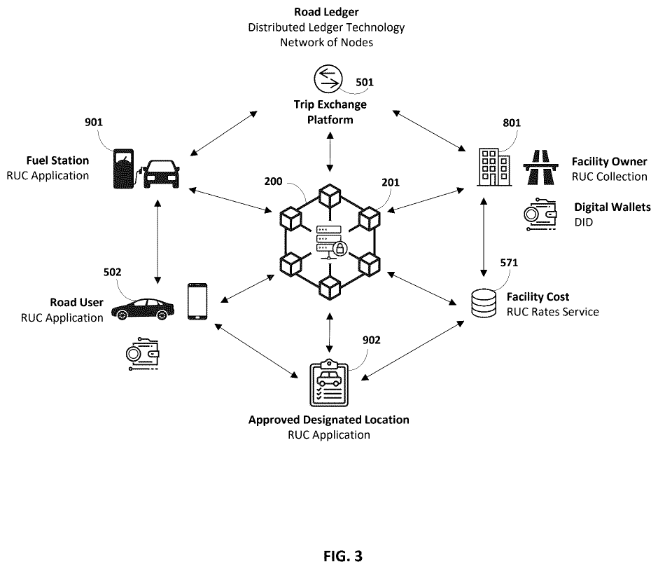

In reference to FIG. 3, the system integrates multiple platforms—including Road User devices, fueling stations, Facility Owner systems, and a centralized or distributed Trip Exchange Platform 501—all interconnected through a DLT network 201 that manages transactions, executes smart contracts, and maintains an immutable record of RUC-related activity.

The Fueling Station Platform 1400 is communicatively coupled to the DLT network 201 to allow the purchase or distribution of RUC digital currency (RUDC) directly to a Road User's Digital Wallet 720 during a fueling event. This platform captures fuel usage data from point-of-sale and pump control systems, applies jurisdictional tax deferrals or RUC estimates, and transmits this data to the DLT network 201 for settlement processing. The fueling station interface may also integrate with sensors that detect fuel type, volume dispensed, and payment authorization status, ensuring accurate RUC computation for each transaction.

Road Users may interact with the system via a RUC Application 502 running on a Vehicle 1001 or mobile device. The application interfaces with onboard systems and external data sources to execute RUC policies and smart contracts based on trip segments. It communicates with the RUC Rates Service 571, which stores and serves cost data indexed by Facility Owner policies and supports multiple pricing models, including fixed, distance-based, congestion-based, and time-of-day variable rates. The application also handles real-time trip monitoring, policy compliance checks, and payment triggers, and may work in conjunction with auxiliary modules such as a Trip Manager, Coin Manager, and Contract Manager.

Facility Owners interact through a Facility Owner Platform 801, which may represent road infrastructure operators (e.g., federal, state, city, county, or private entities) that receive RUDC via smart contract execution on the DLT network 201. These smart contracts are dynamically generated per trip segment and can automatically split payments across multiple jurisdictions according to stored policy rules. The Facility Owner Platform 801 includes the capability to reconcile on-chain transactions with internal accounting systems, generate compliance reports, and respond to policy updates.

The system also incorporates an Approved Designated Location (ADL) RUC Application 902, which enables Road Users to manually declare trips or submit offline trip reports when real-time DLT connectivity is unavailable. The ADL system validates these reports against stored rate and trip segment data, retrieves cost information from the RUC Rates Service 571, and triggers retroactive smart contract execution upon restored connectivity. The ADL module may operate from a kiosk, secure web portal, or integrated vehicle interface, with identity verification via Decentralized Identity 421 to ensure report authenticity.

At the center, the Trip Exchange Platform 501 functions as the digital currency management layer, supporting wallet creation, purchase of RUDC with fiat currency, and cryptographic verification for both Road Users and Facility Owners. The platform is equipped with a Digital Wallet Manager 551 for secure wallet provisioning and maintenance, a DLT Interface 571 for broadcasting and confirming transactions on the DLT network 201, and a Transaction Logger 581 for creating an immutable audit trail. The platform facilitates RUDC transfers between parties, currency conversions between digital and fiat forms, and integration with external exchange or settlement systems, all while ensuring compliance with applicable regulations and maintaining transaction traceability.

In reference to FIG. 3a, the AI Activity Module 1300 operates within a Processing Device 331 as part of Programming Module(s) 550, providing an AI-Enhanced Real-Time Traffic and Dynamic Road User Charge (RUC) Optimization Process 1302 tightly integrated with the Road User RUC Application 870. Input Device(s) 361 supply the AI Activity Module 1300 with multi-source telemetry including Vehicle Sensors (e.g., GNSS, accelerometer, odometer, speedometer, LiDAR, radar, and inertial measurement units), Traffic Data (e.g., live traffic camera feeds, incident reports, loop detector outputs, roadside unit (RSU) telemetry, IoT infrastructure data, and third-party traffic APIs), and User Data (e.g., route acceptance or rejection actions, manual trip entries, preferred routing constraints, and user-generated incident reports).

Within the AI Activity Module 1300, a series of interrelated functional components execute the steps of Process 1302. Traffic Condition Detection 1303 aggregates and preprocesses the multi-source telemetry, performing feature extraction, normalization, and geotemporal alignment to detect current roadway conditions for the active segment and predicted conditions for upcoming segments. Comparative Analysis/Incident Detection 1304 applies trained machine learning models, including but not limited to neural networks, gradient boosting algorithms, and reinforcement learning agents, to identify congestion patterns, anomalies, and incident events by comparing real-time data with predictive models and historical baselines. Adaptive Learning 1305 updates the machine learning models using online or federated learning techniques, storing newly labeled data in a training dataset to continuously improve predictive accuracy and decision-making performance. Dynamic Route and Pricing Optimization 1306 executes multi-objective optimization routines that generate one or more alternative travel routes, each designed to minimize travel time and dynamically adjust RUC segment pricing in compliance with jurisdictional rules. User Interaction and Route Adjustment 1307 transmits updated route recommendations to the Road User through a mobile application or in-vehicle navigation interface, receiving acceptance, rejection, or modification inputs, which are then fed back into Adaptive Learning 1305 to refine future predictions. Post-Trip Cost Recalculation 1308 recalculates the total travel distance, segment-level RUC charges, and aggregate RUC owed based on the route actually taken, providing the updated settlement data to the Contract Manager 872 for automated execution of revised smart contracts on the Road Ledger Distributed Ledger Technology (DLT) Network 201.

The AI Activity Module 1300 exchanges data bidirectionally with the Road User RUC Application 870, which includes the Coin Manager 871, Fuel Manager 879, Trip Manager 878, Trip Calculator 877, and Contract Manager 872. Through Communication Device(s) 311, these components interface with external systems including External Secure Digital Wallet(s) 402 for storing and transacting digital currency, the Trip Exchange Platform 501 for currency acquisition and exchange, the Road Ledger DLT Network 201 for smart contract execution and ledger services, and the RUC Rates Service 571 for jurisdiction-specific rate retrieval. This integration enables a continuous feedback and learning cycle in which user interactions, environmental conditions, and trip outcomes improve the accuracy and responsiveness of route recommendations and dynamic RUC pricing, resulting in technical improvements in latency, prediction accuracy, and automated settlement integrity compared to static or rules-based RUC systems.

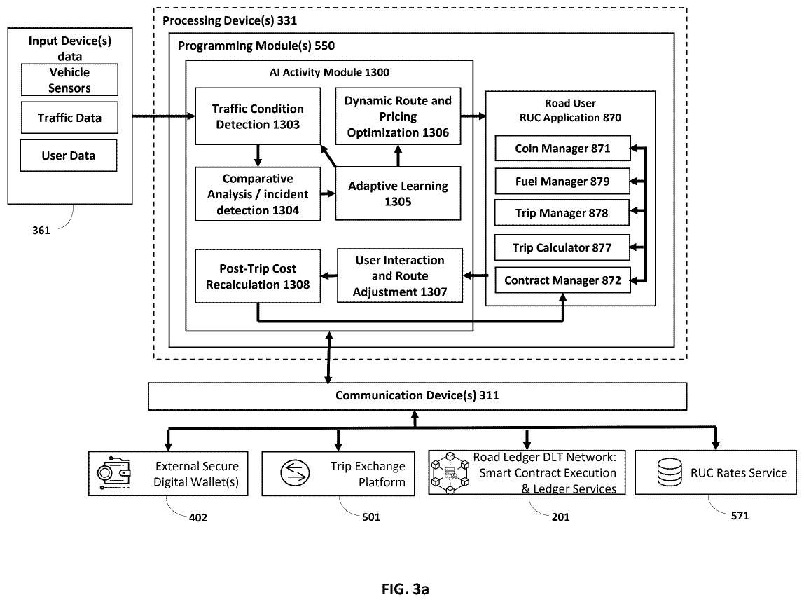

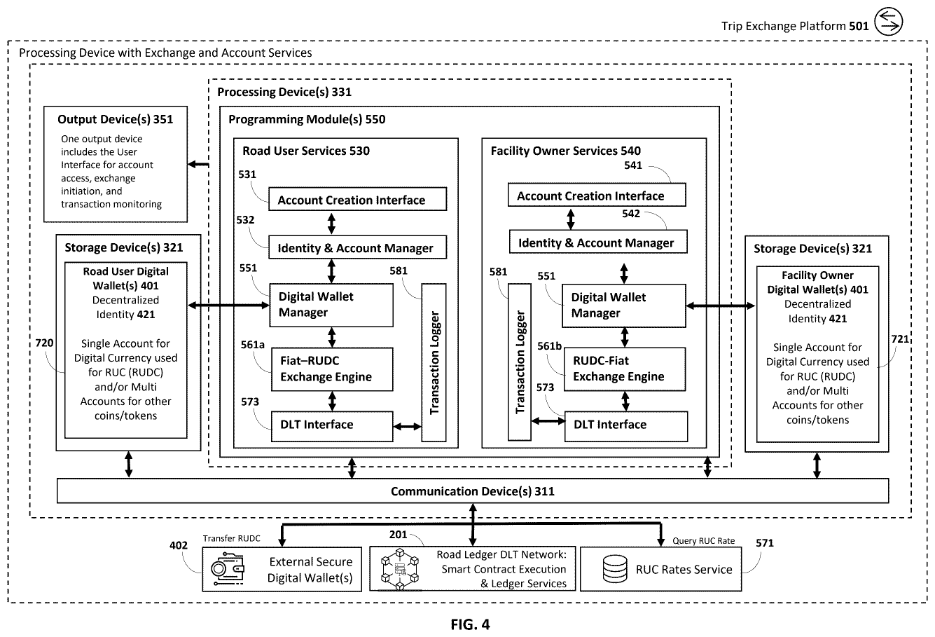

In reference to FIG. 4, the Trip Exchange Platform 501 serves as the central computing and transaction coordination environment for facilitating secure Road User Charge (RUC) payments using a RUC-specific digital currency (RUDC). Within the platform, a Processing Device 331 executes the core logic, operating in conjunction with Programming Module(s) 550 that encapsulate both Road User Services 530 and Facility Owner Services 540. Each service group provides an Account Creation Interface 531 or 541 that allows secure onboarding, with identity verification performed by an Identity & Account Manager 532 or 542. These managers utilize Decentralized Identity (DID) 421 technology to resolve DID documents, validate associated verifiable credentials, and prevent spoofing or replay attacks during account creation and maintenance.

The Road User's Digital Wallet(s) 720 and the Facility Owner's Digital Wallet(s) 721 are managed by a Digital Wallet Manager 551, which generates, encrypts, and maintains wallet keys, supporting both RUDC-only accounts and multi-currency accounts for additional digital tokens. Wallet operations are secured through DID 421 integration to ensure cryptographically signed transactions and authenticated balance queries. Currency conversion between fiat and RUDC is handled by the Fiat-RUDC Exchange Engine 561 in Road User Services 530 and the RUDC-Fiat Exchange Engine 561 in Facility Owner Services 540, each retrieving exchange rates from trusted oracles, locking rates during the transaction process, verifying sufficient balances, and executing settlement either on-chain via the DLT Interface 573 or off-chain with reconciliation to the DLT network 201. The DLT Interface 573 batches outbound transactions, validates inbound block data, ensures consensus finality, and retries failed transmissions using fault-tolerant protocols. All activity is recorded in a Transaction Logger 581, which creates an immutable, append-only log of transactions, each entry timestamped, cryptographically hashed, and optionally replicated across multiple Trip Exchange nodes for redundancy.

Supporting these operations, Storage Device(s) 321 store encrypted wallet keys, DID metadata, contract templates, and historical transaction data with encryption at rest, access control lists, and distributed redundancy. The Communication Device(s) 311 manage secure connections using multiple protocols such as TLS over HTTPS for external API communication, gRPC for inter-service calls, MQTT for event-based updates, and optional satellite or mesh-network failover channels. The Output Device(s) 351 provides a secure interface for Road Users and Facility Owners to view account balances, transaction histories, RUC rate lookups, trip review dashboards, and exchange confirmations, ensuring that all data displayed is cryptographically verified.

Externally, the Trip Exchange Platform 501 interacts with External Secure Digital Wallet(s) 402 to transfer RUDC out of platform custody, signing transactions locally within the Processing Device 331 and verifying them on the DLT network 201. The platform also queries the RUC Rates Service 571 to obtain up-to-date, policy-specific rate data, using authenticated API calls with caching to reduce latency. The DLT network 201 serves as the underlying distributed ledger for executing smart contracts, validating RUC settlement transactions, maintaining an immutable transaction history, and enabling multi-jurisdictional fund distribution based on trip segments and policies.

In some embodiments the system incorporates a Trip Exchange Platform 501 that enables conversion between fiat currency and Road User Digital Currency (RUDC). The Trip Exchange Platform 501 comprises wallet management tools 551, exchange engines 561a/561b, and DLT Interface 573 components to authenticate Road Users 530 and Facility Owners 540. The platform supports cross-chain settlement validated by inclusion proofs or light-client state proofs, enabling interoperability across heterogeneous distributed ledger systems. In addition, the Trip Exchange Platform 501 provides cryptographic authentication to verify Road User identities 532 and Facility Owner identities 542, and ensures that all conversions and settlements are immutably anchored on the DLT Network 201. This design supports both real-time RUC payments during travel and post-trip settlement across multiple jurisdictions.

In reference to FIG. 5, a method is illustrated for facilitating the addition of digital currency used for Road Usage Charging (RUC) to a Road User's Digital Wallet 720 at a Fuel Station Platform 1400. The fuel station platform may include both commercial vendors (e.g., gas stations, electric charging stations, and etc.) and private on-grid or off-grid fuel sources (e.g., home solar charging, private biodiesel pumps, and etc.). The process begins when a Road User arrives and adds motor fuel to the vehicle 1401, after which the fueling process is completed 1402.

At this point, the system determines whether the Road User will opt in to RUC 1403 unless RUC is already mandated by law or platform policy. If the Road User is prompted with the question “Are you using fuel with motor fuel tax?” 1404, they may either proceed with traditional tax payment or choose to pay RUC instead. In parallel, the system may evaluate whether RUC is required by law or platform policy 1405, in which case the RUC payment option is automatically applied and presented to the user before payment completion.

If the Road User declines RUC participation, payment for fuel with motor fuel tax 1406 is made and, where applicable, a gas tax deferral record 1414 is transmitted to the DLT Network 201 for auditing purposes. If the user chooses to pay RUC voluntarily under the opt-in pathway, payment is made only for motor fuel and RUC is generated 1408. If RUC is required, payment is made only for motor fuel without the motor fuel tax 1409, with the RUC portion handled separately. In cases where RUC cannot be processed on-site, payment for RUC may be made by other approved means 1407 as authorized by proper authorities.

When RUC payment is selected or mandated, the Road User can either purchase RUC Digital Currency (RUDC) from the fuel station platform 1410 or purchase RUDC from a connected vehicle or mobile RUC Application 1411. The system integrates with the Coin Manager 871 to calculate the required RUDC amount based on fuel usage, declared trip distance, or historical consumption patterns. The Coin Manager connects to the Trip Exchange Platform 501 to purchase RUDC and can also accept prepaid digital currency from the fuel station platform 1400, working in conjunction with the Contract Manager 872. The Contract Manager manages the execution of policies and smart contracts associated with the transaction.

RUC pricing is retrieved from the RUC Rates Service 571, which stores Facility Owner account data and associated pricing models, including stable pricing, variable pricing, and dynamic pricing based on distance traveled, vehicle classification, congestion levels, or time-of-day factors. Once the estimated RUDC is calculated, it is recorded as a digital transaction via the RUC Application 1412.

Finally, the RUC Smart Contract is executed 1413, transferring the calculated RUDC from the Road User's Digital Wallet 720 to the relevant Facility Owner's Digital Wallet 721, and logging the fuel usage, trip data, and settlement details on the DLT Network 201 for real-time compliance, traceability, and future auditing.

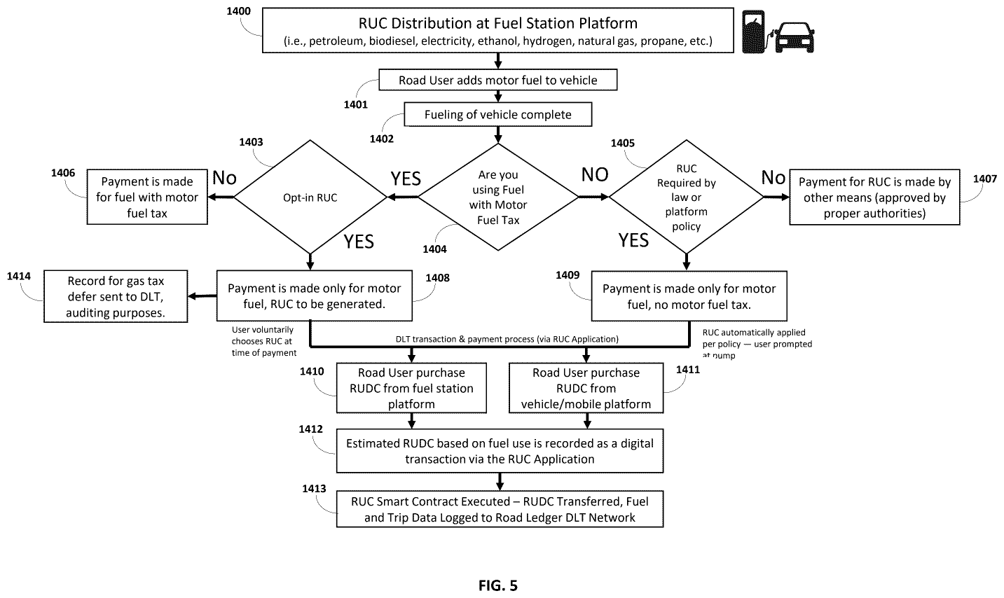

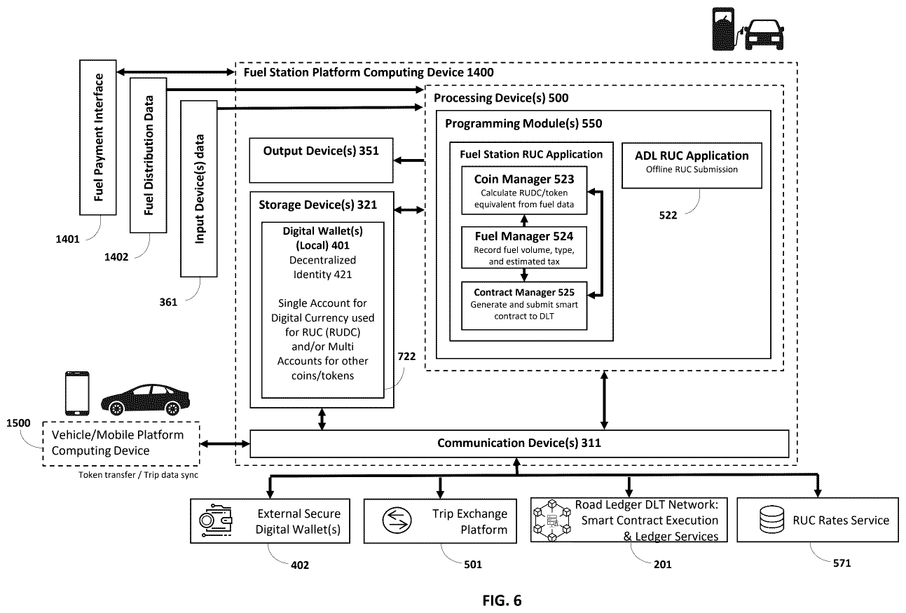

In reference to FIG. 6, a system architecture for facilitating the addition of Road User Digital Currency (RUDC) to a Road User's Digital Wallet(s) 720 via a Fuel Station Platform Computing Device 1400 is illustrated, in accordance with some embodiments. The Fuel Station Platform Computing Device 1400 incorporates Input Device(s) 361 configured to capture Fuel Distribution Data 1402 from metering systems, pump controllers, or charging stations, and to receive payment inputs via a Fuel Payment Interface 1401 connected to point-of-sale terminals, mobile payment systems, or vehicle-based payment modules.

These data streams are processed by a Processing Device 500 executing Programming Module(s) 550, which include the Fuel Station RUC Application and the Approved Designated Location (ADL) RUC Application 522. The Fuel Station RUC Application hosts a Coin Manager 523 configured to calculate the amount of RUDC or token equivalent required for a fueling event based on fuel volume, fuel type, estimated range, and the Road User's current digital wallet balance, leveraging historical trip data and retrieving jurisdiction-specific rates from the RUC Rates Service 571. A Fuel Manager 524 records fuel transaction metadata, including volume, type, and estimated deferred motor fuel tax, and associates these values with the relevant trip identifiers. A Contract Manager 525 generates a smart contract or hybrid smart contract specifying the RUC amount due, linking the contract to fueling data and jurisdictional parameters, and submits it to the Road Ledger DLT Network 201 for immutable execution.

In some embodiments the RUC Application further comprises a Fuel Manager 524 module. The Fuel Manager 524 is configured to capture and process fuel or energy event data, including volume, type, and estimated tax, from fueling stations or charging platforms. The module interfaces with the Coin Manager 523 and Contract Manager 525 to calculate Road User Charge (RUC) token equivalents when no motor fuel tax is applied. Fueling or charging events are logged as signed tuples (volume, type, tax), which are emitted by fueling-station controllers and cryptographically signed for authenticity. These events trigger generation of a smart contract that records the event on the Distributed Ledger Technology (DLT Network 201) via the DLT Interface 573, ensuring that fuel consumption and RUC obligations are immutably linked and disbursed to the appropriate Facility Owner accounts 540/721.

The ADL RUC Application 522 enables offline operation by securely buffering fueling and transaction data when the platform is disconnected from the DLT Network 201, transmitting the stored data upon reconnection to maintain ledger integrity. The Storage Device(s) 321 host the Digital Wallet(s) 722, secured through Decentralized Identity 421 protocols for transaction authentication, with wallets supporting single-currency RUC balances or multi-currency configurations for additional digital assets, and protected through AES-256 or equivalent encryption with secure key management. Output Device(s) 351 provide transaction confirmations, wallet balances, and contract execution results.

Communication Device(s) 311 maintain secure, redundant connections to the Vehicle/Mobile Platform Computing Device 1500, External Secure Digital Wallet(s) 402, the Trip Exchange Platform 501, the Road Ledger DLT Network 201, and the RUC Rates Service 571, using protocols such as TLS over HTTPS for API calls, gRPC for inter-service communication, MQTT for event-driven updates, and optional satellite or mesh-network failover channels including LoRaWAN, Starlink, Zigbee, or Thread. The Vehicle/Mobile Platform Computing Device 1500 mirrors the Fuel Station Platform's RUC Application capabilities, allowing redundant calculation, contract generation, and transaction submission if the Fuel Station Platform 1400 is unavailable, and synchronizing data via Communication Device(s) 311. In operation, RUDC can be purchased directly from the Fuel Station Platform 1400 or via the Trip Exchange Platform 501 using fiat currency or other digital currencies, with identity verification through Decentralized Identity 421 before wallet crediting, and all transactions processed through the DLT Interface 571, recorded immutably on the DLT Network 201, and logged for audit and compliance purposes, enabling secure, high-availability RUC settlement in connected, partially connected, or offline fueling environments.

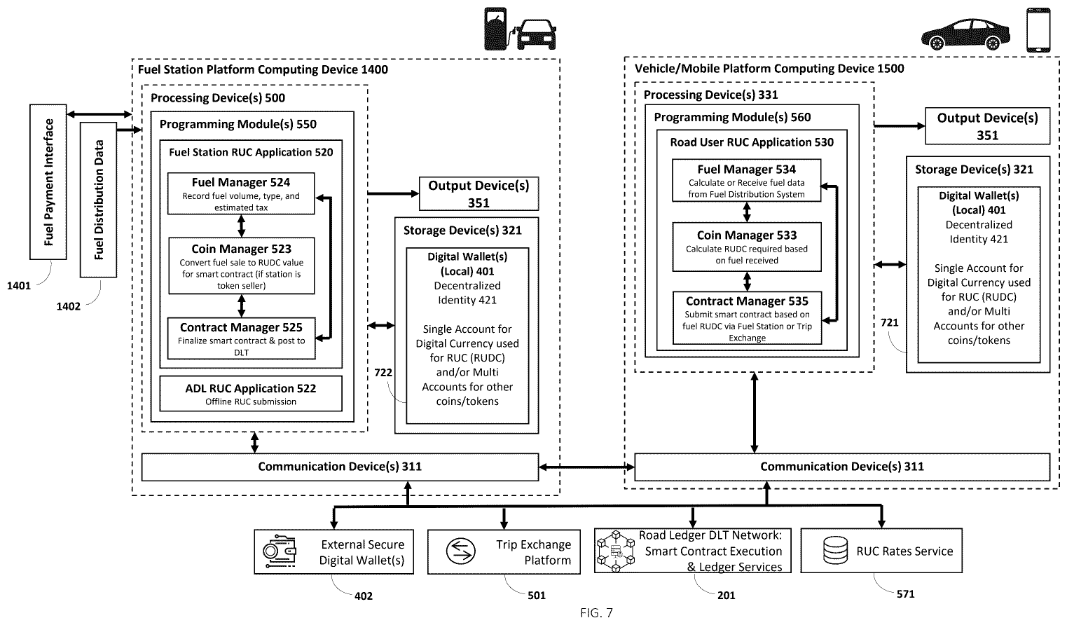

In reference to FIG. 7, a system architecture diagram illustrates the interaction between the Fuel Station RUC Application 520 and the Road User RUC Application 530 within the context of Road User Charging (RUC), in accordance with some embodiments of the present invention. The architecture supports both distributed and redundant processing, secure wallet operations, decentralized identity verification, and the execution of policy-driven smart contracts through the Road Ledger Distributed Ledger Technology (DLT) Network 201. The system comprises two primary computing environments: the Fuel Station Platform Computing Device 1400 and the Vehicle/Mobile Platform Computing Device 1500. Each device includes integrated functional elements such as Processing Device(s) 500/331, Programming Module(s) 550/560, Storage Device(s) 321, Output Device(s) 351, and Communication Device(s) 311 to support secure data exchange, transaction creation, and audit-compliant RUC operations.

The Fuel Station Platform Computing Device 1400 hosts the Fuel Station RUC Application 520, which contains the Fuel Manager 524 for recording fuel volume, type, and estimated tax based on readings from the Fuel Distribution Data 1402 interface, the Coin Manager 523 for converting recorded fuel sale metrics into an RUC Digital Currency (RUDC) value suitable for inclusion in a smart contract and performing token equivalency calculations if the station operates as a token seller, and the Contract Manager 525 for finalizing the smart contract payload, applying cryptographic signatures, and posting it to the DLT Network 201 for immutable recording. The ADL RUC Application 522 provides offline RUC submission capability, enabling the station to capture and store complete transaction data until a network connection is available for synchronization. The Storage Device(s) 321 on the Fuel Station Platform includes Digital Wallet(s) (Local) 401 paired with a Decentralized Identity 421. The wallet may be configured as a single account for RUC-specific digital currency or as a multi-account wallet supporting additional digital assets. All wallet keys and identity metadata are encrypted and stored locally, with secure backup and optional integration to External Secure Digital Wallet(s) 402.

The Vehicle/Mobile Platform Computing Device 1500 runs the Road User RUC Application 530, containing the Fuel Manager 534 for calculating or receiving fuel usage data from the Fuel Distribution Data 1402 system or from a connected interface, the Coin Manager 533 for computing the exact RUDC amount required based on the fuel type, volume, and applicable RUC rates obtained from the RUC Rates Service 571, and the Contract Manager 535 for constructing and digitally signing the smart contract for submission via either the Fuel Station Platform or the Trip Exchange Platform 501. Both computing devices are equipped with Communication Device(s) 311, supporting secure, policy-driven connectivity between platforms and the DLT network. These devices may employ multiple secure protocols—such as TLS over HTTPS for external API traffic, gRPC for service-to-service transactions, and MQTT for event-driven messaging—while offering satellite or mesh-network failover for offline scenarios.

The architecture allows for flexible operational modes. In one embodiment, the Fuel Station Platform acts as the RUDC token seller and delivers pre-calculated RUDC values to the Road User platform in real time. In another embodiment, the Road User platform initiates the token purchase, and the Fuel Station executes the smart contract posting. All finalized smart contracts and associated metadata—including fuel type, volume, cost, wallet address, timestamp, and unique contract identifiers—are transmitted via the DLT Interface to the Road Ledger DLT Network 201. The network executes the contract, transfers funds to the appropriate Facility Owner account, and retains a permanent, auditable transaction record. Finally, the Output Device(s) 351 on both platforms provide real-time user feedback in the form of transaction confirmations, cost breakdowns, fuel usage summaries, and contract execution receipts, ensuring transparency for the Road User and compliance validation for the Facility Owner.

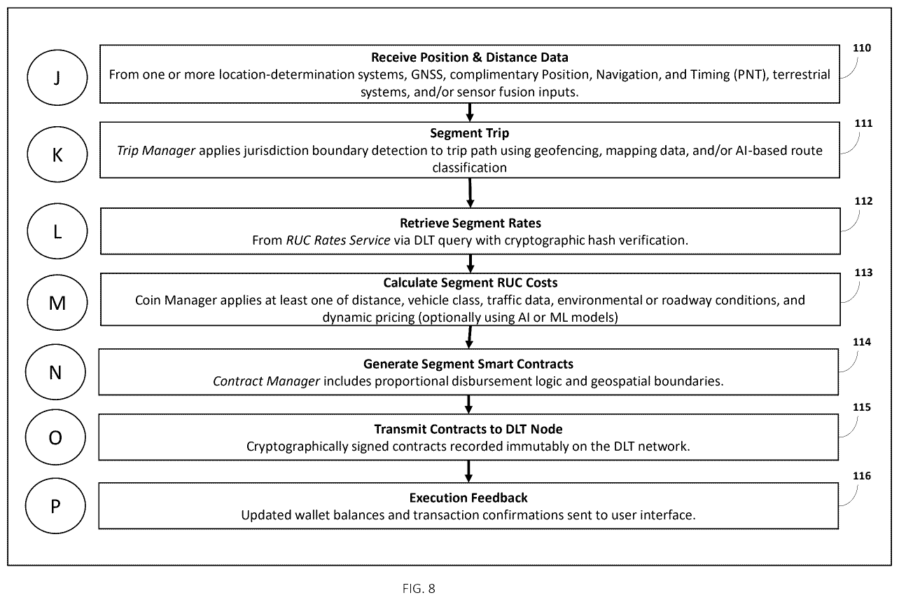

In reference to FIG. 8, a sub-process of the overall method 100 is depicted, providing detailed operations for trip segmentation, cost retrieval, smart contract generation, and execution. The sub-process begins when, at 110, the system receives position and distance data from one or more location-determination systems, which may include but are not limited to GNSS, complementary PNT, terrestrial positioning systems, satellite navigation constellations, cooperative positioning systems, and hybrid sensor fusion methods via the communication device 311. Sources may include on-board vehicle devices 908 such as electronic control units (ECUs), telematics units, connected vehicle (CV) platforms, automated driver assistance systems (ADAS), automated driving systems (ADS), cooperative automated driving systems (CADS), and mobile devices including smartphones, tablets, laptops, wearable devices, and vehicle-mounted IoT gateways. Positioning data may be derived from multi-constellation GNSS (e.g. GPS, Galileo, BeiDou, GLONASS, IRNSS, and etc.) with augmentation via Real-Time Kinematic (RTK) or Satellite-Based Augmentation Systems (SBAS), alternative satellite navigation constellations, complementary PNT, terrestrial positioning beacons, vehicle-to-infrastructure (V21) location transmitters, LiDAR SLAM, computer vision visual odometry, wheel speed sensors, IMU-based dead reckoning, or hybrid sensor fusion. Data transmission may occur over any combination of Personal Area Network (e.g. Bluetooth, BLE, NFC, RFID, ANT/ANT+, and etc.), Dedicated Short Range Communications (DSRC, IEEE 802.11p, 802.11bd), Cellular Vehicle-to-Everything (C-V2X, NR V2X), PC5 Sidelink, Local Area Networks (e.g. Wi-Fi 5/6/6E/7, Ethernet, TSN, and etc.), Wide Area Networks (e.g. LoRaWAN, Sigfox, NB-IoT, LTE-M, LTE, 4G, 5G, 6G, 7G mm Wave, and etc.), Mesh protocols (e.g. Zigbee, Z-Wave, Thread, 6LoWPAN, and etc.), and satellite communications (GEO, LEO, MEO), with security provided by TLS 1.3, DTLS, IPsec, and quantum-safe encryption such as QKD.

At 111, the Trip Manager applies jurisdiction boundary detection to the trip path using digital map layers, geospatial shapefiles, geofencing logic, and real-time jurisdictional data feeds and/or AI-based route classification. Position matching may use AI-enhanced map matching algorithms running on edge computing platforms such as NVIDIA Jetson Orin or Qualcomm Snapdragon Ride, integrating live traffic data from APIs (e.g. HERE, TomTom, INRIX, and etc.), on-board sensors, infrastructure-based IoT devices, and other data sources within the jurisdiction-specific boundary detection portions definitions stored in DLT-backed geospatial registries.

In some embodiments, jurisdiction boundary detection may employ multi-polygon overlays derived from cadastral or roadway databases, with preprocessing into hierarchical grid systems such as S2 or H3 for efficient lookup. Boundary crossings may be confirmed by polygon clipping operations, sweep-line intersection tests, or bounding box pre-filters. To improve resilience against GPS drift, detection logic may incorporate temporal hysteresis, requiring multiple consecutive fixes within a new jurisdiction before committing a boundary crossing. In further embodiments, learned models may augment polygon checks by classifying probable jurisdiction changes using historical driving traces and environmental features.

At 112, segment-specific rates are retrieved from the RUC Rates Service via secure DLT queries with cryptographic hash verification. The RUC Rates Service may store rate tables in on-chain key-value databases (e.g. LevelDB, RocksDB, and etc.), decentralized storage (e.g. IPFS, Filecoin, and etc.), or hybrid cloud-fog-edge repositories, with semantic version control for jurisdiction updates. Rates may include fixed, variable, congestion-based, or dynamically adjusted pricing based on distance, vehicle class, emissions category, fuel type, time-of-day, and jurisdictional policy rules. Integrity checks may use SHA-3, BLAKE3, or post-quantum secure hashing.

In some embodiments, the RUC Rates Service may distribute rate tables as cryptographically committed objects, with each version hashed using SHA3-256, BLAKE3, or equivalent secure hash functions. Verification of rate integrity may be accomplished by inclusion proofs in Merkle Patricia tries, sparse Merkle trees, or Verkle trees. Rates may be retrieved from DLT-anchored registries, cached in roadside edge servers, or delivered through secure APIs with mutual TLS authentication. To support predictive applications, the service may expose future-effective rate tables together with version metadata, enabling pre-calculation of expected costs prior to trip initiation.

At 113, the Coin Manager calculates the RUC cost per segment by applying at least one of distance, vehicle class, traffic conditions, environmental or roadway conditions, and dynamic pricing rules, using AI or ML algorithms including but not limited to weighted summation, regression analysis, gradient boosting, or reinforcement learning. Input data may be retrieved from vehicle CAN bus protocols (J1939, OBD-II), sensor fusion engines, and external traffic and environmental data services. AI prediction models may forecast future rate adjustments and optimize currency consumption to minimize transaction overhead.

At 114, the Contract Manager generates segment-specific smart contracts including proportional disbursement logic, Facility Owner wallet addresses, geospatial boundaries, and jurisdictional metadata. Smart contracts may be implemented in Solidity, Rust, Go, or AssemblyScript, with support for time-locked conditions, multi-signature requirements, zero-knowledge proof verification, and formal verification techniques (Certora, KEVM) to ensure compliance and prevent vulnerabilities.

In some embodiments, the Contract Manager may generate smart contracts that include explicit fields such as segment ID, geofence hash, route commitment encoded as a Merkle root or polyline hash, rate table version, calculated charge amount, timestamps, and a nonce. Contracts may be digitally signed using structured-data signing domains such as EIP-712 or EdDSA domain separation schemes, and may incorporate access control lists, replay protection using per-segment nonces stored in a ring buffer, and reentrancy guards to prevent contract manipulation. Settlement efficiency may be improved by accepting compact proofs such as Merkle proofs, polynomial commitment proofs, or succinct zero-knowledge proofs (zk-SNARKs, zk-STARKs) attesting to route commitments, thereby reducing verification gas costs and capping on-chain storage requirements. In further embodiments, smart contracts may support automated proportional disbursement to multiple Facility Owners, execution under time-of-day constraints, or conditional logic tied to environmental or congestion parameters.

At 115, cryptographically signed contracts are transmitted to the DLT node for execution using secure protocols (e.g. TLS 1.3, QUIC, DTLS, and etc.) and resilient networking methods such as multi-path TCP and failover routing. The DLT node may be a full node, light client, or relay node participating in consensus mechanisms including proof-of-stake (POS), proof-of-authority (PoA), PBFT, or DAG-based consensus.

In some embodiments, transmission of smart contracts and associated transactions may employ secure transport protocols such as gRPC with mutual TLS authentication, HTTPS/2 with TLS 1.3, QUIC-based secure channels, or WebSocket Secure (WSS). Transactions may be serialized using compact formats such as CBOR or Protocol Buffers, and may be batched, streamed, or prioritized based on contract expiration times. In environments with intermittent connectivity, contracts may be cached locally using LevelDB, SQLite, or append-only log structures, cryptographically validated upon reconnection, and resubmitted in the correct sequence order to maintain compliance.

Finally, at 116, execution feedback is generated, including updated wallet balances, transaction confirmations, and immutable ledger entries, which are transmitted to at least one user interface associated with a Road User and/or Facility Owner. Alerts may be delivered to Road User and Facility Owner interfaces via MQTT, WebPush, SMPP SMS, or secure WebSocket events. Ledger entries may be archived to decentralized storage with erasure coding for durability, and privacy-preserving proofs such as zk-SNARKs may be used for regulatory audits without exposing personal or trip-identifying information.

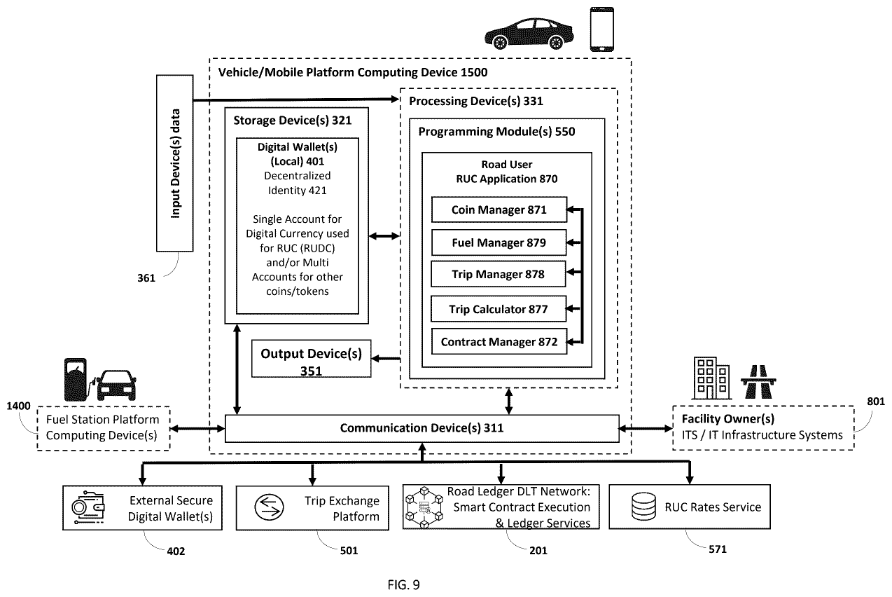

In reference to FIG. 9 is a flow diagram of a method for facilitating the generation of transaction(s) of digital currency in the form of policies and smart contracts to the DLT Network 201 for facilitating the collection of Road User Charges (RUC), in accordance with some embodiments. The RUC Application 870 may be hosted onboard a Vehicle/Mobile Platform Computing Device 1500 or on a mobile device. The Coin Manager 871, a core module within the RUC Application 870, is responsible for calculating the exact quantity of RUC-specific digital currency (RUDC) required for a given fueling event or trip segment. This calculation is performed by combining multiple data inputs, including the current balance stored in the Digital Wallet(s) 720, the projected distance of travel based on declared trip or fueling range, historical trip data, and applicable RUC rate structures retrieved from the RUC Rates Service 571. The Coin Manager 871 may also factor in variable pricing attributes such as congestion-based surcharges, vehicle type multipliers, or time-of-day adjustments, as defined by the Facility Owner 801.

The Coin Manager 871 executes predictive models such as Long Short-Term Memory (LSTM) recurrent neural networks for trip-level forecasting and Graph Neural Networks (GNNs) for congestion-aware adjustments. Forecast cycles are bounded to ≤T milliseconds and prediction error constrained to ≤α %, ensuring low-latency, accurate currency estimation.

The RUC Rates Service 571, stored and maintained within the distributed ledger ecosystem, provides real-time cost data for every roadway segment in the network. Each entry is indexed by facility identifier, vehicle class, and jurisdiction. The service can return static rates for fixed-pricing jurisdictions or dynamically updated rates calculated from congestion feeds, weather inputs, and network-level optimization algorithms. The Facility Owner 801 is responsible for publishing and maintaining their segment rates into the RUC Rates Service 571, ensuring the Trip Calculator 877 and Coin Manager 871 have authoritative data for policy generation.

The Coin Manager 871 captures the complete trip route, splitting it into discrete “segments,” where each segment is defined as a continuous stretch of travel under the same Facility Owner's jurisdiction. It then compiles per-segment distance measurements collected by the Trip Manager 878, which uses RUC Input Device(s) 361 such as Global Positioning System (GPS) data, Inertial Measurement Unit (IMU) readings, odometer pulses, digital map coordinates, on-board telematics, and cellular or satellite telemetry. The Trip Manager 878 may continuously verify Facility Owner jurisdiction using map overlays and geofencing logic, ensuring accurate segmentation even in overlapping or boundary areas.

The Trip Manager 878 applies Hidden Markov Model (HMM) map-matching with Viterbi decoding over an R-tree-indexed road graph, fuses GNSS signals (≥1 Hz) with odometer and IMU data (≥100 Hz) via an Extended Kalman Filter (EKF), and computes facility boundaries using S2/H3 polygon tiling with point-in-polygon tests and polygon clipping at intersections. It maintains a ring buffer of Q kilobytes and prunes candidate states to beam width B, guaranteeing bounded memory and ≤T ms latency.

Once the segment distances are confirmed, the Trip Calculator 877 multiplies each segment's length by the applicable rate from the RUC Rates Service 571, producing a per-segment RUC cost. It then aggregates all segments to form a total trip cost, while also generating metadata such as trip IDs, Facility Owner IDs, timestamps, and applied pricing model references for auditing. The Trip Calculator 877 prepares the raw policy and smart contract parameters and sends them to the Contract Manager 872 for assembly and cryptographic signing.

The Contract Manager 872 builds a smart contract for each segment, embedding the RUC payment obligation in a blockchain-compatible format that can be deployed to the DLT Network 201. These smart contracts may be single-step transfers or hybrid contracts that include conditional triggers such as proof-of-trip completion, late payment penalties, or jurisdictional redistribution clauses. The Contract Manager 872 signs each contract using private keys associated with the Digital Wallet(s) 721 of the Road User and ensures compliance with network-level consensus requirements. Each contract encodes explicit fields (segment ID, geofence hash, route commitment as polyline hash/Merkle root, rate version, calculated amount, timestamp, and nonce). Replay protection is enforced via a nonce ring buffer keyed by segment ID, ensuring O(1) lookup. Compact Merkle proofs replace full per-vertex evidence, reducing storage overhead and capping gas consumption to ≤G units.

In some embodiments, the Contract Manager 872 is also configured to validate zero-knowledge proofs (ZKPs) prior to generating or posting a smart contract to the DLT Network 200. This ensures that settlement transactions are bound to cryptographically verifiable evidence, such as proof of trip distance or wallet balance sufficiency, without exposing personally identifiable or sensitive trip data. By integrating proof validation directly into the Contract Manager 872 workflow, the system ensures that every posted smart contract is accompanied by a privacy-preserving attestation consistent with the ZKP framework described above.

To post these contracts, the Contract Manager 872 communicates via Communication Device(s) 311, which manage secure connections using multiple protocols, including Transport Layer Security (TLS) over HTTPS for external API communication, gRPC for high-performance inter-service calls, MQTT for event-based updates, and optional satellite or mesh-network failover channels for remote environments. Supported network layers include Personal Area Network (PAN) protocols (Bluetooth, BLE, NFC, RFID), Local Area Network (LAN) protocols (Wi-Fi), Wide Area Network (WAN) protocols (LTE, 5G, 6G), mesh protocols (Zigbee, Z-Wave, Thread, 6LoWPAN), and satellite protocols (GEO, LEO, MEO). The Contract Manager 872 supports both cloud-mediated transaction relays and direct peer-to-peer settlement at roadside edge computing nodes for low-latency finalization.

The Fuel Manager 879 within the RUC Application 870 integrates fueling-related data streams into the trip and payment workflow. This includes fuel volume, type, source, and timestamps from onboard sensors, fueling station APIs, or private dispenser modules. When a fueling event occurs, the Fuel Manager 879 determines whether the motor fuel tax will be paid traditionally or deferred under the RUC model. If RUC is used, the Fuel Manager 879 notifies the Coin Manager 871 to adjust the RUDC purchase calculation accordingly. The fuel data is then archived in Storage Device(s) 321 for long-term retrieval, enabling retroactive reconciliation if the transaction is delayed due to offline conditions (e.g., unverified ADL operation). The Fuel Manager 879 also executes checksum validation on fueling event logs and stores hashes of sensor data in the DLT Network 201, ensuring immutability and fraud resistance.

The RUC Application 870's Output Device(s) 351 provide the Road User with detailed visualizations, including per-segment cost breakdowns, total trip costs, fuel summaries, smart contract IDs, payment confirmations, and regulatory compliance receipts. This ensures that all transactions are transparent and verifiable by both the Road User and the Facility Owner 801.

During offline operation, the RUC Application 870 caches trip history, segment definitions, fueling records, and pending smart contracts in the Storage Device(s) 321 until network connectivity is restored. Upon reconnection, the queued transactions are automatically submitted to the DLT Network 201, verified by the consensus layer, and permanently recorded for compliance auditing. Offline caching employs AES-256 symmetric encryption with HMAC authentication and stores data in append-only log structures. The log structure is pruned with a sliding window policy to cap storage usage at ≤M entries, while guaranteeing immutability through chained hashes.

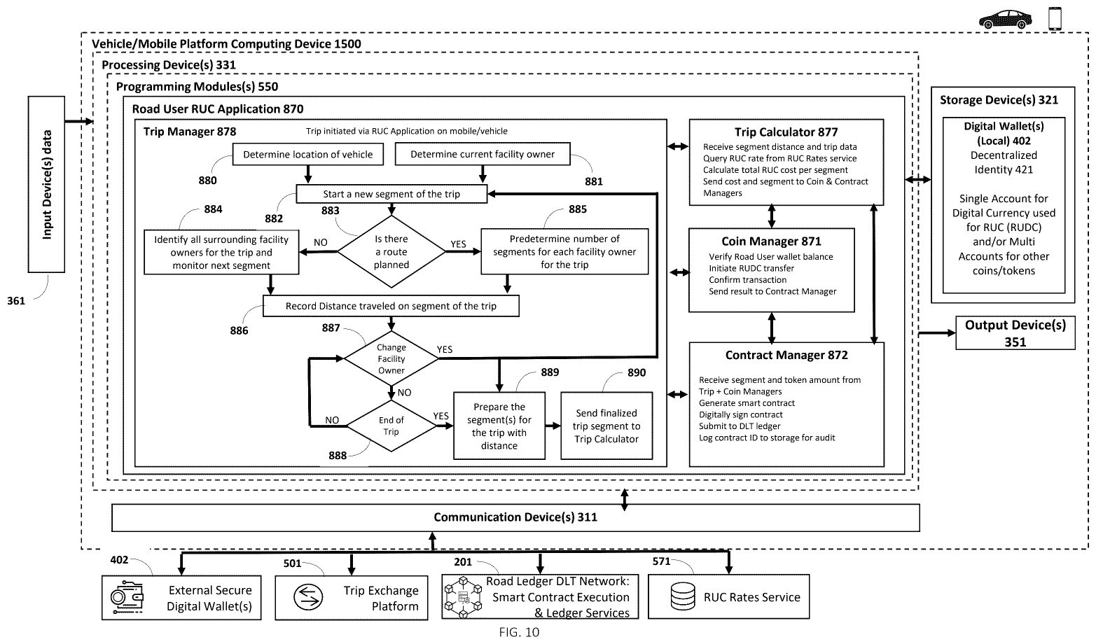

In reference to FIG. 10, a flow diagram of a method for facilitating and generating digital currency based on Facility Owners during a Road User trip determined by segments for facilitating the collecting of the RUC, in accordance with some embodiments is illustrated.

Accordingly, a trip may be defined as the start and end of a specific route taken on the roadway network. Further, the disclosed system may be configured for determining a start location of the vehicle and the current Facility Owner to start a first segment. The vehicle may follow a route or monitor nearby Facility Owners for no pre-planned driving. The trip may be broken into one or more segment(s). A segment is where the Facility Owner remains constant during the trip. As the Facility Owner changes, a new segment is started.

In some embodiments, the change of the Facility Owner from one segment to another can be detected by using sensors or cameras installed in a vehicle, communication device, input device or any device known in the art that can be connected to the present invention.

Accordingly, the method and system of present invention may include steps of determining, by the computing device via the processing device 331, a first Facility Owner segment location and a second Facility Owner segment location. Further, if the first Facility Owner segment location and the second Facility Owner segment location is different, at least one segment can be displayed on the digital map 888 showing trip progress of the Road user.

In some embodiments, the first Facility Owner segment location (which can be a point located at the rear side of the Road user/vehicle) and the second Facility Owner segment location (which can be a point located at the front side of the Road user/vehicle) can be detected at a predetermined distance from the Road user location so that the change of the Facility Owner can be properly detected when the two points (first and second Facility Owner segment locations) indicate different Facility Owner.

For example, the method may include a step of determining, by the computing device via the processing device 331, a first Facility Owner segment location and a second Facility Owner segment location. Further, in response to determining the first Facility Owner segment location and the second Facility Owner segment location, if the first Facility Owner segment location and the second Facility Owner segment location is different, at least one segment can be displayed on the digital map 888.

The Trip Manager 878 may also collect the distance traveled to be used in a policy and smart contract by the Contract Manager 872. Once a segment is completed then the Contract Manager 872 collects required data from Coin Manager 871, Trip Manager 878, and Trip Calculator 877, to meet the conditions of a policy and smart contract on the DLT network 200, for Road Use of the vehicle.

More specifically, Trip Manager 878 (described in FIG. 9) associated with the RUC Application 870 may capture the routes taken on a trip and break them into segments. A segment is part of a trip where the Facility Owner remains constant during the trip. The Trip Manager 878 may collect the distance traveled to be used in a policy and smart contract by the Contract Manager 872. Thus, according to the preferred embodiment, the method comprises, determining the location of a vehicle and current Facility Owner using data from RUC input device data by the Trip Manager 878 at 880, 881.

At 882, the method then starts a new segment by determining the start of a segment by the Trip Manager 878. At 883, the method further includes determining whether the trip is planned or not planned with pre-selected route by the Trip Manager 878, and recording distance data for each segment of a trip by the Trip Manager 878 at 884. If the route is planned, the method may use predetermine number of segments for each facility owner for the trip at 886 or if the route is not planned, the method may identify all surrounding facility owners for the trip and monitor next segment at 885.

If there is a change of Facility owner detected, the method may start a new segment of the trip at 887. At the end of the trip 890 and when the Facility owner is changed, the method may prepare the segment(s) for the trip with distance data at 889.

In the preferred embodiment, the Trip Calculator 877 (described in FIG. 9) prepares the total cost and processes the cost of each roadway segments to later be used by the Contract Manager 872. Accordingly, the method of the present invention comprises managing the cost for using each facility based on data from the Coin Manager 871 through the RUC Rates database 876 wherein the Trip Calculator 877 uses input from the Trip Manger 878 to prepare all the data needed to support transactions for the Contract Manager 872 for each segment owned by a different Facility Owner. Further, the Trip Calculator 877 gathers Facility Owner account/address information form the Coin Manager 871 through the RUC Rates database 876 for each segment provided by the Trip Manager 878 and determines the number of digital currency to be provided to the Facility Owners based RUC Rates for each transaction.

Continuing with the preferred embodiment, the Contract Manager 872 associated with the RUC Application 870 may prepare the policy and smart contract and required data to meet conditions for each segment of the trip and use the digital currency for payment of Road Use to post on the DLT network 200. To that end, the method comprises executing transaction of Digital currency, which are stored in the Road User digital wallet 720, from the Trip Calculator 877 for each segment of a trip on DLT network 200, using the Contract Manager 872. The method further comprises logging all transactions from the at least one Road User using the DLT network 200, for auditing purposes.

Further, the Trip Manager 878 may record the distance data for each segment(s), where the Facility Owner is constant, along the trip until the completion of the trip, and transfer this data to the Trip Calculator 877. Further, the Contract Manager 872 may execute transaction(s) of digital currency, that may be stored in the Road User digital wallet 720, from the Trip Calculator 877 for each segment and trip on the DLT network 200. Further, the Contract Manager 872 connects using a communication device 311 to the DLT network 200. Further, the Facility Owner may connect to the DLT network 200, through ITS/IT infrastructure systems (which may include wired and wireless communication devices, ITS roadside equipment, broadband connectivity and etc.) to connect Facility Owner digital wallet. Further, the Facility Owner receives the digital currency directly to a digital wallet from the Road User for each segment and trip using the DLT network 200.

Further, a Transaction Logger may be used by the Contract Manager 872 to record each smart contract submission for every segment, storing contract ID, timestamp, Facility Owner identity, and amount transacted to ensure auditing integrity.

In some embodiments, if the trip ends or the system loses connection to the DLT network, all pending segment data and transactions are stored temporarily in Storage Device(s) associated with the RUC Application and submitted later via the Contract Manager 872. The Trip Manager 878 and GUI may present a summary to the Road User, identifying completed and pending segment payments.

In reference to FIG. 10, a flow diagram of a method for facilitating and generating digital currency based on Facility Owners during a Road User trip determined by segments for facilitating the collection of the RUC, in accordance with some embodiments, is illustrated.

A trip may be defined as the start and end of a specific route taken on the roadway network. The disclosed system is configured to determine a start location of the vehicle and the current Facility Owner 801 to initialize the first segment. The vehicle may follow a pre-planned route or operate without a planned route, in which case the system monitors surrounding Facility Owners to determine segmentation dynamically. The trip is broken into one or more segments, where a segment is a continuous portion of travel under the jurisdiction of a single Facility Owner. When the Facility Owner changes, the system closes the current segment and begins a new one.

The change of Facility Owner from one segment to another can be detected using RUC Input Device(s) 361, which may include onboard sensors, GPS modules, IMU sensors, digital maps, cameras, vehicle telematics, or any connected input device capable of detecting jurisdictional boundaries. The Processing Device(s) 331, executing the Programming Module(s) 550 of the Road User RUC Application 870, determine both the first Facility Owner segment location and the subsequent Facility Owner segment location. If these locations differ, the change is confirmed, and at least one segment boundary is displayed on the user interface provided via Output Device(s) 351.

In some embodiments, the first and second Facility Owner segment locations may be calculated at a predetermined detection range from the vehicle's current location to ensure the change is processed in time for accurate contract and payment handling. This detection logic ensures both pre-planned and ad-hoc trips are segmented correctly and in real-time.

The Trip Manager 878 orchestrates this process using sub-steps as illustrated in FIG. 10: determining vehicle location 880 and current Facility Owner 881, starting a new trip segment 882, determining if the route is planned 883, identifying all surrounding Facility Owners for monitoring in non-planned trips 884, and predetermining the number of segments for each Facility Owner in planned trips 885. During travel, the Trip Manager records segment distance 886 and checks for changes in Facility Owner 887. If no change occurs, the trip continues in the current segment; if a change is detected, or the trip ends 888, the segment is finalized 889 and transmitted to the Trip Calculator 890.

The Trip Manager 878 executes Hidden Markov Model (HMM) map-matching with Viterbi decoding across an R-tree-indexed road graph, applies an Extended Kalman Filter (EKF) fusing GNSS updates (≥1 Hz) with odometer and IMU inputs (≥100 Hz) to mitigate drift, and runs point-in-polygon checks against S2/H3 jurisdiction polygons with polygon clipping at facility boundaries. The Trip Manager maintains a fixed-capacity ring buffer of Q kilobytes for candidate states and prunes to beam width B, bounding working memory and ensuring ≤T ms per-fix latency.

The Trip Calculator 877 receives segment data and queries the RUC Rates Service 571 for the applicable Facility Owner rates. It calculates total RUC cost for each segment, aggregates costs for the trip, and sends cost and segment data to the Coin Manager 871 and Contract Manager 872. The Trip Calculator 877 also compiles Facility Owner 801 account and address data, retrieved via the Coin Manager 871 from the RUC Rates Service 571, and determines the precise number of RUDC to be transferred.

The Trip Calculator 877 maintains rate data in a version-controlled Merkle trec, with each rate-table leaf hashed and anchored in the DLT Network 201. This allows compact Merkle proofs of rate authenticity to be included in downstream smart contracts, preventing tampering.

The Coin Manager 871 verifies the Road User's Digital Wallet(s) 721 balance, initiates the RUDC transfer, and confirms the transaction status. This module can process transactions directly from locally stored digital currency or acquire additional RUDC from the Trip Exchange Platform 501 if necessary.

The Coin Manager 871 executes double-spend prevention checks using a UTXO-style ledger model and caches pending debits in a journaled log structure with chained hashes, ensuring integrity until confirmation by the DLT consensus layer.

The Contract Manager 872 assembles the smart contract payload for each segment, embedding payment obligations in a blockchain-compatible format for deployment to the DLT Network 201. Each contract is digitally signed using private keys stored in the Digital Wallet(s) 721, then transmitted using Communication Device(s) 311. Supported communication layers include PAN (Bluetooth, BLE, NFC, RFID), LAN (Wi-Fi), WAN (LTE, 5G, 6G), mesh protocols (Zigbee, Z-Wave, Thread, 6LoWPAN), and satellite protocols (GEO, LEO, MEO). Secure transmission protocols include TLS over HTTPS, gRPC, and MQTT, with optional satellite or mesh failover for remote segments.

Each contract encodes explicit fields (segment ID, geofence hash, polyline commitment/Merkle root, rate version, calculated amount, timestamp, and nonce). Nonce replay protection is handled via an O(1) lookup ring buffer keyed by segment ID, and gas efficiency is achieved by requiring a single compact Merkle proof of the committed route rather than per-vertex evidence. Contracts enforce access control lists, signature validation via EIP-712 domains, and reentrancy protection to prevent contract hijacking.

The Facility Owner(s) 801 connect to the DLT Network 201 via ITS/IT infrastructure, which may include wired and wireless devices, ITS roadside units, broadband connections, and cloud-based service interfaces. The Facility Owner receives digital currency directly into its wallet for each completed segment.

A Transaction Logger integrated with the Contract Manager 872 records each smart contract submission, storing the contract ID, timestamp, Facility Owner ID, and transaction amount to ensure audit integrity.

The Transaction Logger implements an append-only log with chained hashes, enabling regulators to audit compliance without revealing personally identifiable trip data. Logs are periodically anchored into the DLT Network 201 using vector commitments, ensuring tamper-proof audit trails.

In offline scenarios, all segment data, smart contracts, and pending RUC transactions are cached in Storage Device(s) 321 until connectivity is restored. Upon reconnection, queued transactions are automatically submitted to the DLT Network 201 for validation and permanent ledger inclusion. The Trip Manager 878 and associated GUI present a summary to the Road User, showing completed and pending segment payments, per-segment costs, and compliance confirmations.

Offline caching uses AES-256 encryption with HMAC authentication. Data is stored in a rolling append-only structure with a sliding window retention policy, limiting storage to ≤M entries while ensuring continuity once reconnected.

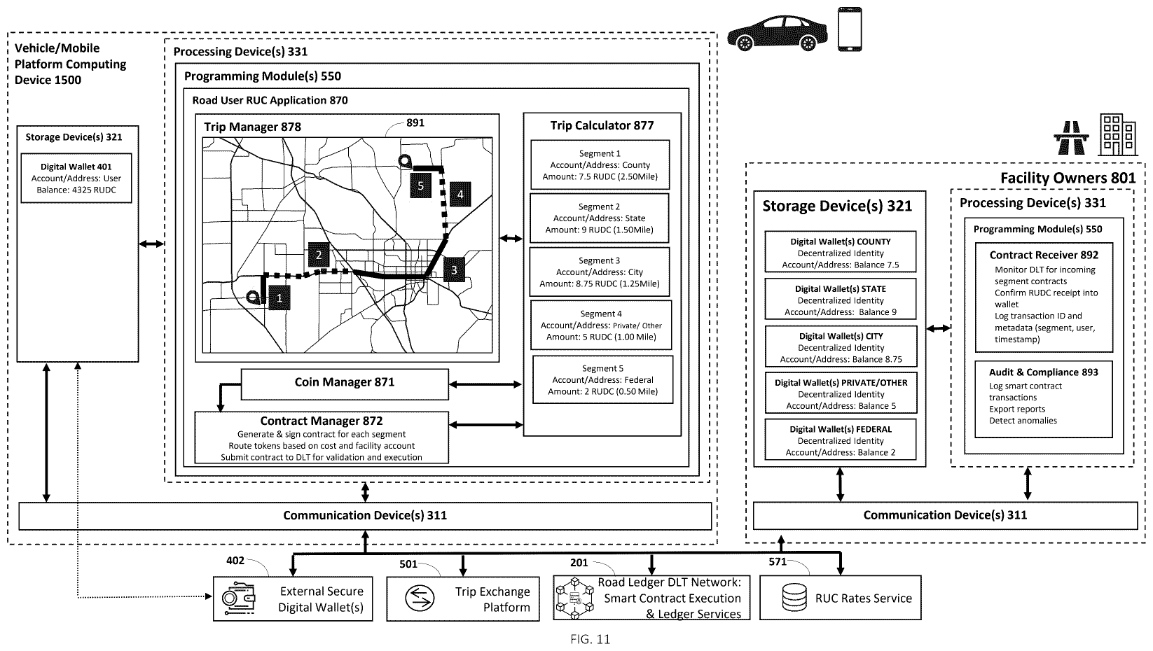

In reference to FIG. 11, a flow diagram of a method for facilitating and generating transaction(s) of digital currency by segments of a trip based on Facility Owners 801 for facilitating the collection of the RUC, in accordance with some embodiments, is illustrated. Each segment may be transmitted to the appropriate Facility Owner 801 through a policy and smart contract on the DLT Network 201. Each policy and smart contract may include the digital currency attached as payment for road use on the facility. In the preferred embodiment, road owners and operators may be separated into different categories (i.e., Federal, State, County, City, Private, Other, etc.) for RUC collection. Each road owner may have their own account/unique ID and act as a Node in the DLT Network 201 (including, but not limited to, implementations using Directed Acyclic Graph, Hyperledger, or Blockchain technologies). Each facility of a road owner may be linked to an account on the DLT Network 201. Facility Owners 801 may exchange digital currency for fiat currency using the Trip Exchange Platform 501 account manager.

Digital currency distribution is determined based on the vehicle route and which facilities are used during the trip. The Trip Manager 878 may include a digital map 891 with a control layer configured to link facilities to account addresses on the DLT Network 201 associated with the corresponding Facility Owner 801. Each segment may be tagged with a Segment ID and an associated Facility Type label (e.g., Federal, State, Local) to route digital currency to the correct account. The distance traveled on each road facility is used to determine the amount of digital currency to distribute via a policy and smart contract. These policies and contracts may execute when exiting a facility (upon a Facility Owner change) or at the end of a trip, as managed by the DLT Network 201. If connectivity is unavailable, the Vehicle/Mobile Platform Computing Device 1500 or mobile device may store the transaction(s) locally until connectivity is restored.

The Coin Manager 871 segments the trip based on Facility Owner categories and receives RUC Rates from the RUC Rates Service 571, which may define costs using stable, variable, or dynamic pricing models based on travel distance, vehicle type, congestion, or other relevant parameters. The Trip Calculator 877 prepares all transactions for the Contract Manager 872 for each segment owned by a different Facility Owner 801, assigning a unique Segment Identifier and cross-referencing facility ownership data, applicable pricing tiers, and contract templates for each roadway type. The Trip Calculator 877 gathers account/address information from the Coin Manager 871 and calculates the number of RUDC required for each transaction based on distance traveled and applicable RUC Rates.

The Contract Manager 872 generates and signs a smart contract for each segment using the cost data and segment metadata provided by the Trip Calculator 877. Each smart contract includes the destination Facility Owner 801 account/address, the cost in RUDC, and associated policy terms. The Contract Manager 872 then routes the exact amount of RUDC to the Facility Owner account based on the pricing and ownership of the roadway segment and submits the smart contract to the DLT Network 201 for validation and execution.

The Contract Receiver 892 is configured to monitor the DLT Network 201 for incoming smart contracts addressed to the Facility Owner 801 Digital Wallet(s) 321. Upon detecting a contract, the Contract Receiver 892 confirms RUDC receipt and logs metadata such as the Segment ID, Road User address, timestamp, and contract ID. The Audit & Compliance module 893 records the history of smart contract transactions, exports operational and compliance reports, and flags anomalies or mismatches in transaction behavior or payment patterns, ensuring traceability, transparency, and audit readiness for all RUC-related activity.

The Contract Manager 872 may execute transaction(s) of digital currency stored in the Road User's Digital Wallet(s) 721 for each segment and trip determined by the Trip Calculator 877. A Transaction Logger records contract execution events, including the timestamp, wallet address, amount transacted, and segment identifier, for compliance and auditing. The Contract Manager 872 may log all transaction(s) from the Road User using both onboard Storage Device(s) 321 and the DLT Network 201 for redundancy and audit purposes. The Facility Owner 801 receives RUDC directly to its Digital Wallet(s) 321 from the Road User for each segment and/or trip using the DLT Network 201. Facility Owners 801 may transfer digital currency from their Digital Wallet(s) 321 to the Trip Exchange Platform 501 and exchange it for fiat currency or other digital currencies. All segment-based transactions may be reconciled within the Trip Exchange Platform 501 using transaction metadata and audit logs provided by the Transaction Logger and Contract Manager 872, ensuring complete traceability of digital currency flows from Road Users to the appropriate Facility Owner nodes.

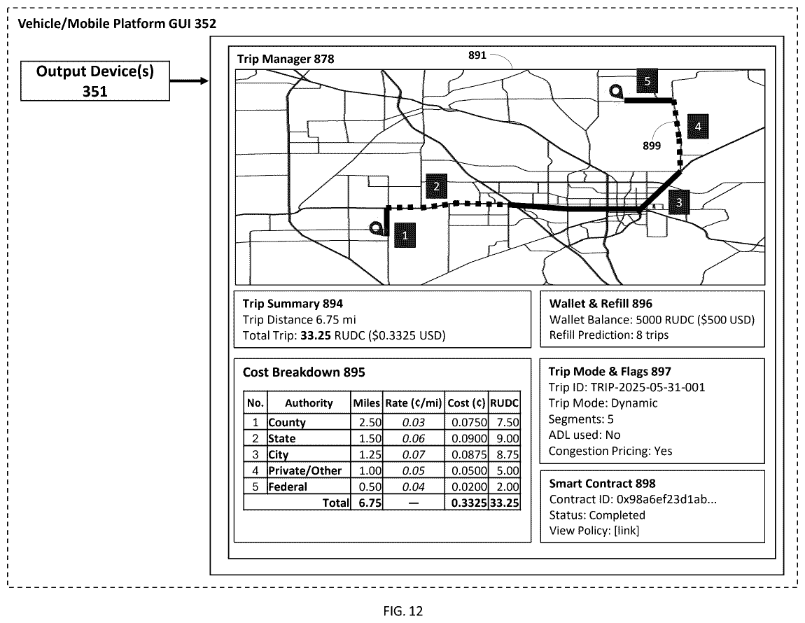

In reference to FIG. 12, a user interface of the Road User RUC Application is illustrated, showing the Vehicle/Mobile Platform GUI 352 hosted on a mobile device or integrated vehicle computing system, in accordance with some embodiments of the present invention. This interface enables the Road User to visualize key trip and payment data in real time, and interact with the system during or after road usage events.

The interface is rendered via Output Device(s) 351 and comprises multiple modules and visual elements linked to data processed by the Trip Manager 878, Trip Calculator 877, Coin Manager 871, and Contract Manager 872, reflecting the state of transactions on the DLT Network 201.

The Trip Summary 894 module displays the total trip distance (in miles or kilometers) and the computed total RUC cost expressed in RUDC along with its fiat equivalent (e.g., $0.3325 USD). This value is calculated from the cumulative costs of all roadway segments traversed during the trip and is based on per-segment cost data returned by the RUC Rates Service 571.

The Cost Breakdown 895 module provides a segmented view of cost components, including Facility Owner authority type, miles traveled, per-mile rates (which may be stable, variable, or dynamically priced), and the total RUDC for each segment. This table helps the Road User identify which segments or Facility Owners contribute most to the total cost.

The Wallet & Refill 896 module shows the current RUDC balance in the Road User's Digital Wallet(s) 721. It also displays a refill prediction, estimating when additional RUDC will be needed based on current balance, historical usage patterns, and projected travel distance. This prediction may leverage AI/ML models integrated into the RUC Application for personalized forecasting.

The map-based Segment Display Layer 891—powered by the Trip Manager 878—presents visual representations of current and completed trip segments, ownership boundaries, and Facility Owner transitions. Each segment may be tagged with a unique Segment ID 899 and labeled with the corresponding Facility Owner and associated costs.

The Trip Mode & Flags 897 panel displays key trip metadata such as trip ID, mode type (e.g., dynamic or static), number of segments, whether Automated Distance Logging (ADL) was used, and any active pricing mechanisms such as congestion charges.

The Smart Contract 898 panel provides contract-specific data for the trip, including the blockchain contract ID, current execution status, and a link to view the policy or transaction record directly on the DLT Network 201 via the Transaction Logger.

By combining these modules into the Vehicle/Mobile Platform GUI 352, the Road User is given a detailed, real-time operational and financial view of trip progress, segment costs, wallet status, and smart contract execution—supporting transparency, compliance, and payment assurance across the RUC ecosystem.

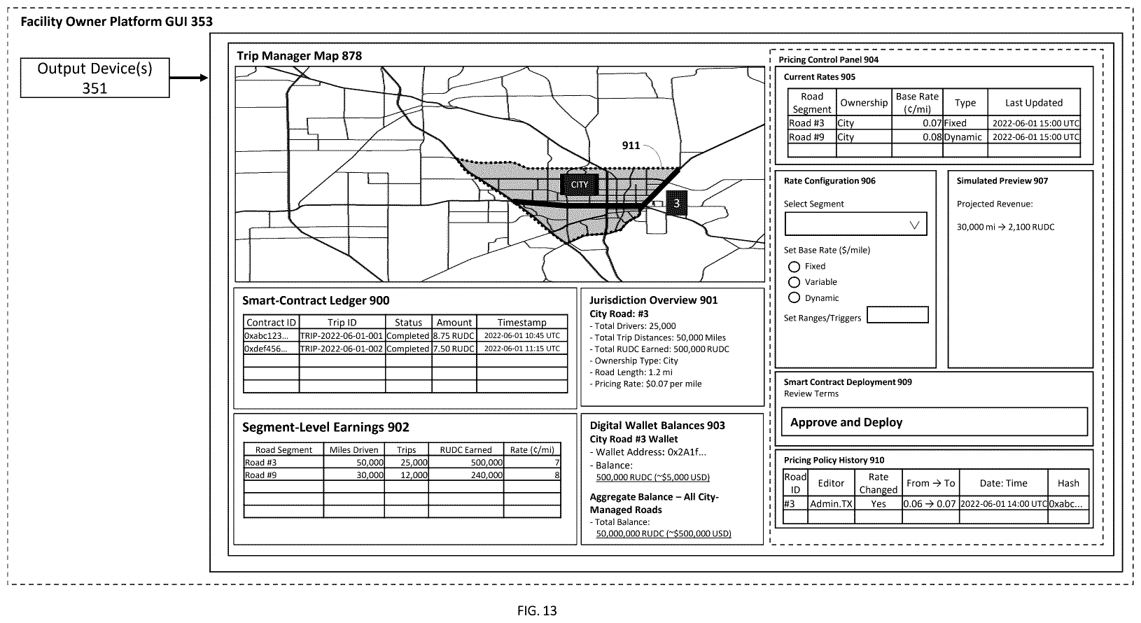

In reference to FIG. 13, a Facility Owner Platform Graphical User Interface (GUI) 353 is illustrated, showing a detailed operational dashboard hosted on a computing device accessible to Facility Owners 801. This interface enables Facility Owners to monitor incoming Road User Charges (RUC) collected via the DLT Network 201, adjust pricing structures, verify smart contract execution, and manage jurisdiction-level revenue with audit-ready transparency. The GUI is presented through Output Device(s) 351 and integrates backend data from the Trip Manager Map 878, Contract Receiver, Transaction Logger, Coin Manager 871, RUC Rates Service 571, and associated storage systems.

The central Trip Manager Map 878 displays segment-specific jurisdiction boundaries with visual overlays indicating ownership and cost associations for each roadway segment. In this example, the City jurisdiction segment is highlighted as 911, showing a segment labeled “CITY” with a segment identifier 3, which is consistent with the trip data originating from the Road User interface (FIG. 12). This live geospatial layer allows Facility Owners to correlate on-map roadway segments to jurisdiction accounts for contract verification and pricing analysis.

The Smart-Contract Ledger 900 provides a tabular listing of executed smart contracts relevant to the Facility Owner. For each entry, it records the contract ID, trip ID, contract execution status, RUC payment amount in RUDC, and a precise timestamp in UTC. These contracts originate from the Contract Manager 872 and are validated on the DLT Network 201 before appearing in this ledger. The ledger is integrated with the Transaction Logger, ensuring immutable storage of these records for compliance auditing.

In some embodiments, the Contract Manager 872 encodes privacy-preserving audit fields into smart contracts, which are then displayed through the Facility Owner graphical user interface (GUI 353). These audit fields enable regulators to verify compliance with RUC policies without accessing sensitive trip-level personal data. The audit fields may be encoded using homomorphic encryption, zero-knowledge range proofs, or decentralized identifiers, and are validated against cryptographic state proofs retrieved from the DLT Network 201. The Facility Owner GUI 353 may expose these audit attestations through an authenticated API, enabling regulators to confirm jurisdictional compliance while preserving Road User privacy.

The Jurisdiction Overview 901 delivers a real-time statistical profile of the selected road segment, in this case, “City Road #3.” This module presents total drivers counted, aggregate trip distances, total RUDC earned, ownership classification (e.g., city-managed), physical road length, and the active RUC pricing rate per mile. The data is cross-referenced with the RUC Rates Service 571 to ensure current and accurate rate representation.

The Segment-Level Earnings 902 module compiles aggregated financial performance metrics for each managed road segment. For each listed segment, it shows total miles driven, number of trips, RUDC earned, and the corresponding RUC rate per mile. The values are computed from incoming transaction data, enabling revenue trend analysis across different roadway assets.

The Digital Wallet Balances 903 module shows the Facility Owner's wallet addresses and their respective balances for specific segments (e.g., City Road #3) as well as an aggregate total across all managed roads. Each wallet balance is expressed in RUDC and optionally in fiat currency equivalents. Facility Owners can link these wallets directly to the Trip Exchange Platform 501 to convert RUDC into fiat or alternative cryptocurrencies.

The Pricing Control Panel 904 contains the Current Rates 905 table, which lists active roadway segments under the Facility Owner's jurisdiction, their ownership classification, base rate in cost per mile, pricing type (fixed, variable, or dynamic), and the last updated timestamp. The Rate Configuration 906 submodule enables Facility Owners to modify the base rate for a selected segment and define triggers or ranges for variable or dynamic pricing models. The Simulated Preview 907 calculates projected revenue based on modeled traffic volumes and selected pricing rules, offering real-time forecasting before pricing changes are deployed.

The Smart Contract Deployment 909 panel allows Facility Owners to review and approve updated pricing terms before publishing them to the DLT Network 201. Upon approval, the updated pricing data is integrated into future contract executions, ensuring immediate application for incoming RUC transactions.

The Pricing Policy History 910 records prior rate modifications for auditing purposes. Each entry logs the road ID, editor ID, confirmation of rate change, the “from” and “to” rates, the date and time of change, and the transaction hash. This ensures pricing change history is tamper-proof and verifiable through the DLT ledger.

The map overlay identifier 911 is used to visually correlate a segment on the Trip Manager Map 878 to the jurisdictional data within the dashboard modules, ensuring that Facility Owners can quickly cross-reference geographical segments to financial and contractual records in real time.

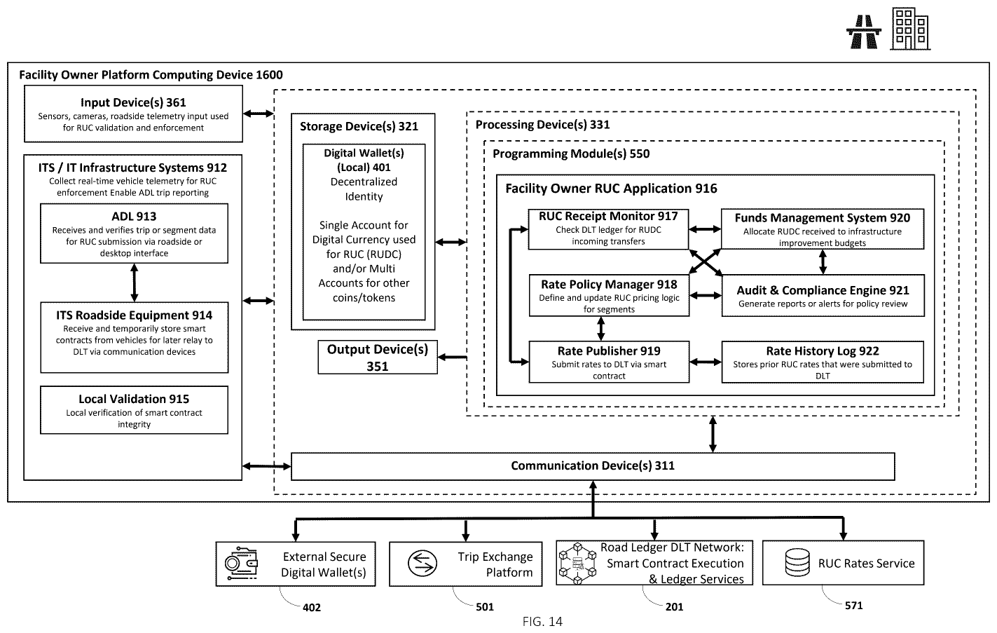

In reference to FIG. 14, a block diagram of a Facility Owner Platform Computing Device 1600 and associated ITS/IT Infrastructure Systems 912 is illustrated, in accordance with some embodiments of the present invention. The platform is designed to perform continuous monitoring, validation, publication, and management of Road Usage Charge (RUC) transactions, segment-based usage data, and smart contract execution using a Distributed Ledger Technology (DLT) Network 201. The system integrates roadside telemetry, cryptographic validation, decentralized wallet management, and policy-based rate configuration into a unified operational environment.

The system may include one or more Input Device(s) 361 capable of acquiring roadway usage data, including GNSS-based position tracking, complementary PNT, inertial measurement unit (IMU) readings, LIDAR/RADAR sensor data, high-resolution camera imagery, and DSRC/C-V2X telemetry messages from equipped vehicles. These devices capture the spatial and temporal parameters required for accurate segmentation and RUC computation. Data from these devices is timestamped, signed using hardware security modules (HSMs), and transmitted to the ITS/IT Infrastructure Systems 912 for processing. The ITS/IT Infrastructure Systems 912 aggregate and pre-process telemetry in real time, validating location, movement patterns, and jurisdiction boundaries against GIS-based facility maps. The ADL 913 module receives and verifies trip or segment-level data submissions via roadside kiosks, enforcement terminals, or desktop-based interfaces. The ADL may also implement offline queuing logic for delayed submission when network connectivity is unavailable, with cryptographic hash pre-commitment to ensure data integrity at the time of capture.

The ITS Roadside Equipment 914 serves as an edge collection and relay system, storing incoming smart contract payloads from Road User devices in tamper-evident storage before forwarding them via Communication Device(s) 311 to the Facility Owner computing device. Local Validation 915 modules execute cryptographic signature verification, smart contract syntax validation, and compliance checks to ensure that incoming contracts adhere to predefined policy schemas before allowing propagation to the DLT Network 201. The Facility Owner Platform Computing Device 354 incorporates one or more Storage Device(s) 321, which maintain Digital Wallet(s) (Local) 401 with decentralized identity integration for authentication and authorization. These wallets store RUC Digital Currency (RUDC) balances and can be configured in single-account mode for centralized accounting or multi-account mode for segregating facility-specific funds. All wallet transactions are logged with full metadata, including transaction IDs, contract references, GPS-based location stamps, and facility ownership identifiers.

A Processing Device 331, executing Programming Module(s) 550, runs the Facility Owner RUC Application 916, which comprises multiple subsystems. The RUC Receipt Monitor 917 continuously queries and subscribes to the DLT Network 201 for transactions addressed to the Facility Owner's wallet(s), validating Merkle proofs, confirming block inclusion or DAG tip confirmation, and verifying that the received RUDC amounts and contract IDs match expected settlement data from prior rate publications. Discrepancies trigger exception handling routines and notify the Audit & Compliance Engine 921. The Rate Policy Manager 918 maintains a policy ruleset for each roadway segment, including static rate tables, congestion-adjusted rates, time-of-day modifiers, vehicle class adjustments, and special event surcharges, while integrating with external traffic analytics APIs, weather feeds, and maintenance schedule databases to dynamically adjust rates. All policy updates are version-controlled with hash commitments stored in the Rate History Log 922. The Rate Publisher 919 packages active rate policies into smart contract payloads, signs them using the Facility Owner's private key stored in a secure enclave, and broadcasts them to the DLT Network 201, embedding effective timestamps and cryptographic links to prior rate versions to ensure atomicity and verifiable lineage.

The Funds Management System 920 classifies incoming RUDC transactions into budgetary categories such as maintenance, capital improvements, or toll facility debt service based on predefined allocation rules. This subsystem supports multi-signature authorization for fund transfers, automated conversion of RUDC to fiat via the Trip Exchange Platform 501, and configurable retention of digital currency reserves for future projects. The Audit & Compliance Engine 921 monitors transaction patterns for anomalies such as duplicate payments, rate mismatches, or out-of-sequence contract submissions, cross-referencing incoming smart contracts with stored Rate History Log 922 entries and published facility boundaries, and producing cryptographically signed audit reports for regulatory review. The Rate History Log 922 functions as an immutable ledger of all prior rate publications and associated metadata, including contract hashes, effective dates, jurisdiction IDs, and facility ownership references, ensuring historical traceability and detection of unauthorized modifications.

Communication Device(s) 311 facilitate secure, bidirectional exchange between the Facility Owner Platform, Road Users, External Secure Digital Wallet(s) 402, the Trip Exchange Platform 501, the DLT Network 201, and the RUC Rates Service 571, using encryption protocols such as TLS 1.3 or QUIC with optional post-quantum cryptographic primitives. Output Device(s) 351 provide Facility Owner personnel with real-time dashboards, compliance alerts, rate configuration interfaces, and fund allocation overviews through secure GUI sessions.

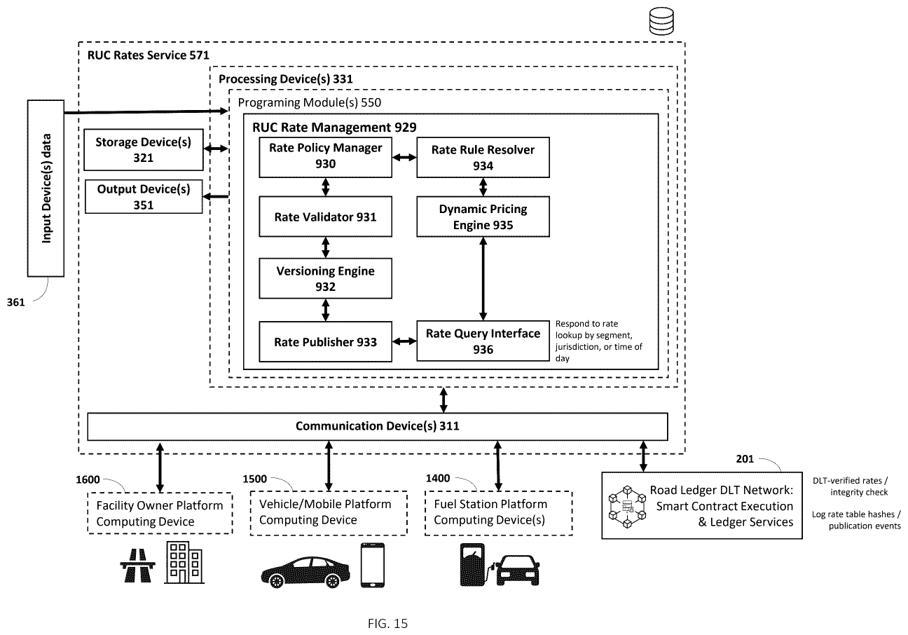

In reference to FIG. 15, a block diagram of a RUC Rates Service 571 is illustrated, in accordance with some embodiments of the present invention. The RUC Rates Service 571 operates as a centralized backend infrastructure layer responsible for the authoritative management, validation, publication, and query resolution of Road Usage Charging (RUC) rates across multiple roadway segments, jurisdictions, and Facility Owners. This service functions as the single source of truth for pricing logic used in smart contract generation and execution across diverse platform types, including Facility Owner Platform Computing Devices 1600, Vehicle/Mobile Platform Computing Devices 1500, and Fuel Station Platform Computing Devices 1400. The architecture is designed to ensure that all pricing data is accurate, version-controlled, cryptographically verifiable, and capable of supporting real-time lookups or dynamic pricing adjustments.

The system may include one or more input device(s) 361 configured to receive structured and unstructured rate update requests, jurisdictional pricing frameworks, vehicle class-based tariffs, energy type-specific multipliers, congestion-based modifiers, and fuel-related rate parameters from authorized Facility Owners or administrative entities. Incoming data may originate from secure APIs, administrative dashboards, or automated jurisdictional feeds.

One or more storage device(s) 321 may be configured to securely store active rate tables, historical rate archives, jurisdiction-specific mapping datasets, congestion pricing triggers, and all prior published rate table cryptographic hashes for later integrity verification. Storage may be organized to support high-speed indexing for rate retrieval requests from external systems, as well as regulatory audit requirements.

The system may further include one or more output device(s) 351 configured to generate and present rate lookup responses, publish rate update confirmations, and output detailed rate update logs containing jurisdiction, version ID, timestamp, and Facility Owner identifiers. These outputs are accessible to authorized Facility Owner dashboards, Vehicle/Mobile platform UIs, and Fuel Station POS systems for contract validation purposes.

At the core of the RUC Rates Service 571 is the RUC Rate Management module 929, executed by one or more programming module(s) 550 running on the processing device(s) 331. The RUC Rate Management module 929 comprises several tightly integrated subcomponents:

The Rate Policy Manager 930 defines, manages, and enforces high-level RUC pricing strategies for individual roadway segments or aggregated jurisdictional zones. It allows Facility Owners to create new rate schedules, apply tiered pricing rules, or make adjustments based on travel distance, vehicle classification, congestion level, environmental impact category, or propulsion type (e.g., gasoline, hybrid, electric).

The Rate Rule Resolver 934 translates the high-level policies from the Rate Policy Manager 930 into executable rule sets that can be uniformly applied during smart contract creation and validation. This translation includes normalization of cross-jurisdictional inputs, ensuring consistency in rate application across different Facility Owners and avoiding policy conflicts in shared infrastructure segments.

The Dynamic Pricing Engine 935 computes time-sensitive or congestion-triggered rate variations in real time. This may include peak-hour surcharges, off-peak discounts, seasonal rate adjustments, or temporary rate changes for construction zones. The engine continuously interfaces with the Rate Rule Resolver 934 to confirm compliance with jurisdictional regulations and predefined rate ceilings or floors.

The Rate Validator 931 performs syntactic, semantic, and regulatory compliance checks on all rate updates before they are eligible for publication. It verifies jurisdictional rule alignment, ensures version sequencing integrity with the Versioning Engine 932, validates DLT ledger rules, and flags any discrepancies for manual review before submission.

The Versioning Engine 932 maintains a complete immutable record of all historical rate versions, including the associated jurisdiction, Facility Owner, publication timestamp, and version hash. It enables time-travel lookups of rate data for auditing purposes and ensures that all historical rates remain accessible for legal or compliance verification.

In some embodiments, the RUC rate management ecosystem integrates with the privacy-preserving audit features of the Contract Manager 872. The Rate Publisher 933 and Rate Rule Resolver 934 record version-controlled rate tables that are cryptographically hashed and signed by Facility Owners. When applied, the Contract Manager generates smart contracts that include both the applicable rate version and an encrypted audit field. Regulators may query the system to confirm that the correct rate version was applied, without accessing personally identifiable trip data. This ecosystem ensures that rate publication, retrieval, and enforcement are tamper-evident and regulator-verifiable on the DLT Network 201.

The Rate Publisher 933 submits validated rate tables and pricing updates to the Road Ledger DLT Network 201 as cryptographically signed smart contracts. It records publication metadata, generates integrity verification hashes for each table, and logs the exact time of DLT acceptance for downstream reconciliation.

The Rate Query Interface 936 provides a secure, high-speed API endpoint for responding to rate lookup requests from authorized external systems, including Facility Owner platforms, Vehicle/Mobile platforms, and Fuel Station platforms. It supports queries based on roadway segment ID, jurisdiction, Facility Owner, vehicle classification, propulsion type, and time-of-day parameters, returning both static and dynamically adjusted rates in real time.

The communication device(s) 311 connect the RUC Rates Service 571 to external computing platforms, enabling bidirectional exchange of rate data, publication confirmations, and rate lookup responses. Published rates are cryptographically signed and stored on the DLT network 201, where the ledger verifies hash integrity, stores version metadata, and ensures public availability of the approved rates for downstream contract execution. In some embodiments, the service can also issue subscription-based rate change notifications to subscribed entities whenever rate adjustments affect their jurisdictions or assigned roadway segments, ensuring proactive compliance and contract pricing accuracy.

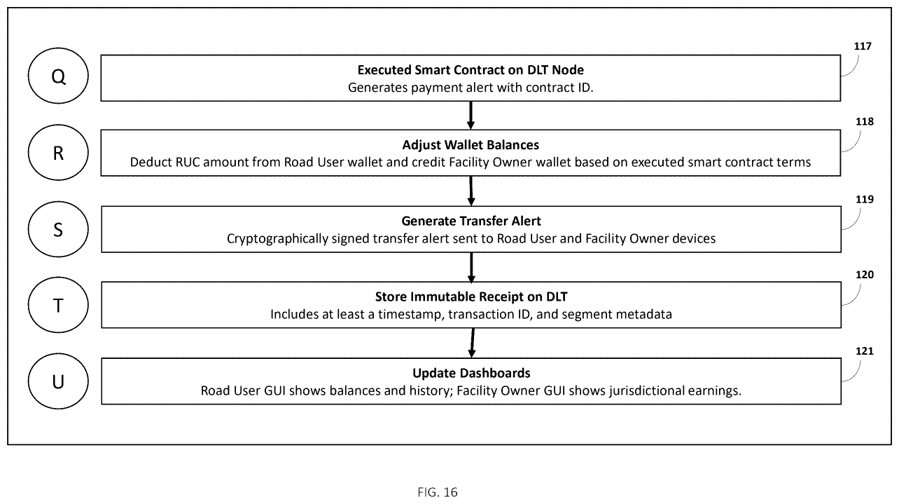

In reference to FIG. 16, the post-execution settlement subprocess begins when the distributed ledger confirms a previously submitted smart contract and emits an execution event; in Step Q, 117 (Executed Smart Contract on DLT Node) a validator finalizes the contract and publishes an event payload that contains a unique contract identifier, a consensus timestamp, a block or state reference, and a cryptographic commitment to the executed payment logic and outputs. The payload further identifies the rate version used, the list of jurisdictional segments covered by the contract, and a per-segment disbursement schedule derived from the encoded proportional rules. This event is delivered to settlement services through an authenticated messaging interface with idempotency tokens so downstream components can detect and safely ignore duplicates. Prior to any fund movement, the settlement service verifies finality of execution, validates that the referenced rate version is applicable to the covered travel window, and confirms signature validity from registered authorities. Where the DLT operates under eventual consistency, the service performs a proof-of-inclusion or multi-confirmation wait to ensure the event is anchored in an immutable ledger state.

Responsive to this execution event, the wallet subsystem performs atomic balance updates; in Step R, 118 (Adjust Wallet Balances) the system debits the Road User wallet and credits one or more Facility Owner wallets according to the per-segment disbursement schedule. Debit/credit operations execute as a single, indivisible transaction guarded by concurrency controls to prevent race conditions when multiple trips or fueling/charging events are processed in close succession. Before posting the debit, the subsystem enforces available-balance checks, spending limits, and, where configured, multi-party approval thresholds. For multi-jurisdiction contracts, credits are split per segment using programmed weights and policy-compliant rounding so the sum of credits equals the debit less any network or processing fees. If a credit target is temporarily unavailable (e.g., a custodial wallet undergoing key rotation), the affected portion is escrowed and marked as pending settlement so completion can occur asynchronously without blocking distribution to the remaining recipients. All intermediate states are written to a tamper-evident journal to enable replay and forensic analysis if a failure occurs mid-operation.

Following successful settlement, the platform issues signed acknowledgments suitable for off-chain notification, audit, and user display; in Step S, 119 (Generate Transfer Alert) the service constructs a transfer alert that includes at least the contract identifier, a transaction identifier, segment identifiers, payer and payee wallet references, token class, settled amounts per segment, the applied rate/policy references, and an integrity checksum. The alert is signed inside a secure execution environment using keys that remain in protected storage and is transmitted over confidential, authenticated channels to Road User and Facility Owner endpoints. To tolerate intermittent connectivity, alerts are queued for reliable delivery with authenticated retry and bounded back-off; endpoints acknowledge receipt, and acknowledgments are logged so alerts are not resent once confirmed. In some embodiments, the alert embeds or links to a privacy-preserving proof attesting to correct fee computation from committed inputs (e.g., segment distance and applicable rate) without exposing raw trip telemetry.

In some embodiments, the system generates cryptographically signed transfer alerts upon execution of a smart contract. The transfer alert includes a transaction hash, a regulator-verifiable state proof, and an updated balance for both the Road User and the Facility Owner. The alerts are transmitted over secure channels to user and owner devices, as well as to authorized regulators for compliance validation. Each transfer alert is recorded on the DLT Network 201 alongside the underlying smart contract, providing an immutable audit trail. This process ensures that settlement transactions are transparent, regulator-compliant, and verifiable in near real time.

The system then persists a durable audit artifact to the ledger; in Step T, 120 (Store Immutable Receipt on DLT) an immutable receipt object is recorded that includes at least the consensus timestamp, transaction identifier, contract identifier, payer and payee references, settled amounts, currency or token class, the set of covered segments, and the rate/policy versions used. The receipt is anchored to the ledger's hash-chain or tree-based commitment structure so reviewers can verify inclusion via standard membership proofs without access to private keys or personally identifiable data. Where regulation requires, a redacted form of the receipt is published for external reviewers while complete metadata is retained under access control within an archival store. Replication across validator nodes and retention policies ensure durability; if interoperable ledgers are used, a bridging record is also written to the destination network to reflect mirrored settlement, cross-referenced to the origin identifier.

Finally, presentation layers refresh state using authoritative records; in Step U, 121 (Update Dashboards) the Road User interface updates wallet balances, recent-activity lists, trip-level receipts, and projections of remaining balance versus planned travel based on the confirmed receipt, while the Facility Owner interface aggregates earnings by jurisdiction and segment, exposes per-transaction drill-down to receipt objects, and surfaces reconciliation status and exception queues for any escrowed or delayed credits. Both interfaces consume indexed views that materialize common filters (e.g., date, jurisdiction, route, vehicle class) and support export to regulatory reporting formats. Each dashboard action is correlated to underlying ledger identifiers so auditors can traverse from a displayed line item to the immutable receipt and, from there, to the executed-contract event, providing end-to-end traceability. Where endpoints were offline when the alert was first issued, the presentation layers obtain the alert and receipt upon reconnection, verify signatures and integrity checksums locally, and then mark corresponding notifications as acknowledged to complete the FIG. 16 subprocess.

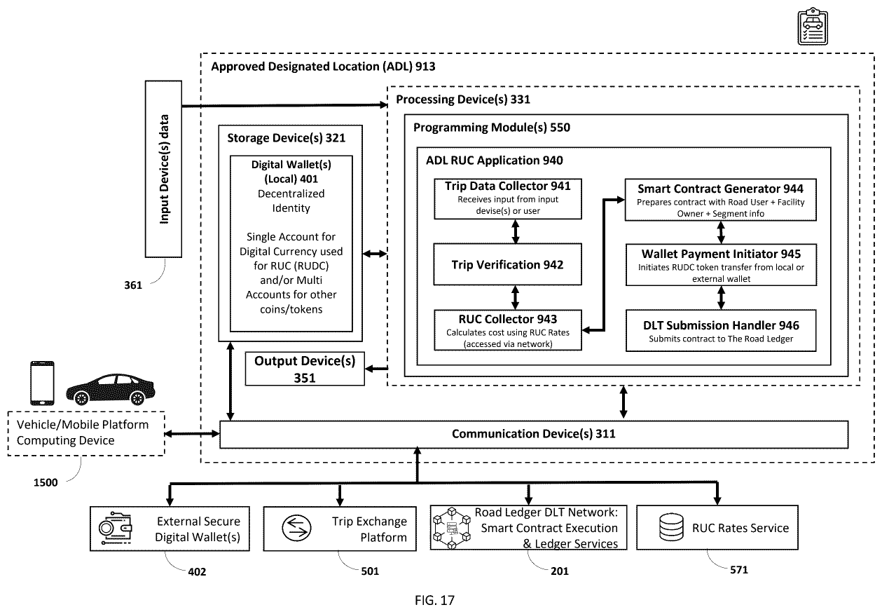

In reference to FIG. 17, a flow diagram of a method for facilitating Road Usage Charging (RUC) at an Approved Designated Location (ADL) 913, in accordance with some embodiments, is illustrated. The ADL 913 serves as a trusted processing location for Road Users who either do not have an onboard or mobile communications device or require in-person transaction handling. Road Users can use the ADL 913 to transact their RUC stored on the ADL RUC Application and report mileage directly from their RUC input device(s) 361, which may include onboard units (OBUs), odometer readings, OBD-II port devices, or approved onboard software applications, for any vehicle. These reports can be made at government-operated sites such as Departments of Motor Vehicles (DMVs), inspection centers, or authorized private organizations.

The ADL 913 may operate on a required reporting frequency—such as monthly, bi-annually, or annually—defined by jurisdictional rules, with corresponding pricing models retrieved from the RUC Rates Service 571. The RUC Rates Service 571 may provide rate tables and jurisdiction-based allocation formulas to distribute collected RUC to the appropriate Facility Owner accounts, such as federal, state, county, city, and private operators. For Road Users with the RUC Application running on a mobile or vehicle-integrated platform, the ADL 913 can ingest pre-recorded trip or segment data for a specific reporting period and process the applicable RUC transaction.

The ADL RUC Application, executed on a processing device 331 and implemented within programming module(s) 550, may include a Trip Data Collector configured to receive trip or segment-level road usage data directly from input device(s) 361 or from manual Road User submissions. The Trip Verification module is responsible for authenticating submitted mileage data using validation mechanisms such as GPS-based location checks, cryptographic signature verification, and timestamp correlation to detect anomalies or tampering. The RUC Collector then calculates the total RUC owed by accessing current rates and jurisdictional rules from the RUC Rates Service 571.

Once the amount due is determined, the Smart Contract Generator creates a digitally signed smart contract associating the Road User with the relevant Facility Owner(s) for each jurisdiction and segment traveled, embedding the total RUDC cost and relevant policy metadata. The Wallet Payment Initiator then initiates the transfer of the calculated RUDC from the Road User's digital wallet—stored locally on the storage device(s) 321 as Digital Wallet(s) 401 with decentralized identity capabilities—or from an external secure wallet 402. The DLT Submission Handler finalizes the process by submitting the signed smart contract to the Road Ledger DLT Network 201 for validation, execution, and ledger storage.

For Road Users without the RUC Application, the ADL 913 may still process mileage-based or flat-fee payments, supporting both fiat and digital currency transactions. When a Road User lacks a digital wallet 401, the ADL 913 can integrate with the Trip Exchange Platform 501 to convert fiat or other digital assets into RUDC, enabling completion of the smart contract payment process and ensuring that all transactions are recorded on the Road Ledger DLT Network 201.

The storage device(s) 321 at the ADL 913 can store RUDC balances, transaction history, smart contract records, and digital wallet identities for audit purposes. One or more output device(s) 351 can present cost breakdowns, payment confirmations, smart contract status updates, or printed/digital receipts to the Road User, supporting both immediate and deferred DLT submission scenarios. In all cases, the ADL 913 ensures that RUC payments are securely calculated, contractually bound, and verifiably logged for compliance, transparency, and auditing.

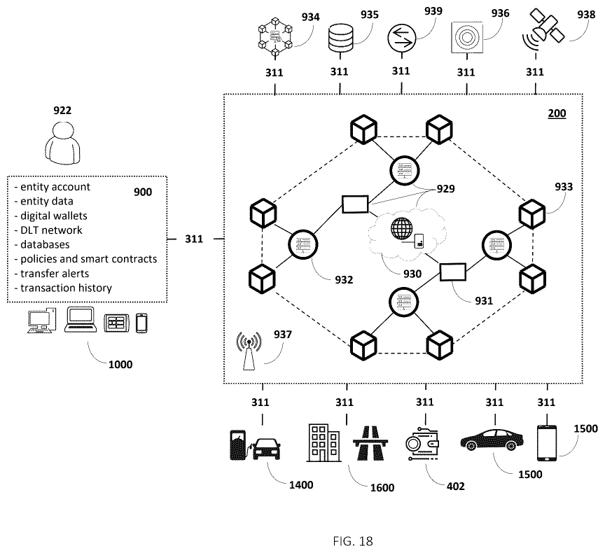

In reference to FIG. 18, an illustration of an online platform 900 is presented, consistent with various embodiments of the present disclosure. The online platform 900 is a distributed computing environment for the management and collection of Road Usage Charges (RUC) using a digital currency maintained within a Distributed Ledger Technology (DLT) network 200. The architecture supports both centralized and decentralized hosting models, including cloud computing infrastructures 930, fog computing nodes 931, and edge computing resources 932 (e.g., Multi-access Edge Computing, MEC) that are physically located near roadway infrastructure. Each compute tier is capable of executing rate resolution algorithms, validating smart contracts, processing jurisdictional rate lookups, and synchronizing distributed RUC databases.

The platform's centralized and decentralized servers are interconnected via communication device(s) 311, which implement encrypted transport protocols, redundancy failover mechanisms, and ledger synchronization services to maintain transaction consistency across the RUC ecosystem. These servers are configured to receive and transmit data to multiple classes of external devices, including mobile device(s) 1500 (smartphones, laptops, tablets), on-board vehicle computing device(s) 1500 (electronic control units, connected vehicle controllers, ADAS/ADS platforms, telematics modules, and OBDII-based RUC meters), roadway facility owner infrastructure device(s) 1600 (Intelligent Transportation Systems and Information Technology components including RUC communication hardware, ITS roadside equipment, and broadband backhaul infrastructure owned by municipal, state, federal, or private entities), fueling station platform(s) 1400 (point-of-sale integrated RUC terminals, fuel pump controllers), and secure digital wallet(s) 401, 402 (hardware wallets, software wallet applications, or HSM-backed custody systems).

The online platform 900 further interfaces with distributed compute clusters 934 (for large-scale data analysis and blockchain state replication), database server(s) 935 (for storing jurisdictional rate tables, transaction logs, and contract metadata), currency exchange platform(s) 939 (for fiat-to-digital and cross-token conversion), sensor network(s) 936 (roadside telemetry, vehicle detection systems, weigh-in-motion stations, congestion monitors), wireless communication modules 937 (cellular V2X, DSRC, Wi-Fi, 5G NR, and etc.), and satellite communication modules 938 (GNSS-based positioning, secure satellite messaging). These interfaces allow the online platform 900 to ingest real-time telemetry, perform geospatial validation, and calculate dynamic RUC charges according to published jurisdictional rules.

Within the DLT network 200, the online platform integrates with multiple node types, including policy execution nodes 929 (responsible for enforcing rate rules and applying dynamic pricing logic), validation nodes 931 (verifying cryptographic integrity and consensus acceptance of submitted contracts), and settlement nodes 933 (executing token transfers to designated Facility Owner accounts). Edge ledger nodes 932 handle latency-sensitive tasks, such as confirming RUC microtransactions from mobile or roadside devices, while also maintaining a partial ledger state for offline synchronization. Cloud orchestration services within 930 coordinate global ledger replication and broadcast finalized block data to all connected nodes.

The online platform 900 is designed with modular service layers, including but not limited to a Smart Contract Generator (which assembles jurisdiction-specific RUC contracts with cryptographic signatures), a Digital Wallet Interface (supporting multi-signature transactions and hierarchical deterministic key management), a Rate Lookup API (providing sub-second rate retrieval based on segment ID, jurisdiction, vehicle class, and time-of-day), a Transaction Logger (storing immutable event logs with hash-chained records), and Identity & Access Control subsystems (managing public key infrastructure, access rights, and policy enforcement). These modules allow Road Users, Facility Owners, Fuel Stations, and Approved Designated Locations (ADLs) to securely submit, validate, and retrieve smart contracts and related transaction data directly from the DLT network 200.

Integration with the Trip Exchange Platform 501 enables additional functions, including currency conversion from fiat or non-RUC digital assets to RUDC, automated wallet provisioning, and account onboarding with multi-factor authentication. The Trip Exchange Platform also supports escrow-based settlement workflows for disputed RUC transactions and rate arbitration services.

A user 922, which may be a Road User, Facility Owner, system administrator, or other authorized participant, can access the online platform 900 via a web-based application or browser interface (supporting both Web 2.0 and Web 3.0 standards). This interface may be deployed as a website, desktop application, mobile application, onboard vehicle application, or roadside kiosk application, each capable of operating on computing device(s) 1000. The communication device(s) 311 ensure persistent, encrypted, and fault-tolerant connectivity between all participating entities, enabling secure, auditable, and near-real-time RUC collection, validation, and settlement across all connected platforms in the ecosystem.

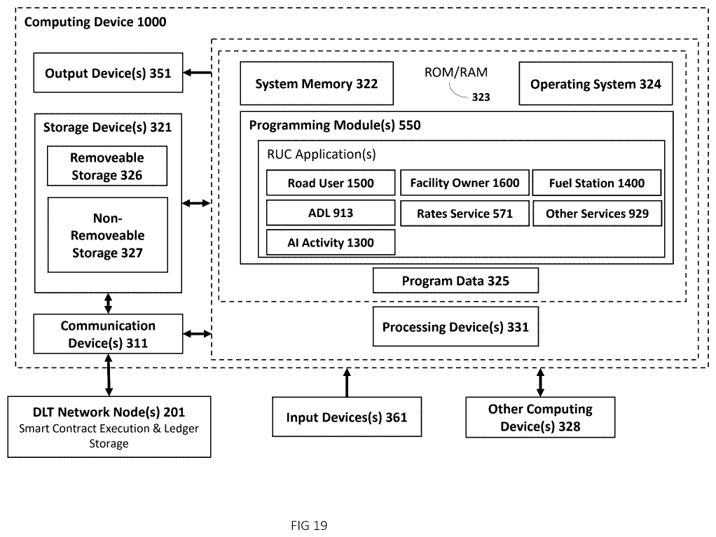

With reference to FIG. 19, a system consistent with embodiments of the present disclosure may comprise a Computing Device 1000 implemented as a physical device, a virtualized instance, or a cloud, fog, or edge-hosted service. In certain embodiments, the computing device may be embodied as a mobile phone application, a cross-platform containerized runtime, an embedded module within an in-vehicle infotainment system, an edge AI gateway, or a dedicated electronic control unit within a vehicle. In other embodiments, the device may operate as a node in a distributed computing mesh, supporting decentralized transaction processing and Road Usage Charge (RUC) ledger operations.

The core processing layer includes at least one Processing Device 331, which may be implemented as a high-performance, multi-core, AI-accelerated, and hardware-secured processor capable of executing cryptographic functions, distributed consensus algorithms, and low-latency smart contract logic. These processors may include general-purpose CPUs, GPUs, tensor processing units, neural processing units, or other specialized accelerators optimized for machine learning inference, cryptographic hashing, and secure enclave operations.

The System Memory 322, connected to the processing device, may comprise volatile and non-volatile memory technologies, including ROM/RAM 323, persistent memory, high-bandwidth memory, or hybrid memory cube architectures. The system memory hosts the Operating System 324, which may be a real-time operating system, a hardened Linux distribution, or a safety-certified automotive OS capable of deterministic execution for RUC contract validation, distributed ledger synchronization, and secure communications. The operating system may be further enhanced with secure boot chains, kernel-level attestation, and AI-assisted task scheduling to balance workloads across edge and cloud resources.

Also residing within system memory is Program Data 325, which contains configuration files, cached rate tables, cryptographic key stores, training datasets for AI models, and operational logs relevant to the RUC ecosystem. The Programming Module(s) 550 include a suite of modular RUC Applications, each implementing specific functional domains: Road User 1500 for contract generation and submission from user-operated platforms; Facility Owner 1600 for rate policy management, receipt monitoring, and fund allocation; Fuel Station 1400 for integration with pump-side devices and on-site RUC enforcement; ADL 913 for Approved Designated Location processing of offline or in-person trip submissions; RUC Rates Service 571 for jurisdiction-specific rate retrieval, validation, and publication; Services 929 for orchestration of cross-platform support functions; and AI Activity 880 for adaptive, real-time optimization of RUC-related operations.

The AI Activity 880 module may receive multi-source telemetry including GNSS or complimentary PNT geolocation, in-vehicle sensor data, roadside and aerial camera feeds, IoT infrastructure signals, and third-party mobility APIs. It may also track user interaction events such as route acceptance or rejection, manual trip adjustments, and payment confirmations. The data may be preprocessed using feature extraction, anonymization, and normalization pipelines, then stored as structured training datasets. The AI module may employ neural networks, gradient boosting machines, reinforcement learning agents, and federated learning to infer optimal RUC rates, predict congestion patterns, and dynamically adjust smart contract terms. Model updates may be deployed across edge, fog, and cloud execution nodes for low-latency decision-making, thereby reducing processing delays, increasing predictive accuracy, and improving system adaptability compared to static pricing systems.

Storage Device(s) 321 provide persistent data retention and may include Removeable Storage 326 such as SD cards or USB-based secure modules, and Non-Removeable Storage 327 such as NVMe SSDs, eMMC flash, or distributed ledger-compatible object stores. These storage devices may integrate cryptographic signing and tamper-evident logging to safeguard rate tables, smart contract templates, and compliance reports. Storage may also extend to distributed systems such as IPFS, IOTA Streams, or Hyperledger Fabric private channels, ensuring redundancy and verifiability across the RUC network.

Output Device(s) 351 may include graphical displays, heads-up displays, printers, or audio systems for presenting RUC transaction receipts, smart contract terms, and compliance alerts. Input Device(s) 361 may include keyboards, biometric scanners, GPS receivers, accelerometers, OBD-II interfaces, or other sensor-enabled hardware for capturing RUC-relevant data. Other Computing Device(s) 328 may interface with the computing device via wired or wireless links for collaborative processing, data validation, or distributed AI training.

Communication Device(s) 311 enable secure and multi-protocol connectivity between the computing device and external networks. These may include wired interfaces such as Ethernet, CAN bus, or fiber-optic links, and wireless interfaces such as Wi-Fi 6/7, mmWave 5G/6G, V2X, BLE Mesh, UWB, and satellite communications. Communication modules may implement quantum-resilient cryptography, including NIST-standardized post-quantum primitives such as CRYSTALS-Kyber and Dilithium, as well as secure over-the-air update capabilities for firmware and application deployment across the RUC network.

The computing device may also communicate with DLT Network Node(s) 201 for smart contract execution, ledger synchronization, and rate publication. These nodes may operate within a peer-to-peer topology, supporting consensus algorithms, ledger pruning, transaction indexing, and integrity verification.

In some embodiments, the system supports green compute strategies such as adaptive voltage and frequency scaling, workload migration to renewable-powered nodes, and distributed caching to minimize redundant processing. Emerging compute substrates such as photonic logic arrays, neuromorphic processors, RISC-V vector extensions, and quantum co-processors may be integrated to improve computational efficiency for RUC-related AI inference and ledger operations.

The described architecture may be deployed in various physical and virtual configurations, ranging from embedded vehicular controllers to federated edge clusters, ensuring that the RUC ecosystem remains scalable, resilient, and capable of supporting future policy and technology evolution.

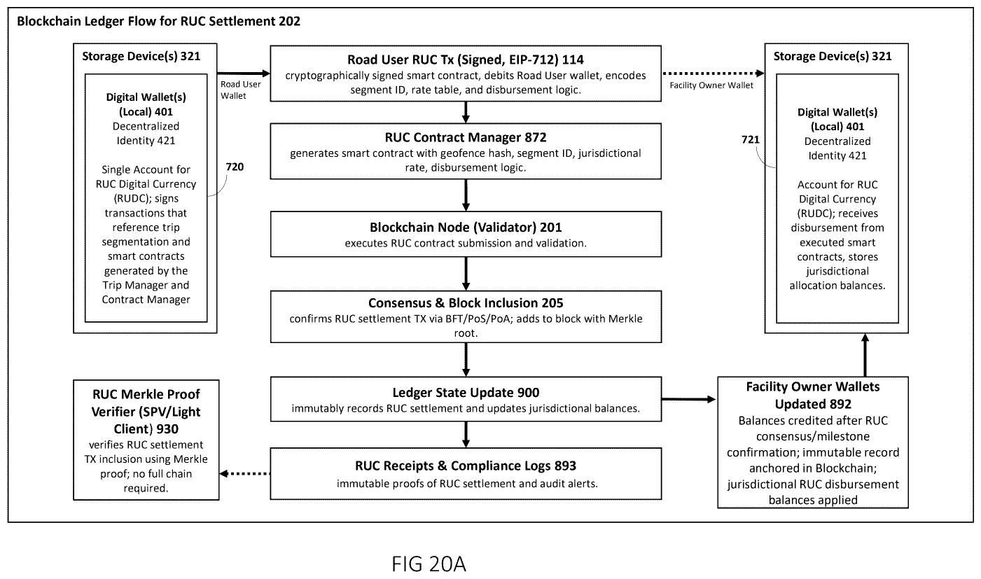

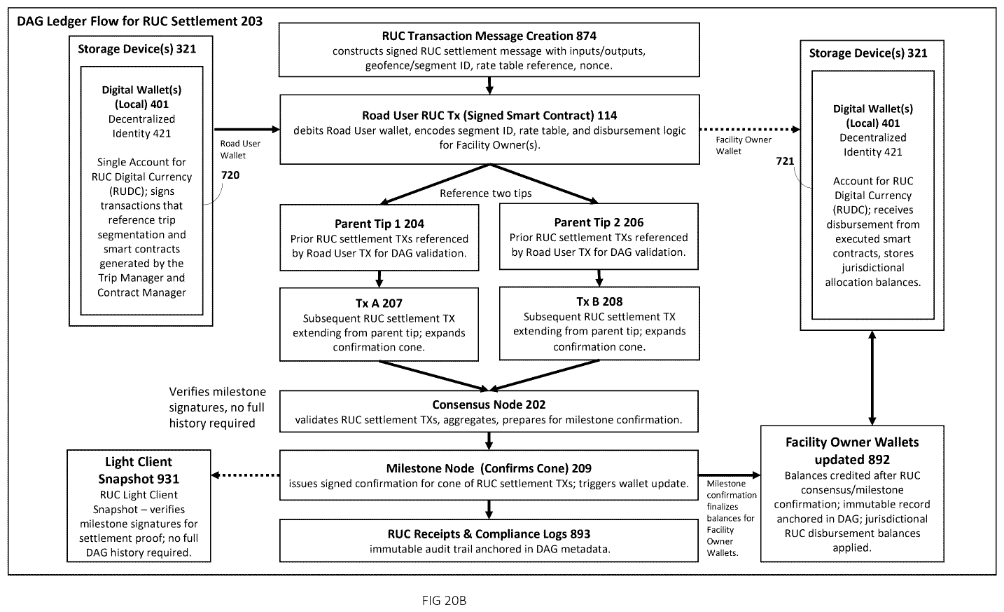

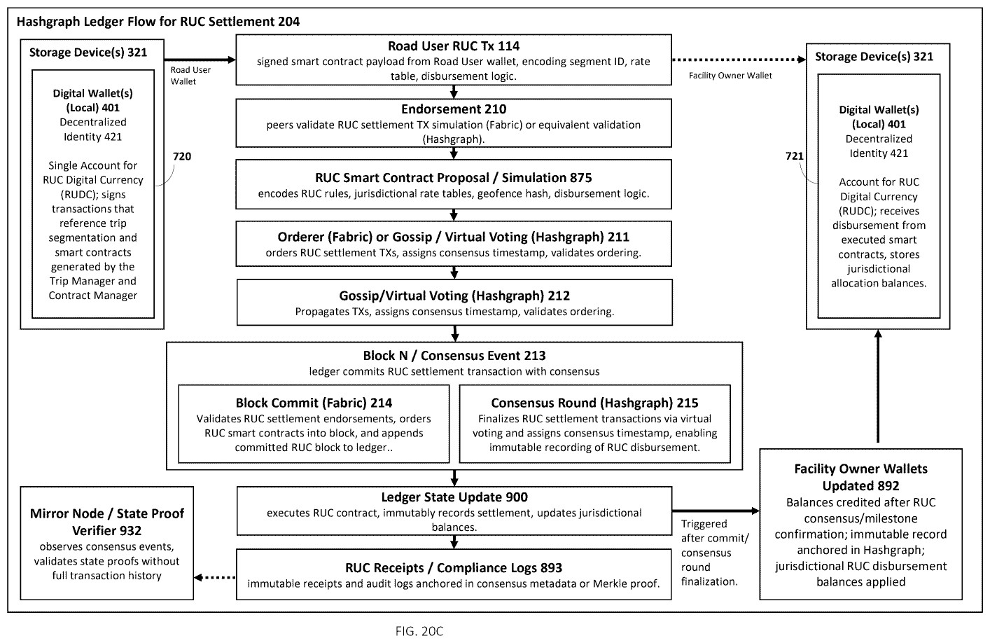

In reference to FIG. 20A, the blockchain ledger settlement flow 202 for Road User Charge (RUC) settlement begins at the Road User's storage environment and proceeds through contract generation, validator execution, network consensus, ledger mutation, independent proof verification, and disbursement to a Facility Owner wallet. The Road User's secure hardware and local key store are depicted as Storage Device(s) 321, which persist encrypted private keys, wallet state, and transaction history. Within this device, Digital Wallet(s) 401 manage signing keys and account state that are bound to a Decentralized Identity 421 so that every transaction can be associated with a cryptographically verifiable identity. The spendable account used for RUC debits is the Road User Wallet 720, which holds RUC digital currency and exposes a signing interface to authorize settlement. On the receiving side, the Facility Owner maintains a Facility Owner Wallet 721 within Storage Device(s) 321 using its own Digital Wallet(s) 401 and Decentralized Identity 421 so that receipts are cryptographically attributable.

Transaction formation is initiated as Road User RUC Tx (Signed, EIP-712) 114. In this step, the application composes a typed transaction payload that includes at least a geofence hash derived from the location segment, a segment identifier corresponding to the roadway or jurisdictional segment traveled, a jurisdictional rate table reference that yields the per-unit charge for time, distance, or fuel, and a disbursement logic structure that encodes the proportional allocation of the debit across one or more Facility Owner recipients. The payload is domain-separated and signed according to EIP-712 using the keys maintained by Digital Wallet(s) 401 under Decentralized Identity 421, producing a tamper-evident message that debits the Road User Wallet 720 when executed.

The signed payload is provided to RUC Contract Manager 872, which generates an executable smart contract instance encapsulating the RUC rules. The manager binds the geofence hash and segment identifier to the correct jurisdictional rate schedule, computes the total settlement amount, and encodes deterministic disbursement instructions (for example, split percentages or rules keyed by jurisdiction or facility). The resulting contract object includes validation guards (e.g., signature checks, nonce/anti-replay fields, and expiration) and emits well-formed events used by downstream receipt and compliance logging.

Execution is performed by Blockchain Node (Validator) 201, which accepts the contract submission, validates the EIP-712 signature and nonce against the Road User Wallet 720, validates gas/fee sufficiency where applicable, and simulates the state transition for correctness prior to inclusion. After node-level validation, the transaction proceeds to Consensus & Block Inclusion 205, where the network's consensus protocol (e.g., BFT, PoS, or PoA depending on deployment) orders the transaction, finalizes its inclusion, and commits it within a block that records a Merkle root over all included transactions. This step provides global ordering, liveness, and safety guarantees for the settlement event and fixes the transaction's canonical hash for external proofs.

Upon finalization, Ledger State Update 900 applies the smart-contracted debits and credits on-chain. The contract transfers the settled amount from the Road User Wallet 720 and posts jurisdictional allocations according to the encoded disbursement logic, updating balances for the Facility Owner Wallet 721. Concurrently, RUC Receipts & Compliance Logs 893 persist immutable settlement receipts, including the block identifier, transaction hash, payer and payee identifiers, amounts, rate table references, and contract event metadata needed for audit, reconciliation, and post-disbursement compliance checks.

Independent verification without full node synchronization is supported by RUC Merkle Proof Verifier (SPV/Light Client) 930. This client obtains the relevant block header and Merkle branch for the settlement transaction and verifies that the transaction hash is included under the published block header's Merkle root, thereby confirming inclusion and finality guarantees provided by Consensus & Block Inclusion 205 while avoiding full-chain download. This enables thin clients or regulatory tools to perform settlement validation efficiently.

As consensus finalizes and the contract's transfer events are processed, Facility Owner Wallets Updated 892 applies the incoming credits and records jurisdictional allocation balances. These updates are anchored by the same block and event metadata stored by RUC Receipts & Compliance Logs 893, ensuring the Facility Owner Wallet 721 is transparently and immutably tied to the executed smart contract and the finalized ledger state produced by Ledger State Update 900.

In reference to FIG. 20B, a Directed Acyclic Graph (DAG) settlement flow 203 is depicted for distributing Road User Charge (RUC) payments across jurisdictions using parallel transaction confirmation and milestone finality. The Road User's secure environment is provided by Storage Device(s) 321, which persist encrypted keys, wallet state, and signed transaction records. Within this environment, Digital Wallet(s) 401 maintain cryptographic key pairs bound to a Decentralized Identity 421 so that every transaction is attributable to a verifiable, non-repudiable identity. Spending authority is exposed through the Road User Wallet 720, which holds RUC digital currency (RUDC) and signs settlement messages generated by the RUC Application. The Facility Owner maintains a parallel environment consisting of Storage Device(s) 321, Digital Wallet(s) 401, Decentralized Identity 421, and a Facility Owner Wallet 721, which is credited during disbursement.

In DAG flow 203, transactions reference multiple parent tips. Tip selection uses a Uniform Random Tip Selection algorithm with maximum depth parameter D and an aging factor α to deprioritize stale tips. Finality is achieved via milestone confirmations digitally signed by a quorum of milestone nodes using a threshold signature scheme with threshold≥τ. The computing device maintains a local DAG snapshot, storing only state commitments and milestone signatures, thereby reducing memory requirements to ≤Z MB. Atomic disbursements are implemented under a UTXO model supporting alias and NFT outputs for Facility Owner wallets, ensuring multi-party settlement and preventing double-spending. DAG settlement 203 therefore provides reduced transaction latency compared to block-based consensus.

Transaction construction begins in RUC Transaction Message Creation 874, where the application composes a typed settlement message that includes inputs/outputs, a geofence or segment identifier, a rate table reference or version tag, and a nonce/sequence for anti-replay. The message format supports deterministic hashing (e.g., Keccak/SHA-256 depending on implementation) and domain separation compatible with EIP-712-style typed data, allowing an application-layer signature while preserving canonical serialization for downstream validation. Once parameterized, the Road User RUC Tx (Signed Smart Contract) 114 is produced by signing the payload with the keys held in Digital Wallet(s) 401 under Decentralized Identity 421. The signed contract encodes debit logic for the Road User Wallet 720 and proportional disbursement logic for one or more Facility Owners, with references to the applicable jurisdictional rate table and segment metadata.

To satisfy DAG validation rules, the newly created transaction references two prior tips. The first reference, Parent Tip 1 204, and the second reference, Parent Tip 2 206, point to prior RUC settlement transactions that are visible in the local tip set. By approving two tips, the new transaction increases cumulative weight on earlier messages and extends the confirmation cone, improving throughput and liveness without centralized ordering. Immediately after issuance, additional child transactions—Tx A 207 and Tx B 208—may extend from the same parents (or from the new transaction), further expanding the cone and enabling parallel settlement of subsequent trip segments or independent users' payments that happened to select the same tip set. Each message includes a deterministic hash, digital signature (e.g., Ed25519/ECDSA), and references to its parents, ensuring acyclicity and efficient topological ordering for validation.

Network-side validation occurs at the Consensus Node 202, which verifies the signature, input/output consistency (e.g., UTXO-like balance checks or account/balance model constraints), rate table provenance, and segment-vs-geofence coherence. The node aggregates approved transactions into a confirmation cone and prepares them for milestone finality. In DAG systems that employ milestone-based confirmation, a dedicated Milestone Node (Confirms Conc) 209 issues a signed milestone that cryptographically attests to the validity of a set of transactions reachable within the cone. The milestone includes a timestamp, cone root(s), and the public key material required to verify the attestation, and its publication triggers state application for all transactions referenced directly or indirectly by the milestone.

Once the milestone is accepted by the network, the settlement is recorded and auditable. RUC Receipts & Compliance Logs 893 persist immutable receipts that include the transaction hash, milestone identifier, payer and payee wallet identifiers, segment/route metadata, rate table version, and the amount disbursed per jurisdiction. These receipts support regulatory audit, dispute resolution, and post-event reconciliation without revealing extraneous personal data. In parallel, a Light Client Snapshot 931 enables independent proof of settlement without downloading full DAG history. By verifying only the milestone signature and the inclusion of the transaction hash within the milestone's confirmation cone (e.g., via snapshot index or succinct cone membership proof), thin clients operated by users, facility owners, or regulators can confirm finality with minimal bandwidth and storage.

On the receiving side, the Facility Owner Wallets Updated 892 applies the credited balances to the Facility Owner Wallet 721 according to the executed smart-contract disbursement logic embedded in the Road User RUC Tx 114 and recognized by Consensus Node 202. The annotation in the figure indicates that milestone confirmation finalizes the balances for Facility Owner wallets, guaranteeing that the on-ledger allocations are consistent with the cone attested by the milestone and are therefore immutable under the network's finality rules.

In some embodiments, the DAG settlement flow 203 applies a Uniform Random Tip Selection algorithm bounded by a maximum depth parameter D and an aging factor α that deprioritizes stale tips. Finality is reached via milestone confirmations digitally signed by a quorum of milestone nodes using a threshold signature scheme with threshold≥τ. The computing device may maintain a local DAG snapshot storing only milestone signatures and state commitments, thereby reducing memory usage to ≤Z MB. Atomic disbursements may be performed under a UTXO model supporting alias and NFT outputs, ensuring multi-party settlement integrity and preventing double-spend conditions.

In reference to FIG. 20C, a hashgraph ledger settlement flow 204 for Road User Charge (RUC) settlement is illustrated, beginning at the Road User's secured wallet environment and proceeding through endorsement, contract simulation, gossip-based propagation, consensus ordering, ledger mutation, compliance logging, independent proof verification, and disbursement to a Facility Owner wallet. The Road User's environment is represented by Storage Device(s) 321, which persist encrypted private keys, wallet state, and signed transactions. Within this device, Digital Wallet(s) 401 maintain cryptographic keys bound to a Decentralized Identity 421, providing the identity framework that makes each transaction verifiable and attributable. The spendable account that authorizes debits is the Road User Wallet 720, which holds RUC digital currency. On the receiving side, the Facility Owner maintains a parallel environment consisting of Storage Device(s) 321, Digital Wallet(s) 401, Decentralized Identity 421, and a Facility Owner Wallet 721, which is credited during disbursement.

In hashgraph flow 204, transactions propagate via gossip-about-gossip with authenticated encryption and per-peer rate limiting. Virtual voting establishes ordering and finality. Gossip metadata is compacted to ≤S bytes per round, reducing communication overhead. Contracts are anchored through Hedera Consensus Service (HCS) topics. Each confirmation includes a state proof cryptographically binding settlement records to a consensus round number. Regulators can verify settlement integrity using pinned public roots while proof size remains ≤S bytes, ensuring lightweight audits. Hashgraph flow 204 thereby reduces communication and verification overhead compared to block-based consensus while preserving determinism and auditability.

Transaction formation begins with Road User RUC Tx 114, a cryptographically signed smart contract payload. The RUC Application encodes within this payload a segment identifier, a rate table version, a geofence or jurisdictional reference, and deterministic disbursement logic for one or more Facility Owners. The payload is signed with keys maintained in Digital Wallet(s) 401 under Decentralized Identity 421, producing a tamper-evident and non-repudiable contract that debits the Road User Wallet 720 when executed.

The signed payload proceeds to Endorsement 210, where validator peers simulate and verify the settlement. This includes checking contract parameters, verifying the Road User's balance, ensuring nonce and replay protections, and confirming conformance with RUC policies. Once endorsed, the transaction enters RUC Smart Contract Proposal/Simulation 875, where the encoded rules—including segment identifiers, geofence hashes, rate tables, and disbursement percentages—are simulated to guarantee that all peers can deterministically reproduce the same state update.

Consensus ordering in the hashgraph architecture is accomplished by Orderer (Fabric) or Gossip/Virtual Voting (Hashgraph) 211 and Gossip/Virtual Voting (Hashgraph) 212. In the hashgraph mode emphasized here, transactions are propagated by gossip-about-gossip, where each event carries references to prior events. Virtual voting allows nodes to independently determine ordering and consensus timestamps without requiring direct voting messages. This ensures fairness and efficiency while eliminating the need for block mining.

When a sufficient number of nodes have observed the transaction, Block N/Consensus Event 213 is reached, representing the point of consensus inclusion. In Fabric-based systems, Block Commit (Fabric) 214 orders and appends endorsed transactions into blocks. In the hashgraph pathway, Consensus Round (Hashgraph) 215 finalizes the transaction by assigning a consensus timestamp, producing an auditable state proof that binds the event to the authenticated ledger state. This state proof enables immutable settlement records across the network.

Once consensus is achieved, Ledger State Update 900 applies the contract logic, debiting the Road User Wallet 720 and crediting the Facility Owner Wallet 721 according to the disbursement instructions. At the same time, RUC Receipts & Compliance Logs 893 persist immutable settlement records that include consensus timestamps, transaction identifiers, payer and payee accounts, and rate or segment metadata. These receipts provide the basis for compliance audits, reconciliation, and dispute resolution.

For transparency and lightweight verification, Mirror Node/State Proof Verifier 932 observes consensus events and validates the state proof emitted by the hashgraph. This allows regulators, auditors, or external systems to confirm settlement inclusion and ordering without needing to replay the full gossip history. The Facility Owner Wallets Updated 892 reflects the credited balances, ensuring that Facility Owner accounts are anchored to the same consensus artifacts and compliance logs as the Road User's debits.

In some embodiments, gossip propagation batches multiple signed transaction events into compact gossip messages, reducing communication overhead to ≤S bytes per round. Virtual voting establishes transaction ordering without requiring global block synchronization, thereby reducing consensus latency. Smart contracts may be anchored using a Hedera Consensus Service (HCS) topic, with state proofs that cryptographically bind settlement records to consensus round numbers. This improves auditability and reduces processing time compared to block-based consensus systems.

### Additional Embodiments: Multi-Ledger Orchestration

In certain embodiments, the disclosed system may further comprise an orchestration hub configured to manage road user charge (RUC) settlements across heterogeneous distributed ledger technologies (DLTs). These embodiments extend the system architecture described above by introducing a ledger-neutral transaction object (To) that enables consistent encoding of road usage events prior to submission to any specific ledger. The orchestration hub may classify transactions, enforce bounded operational constraints, select and translate into target ledger formats, verify heterogeneous proofs of settlement, and record results in a unified cross-ledger audit log. The following sections describe representative mechanisms for realizing such multi-ledger orchestration.

Ledger-Neutral Transaction Object (Tₒ): In certain embodiments, road usage records may be encoded into a ledger-neutral transaction object (Tₒ) prior to submission to any distributed ledger technology (DLT). The object Tₒ may include a route commitment R* (e.g., a Merkle root, Verkle root, or vector commitment), facility identifiers, jurisdiction identifiers, a segment-based mileage and disbursement vector, a timestamp, a nonce, and a policy tuple {M, T, S, G} corresponding to maximum memory utilization, bounded latency, proof size constraint, and transaction cost/gas limits. The ledger-neutral representation enables consistent treatment of usage data and settlement attribution across heterogeneous ledger backends.

Multi-DLT Orchestration Hub: An orchestration hub may be configured to: (i) receive ledger-neutral transaction objects, (ii) classify transactions based on attributes such as jurisdiction, urgency, or value, (iii) partition a single RUC settlement into disbursement vectors routed in parallel to heterogeneous ledgers (e.g., blockchain for audit-grade settlement, DAG for latency-sensitive microtransactions, permissioned ledgers for jurisdictional attestations, and hashgraphs for state proofs), (iv) translate Tₒ into ledger-specific transaction formats, (v) transmit transactions to validator nodes of the selected ledgers, and (vi) receive heterogeneous proofs of settlement from the ledgers.

The orchestration hub may normalize returned proofs into a compact ProofDigest, append digests into a Unified Transaction Log, and enforce policy tuple {M, T, S, G} by rejecting transactions requiring memory greater than M, aborting validation if latency exceeds T, discarding proofs larger than S, and rerouting or anchoring settlement if transaction cost exceeds G or primary settlement paths fail.

Unified Transaction Log & Proof Verification: The unified transaction log may serve as a tamper-evident cross-ledger audit layer. Each log entry may include a digest of the ledger-neutral object, identifiers of selected ledgers, jurisdictional disbursement vectors, and compact proofs of finality. The log may be hash-chained and periodically anchored to one or more destination ledgers, such as a public blockchain, to provide external verifiability of RUC settlements. The normalized ProofDigest may be designed for verification on constrained devices (e.g., in-vehicle OBUs or mobile applications) without requiring access to full ledger state, enabling light-client deployment of the RUC system.

Governance, Identity, and Token Portability: Governance and compliance functions may be supported through decentralized frameworks such as Decentralized Autonomous Organizations (DAOs), verifiable credentials (VCs), and decentralized identifiers (DIDs). These may define machine-readable policy rules that govern transaction acceptance, jurisdictional fee distribution, and audit procedures. The orchestration hub may further support token portability mechanisms, including wrapping, escrow-mint, and cross-ledger swaps, to ensure consistent value representation and liquidity across heterogeneous ledgers during settlement.

Identity and Privacy Protections: Identity and privacy protections may be strengthened through mechanisms including trusted execution environments (TEEs), homomorphic encryption, differential privacy for aggregated trip records, and zero-knowledge proof constructions, thereby enabling settlement verification without exposing underlying trip data.

Representative Extensions: The orchestration hub and transaction object model may further be extended with emerging communication protocols (e.g., delay-tolerant networking, satellite relays), cryptographic standards (post-quantum algorithms, accumulators, attribute-based encryption), and interoperability frameworks (e.g., Interledger Protocol, Cosmos IBC, Chainlink CCIP, LayerZero, Axelar, Wormhole). These extensions ensure the disclosed system remains applicable across heterogeneous, evolving ledger environments.

These embodiments are representative and not limiting, and may be combined in whole or in part with other system elements as described herein. The foregoing description of multi-ledger orchestration illustrates how the disclosed system may be extended to support heterogeneous ledger environments, policy-bounded settlement, governance-aware compliance, and cross-ledger portability.

Thus, an overall overview of the present invention may be described as follows:

The process for creating digital currency to facilitate and collect Road User Charges (RUC) over a distributed ledger network 200 begins with an Entity creating an account in the Trip Exchange Platform 501. A Road User connects at least one digital wallet 720, including the digital wallet associated with at least one vehicle, to the account in the Trip Exchange Platform 501. A Facility Owner connects at least one digital wallet 721, including the digital wallet associated with at least one roadway segment, to the account in the Trip Exchange Platform 501. In some embodiments, all entities must verify identity using distributed identity (DID) technology and a secure, unique digital identifier to access their accounts in the Trip Exchange Platform 501.

The Road User connects to the Trip Exchange Platform 501 to purchase digital currency (e.g., stablecoin, utility token) using fiat currency or other digital currency, which may or may not include a service fee. The Trip Exchange Platform 501 processes the exchange of fiat or other digital currency to the Road User's digital wallet 720 for RUC-specific digital currency, which may or may not include a service fee, and stores the resulting transaction on the DLT network 200. The RUC digital currency is retained in the Road User's wallet 720 for use in paying RUC to Facility Owners. The Road User transfers digital currency to Facility Owner digital wallets 721 using policies and smart contracts recorded on the DLT network 200, which may or may not include a service fec. Facility Owners store received RUC digital currency in their wallet 721 for collection purposes, and may convert it into fiat currency or other digital currency through the Trip Exchange Platform 501.

The process for adding digital currency to a vehicle wallet at a Fuel Station Platform 1400 comprises the following steps. The Road User connects the vehicle's digital wallet 720 to the account created in the Trip Exchange Platform 501. The Road User then adds motor fuel at the Fuel Station Platform 1400 to at least one vehicle. The Road User may either:
(1) pay motor fuel tax as part of the fuel sale (the existing method), in which case petroleum-based fuel includes a tax based on cost per gallon or liter collected at the Fuel Station Platform 1400 and the RUC structure is not engaged; or
(2) purchase RUC digital currency in lieu of paying motor fuel tax, with the currency to be distributed to Facility Owners for roadways that the vehicle will use during a trip.

In the RUC currency method, the Road User may purchase the digital currency from the Fuel Station Platform 1400 or directly from the Trip Exchange Platform 501 through the RUC Application 870 using the Coin Manager 871 and Contract Manager 872 via the DLT network 200. The Fuel Station operator issues a policy and smart contract for the sale of RUC digital currency, posted to the DLT network 200. The Road User's Contract Manager 872 verifies the policy and smart contract conditions. Upon completion of fueling, the Coin Manager 871 calculates the estimated digital currency required using data from the RUC Database 876, which may include RUC Input Device(s) 361, historical trip data from the Trip Manager 878 and Trip Calculator 877, and predictions from the AI Activity Module 1300. The Contract Manager 872 uses this data to populate and execute the smart contract on the DLT network 200. The Fuel Station Platform 1400 then transfers the RUC digital currency from its Digital Wallet(s) 401 to the Road User's wallet 720 for later use in paying RUC.

In scenarios where RUC digital currency is not purchased from a Fuel Station (e.g., home charging), upon completing the energy or fuel addition, the Coin Manager 871 similarly calculates the estimated RUC digital currency required based on the RUC Database 876, Trip Manager 878, Trip Calculator 877, and AI Activity Module 1300 outputs. The Contract Manager 872 connects to the Trip Exchange Platform 501 to purchase the required currency using fiat or other digital currency, which may or may not include a service fec. The Trip Exchange Platform 501 processes the exchange, credits the Road User's wallet 720, and stores the transaction on the DLT network 200.

The process for transferring digital currency from Road Users to Facility Owners for RUC collection over the DLT network 200 begins when the Road User starts the vehicle and the Trip Manager 878 determines the current location and Facility Owner using Communication Device(s) 311 and RUC Input Device(s) 361. The Trip Manager 878 starts a new trip segment and determines whether the trip is planned or unplanned. The Coin Manager 871 retrieves applicable RUC rate data and account addresses for each Facility Owner from the RUC Rates Service 571 and/or RUC Database 876. The Contract Manager 872 retrieves the relevant policies and smart contracts for each segment from the DLT network 200 and provides required conditions to the Trip Manager 878 and Trip Calculator 877. The Trip Manager 878 records position, distance, geographic, and other sensor data for each trip segment and sends it to the Trip Calculator 877. The Trip Calculator 877 uses data from the Trip Manager 878 and Coin Manager 871 to calculate RUC cost in digital currency for each segment.

The Contract Manager 872 compiles input data to meet the conditions of the applicable policies and smart contracts. Upon completing a segment or trip, the Contract Manager 872 processes data from the Coin Manager 871, Trip Manager 878, and Trip Calculator 877 to include required conditions (e.g., travel distance, RUC currency amount) and automatically execute the smart contract on the DLT network 200. This triggers transfer of digital currency from the Road User's wallet 720 to the Facility Owner's wallet 721 in accordance with the stored policy and contract terms.

In some embodiments, the AI Activity Module 1300 augments the Trip Manager 878 to execute the AI-Enhanced Real-Time Traffic and Dynamic RUC Optimization Process 1302, which includes Traffic Condition Detection 1303, Comparative Analysis and Incident Detection 1304, Adaptive Learning 1305, Dynamic Route and Pricing Optimization 1306, User Interaction and Route Adjustment 1307, and Post-Trip Cost Recalculation 1308. The AI Activity Module 1300 consumes multi-source telemetry from vehicle sensors, GNSS, roadside units, IT infrastructure, and third-party APIs, and interfaces with the Coin Manager 871, Trip Calculator 877, and Contract Manager 872 for real-time, jurisdiction-aware settlement processing. User feedback and trip results are fed into Adaptive Learning 1305 to continuously improve predictive accuracy and system responsiveness over time.

In some embodiments, the DLT network 200 incorporates a Consensus Layer comprising multiple interchangeable settlement pathways, including Blockchain 202, Directed Acyclic Graph (DAG) 203, and Hashgraph 204. These consensus mechanisms operate in conjunction with nodes 201 to validate, record, and finalize smart contracts generated by the Contract Manager 872, executed with input from the Coin Manager 871, Trip Manager 878, Trip Calculator 877, and RUC Rates Service 571/RUC Database 876. Each pathway provides a distinct technical architecture for processing RUC digital currency transactions, while ensuring that disbursements from the Road User wallet 720 to the Facility Owner wallet 721 occur securely, transparently, and in compliance with the applicable policies and smart contracts stored on the DLT network 200.

The Blockchain 202 pathway employs linear block creation and sequential hashing across nodes 201; smart contracts encode jurisdiction-specific policies, and debits/credits are committed atomically to wallets 720/721 with immutable ordering suitable for audit.

The DAG 203 pathway enables high-throughput, parallel validation by referencing multiple prior tips; segment-level transactions from the Trip Manager 878 and Trip Calculator 877 are validated concurrently with milestone finality, reducing latency during frequent jurisdictional handoffs.

The Hashgraph 204 pathway leverages gossip-about-gossip and virtual voting to provide deterministic ordering and fairness; consensus timestamps drive near-real-time finality and equitable distribution among Facility Owner wallets 721, with light-client state proofs for transparent verification.

By supporting Blockchain 202, DAG 203, and Hashgraph 204 within the DLT network 200, the disclosed system adapts settlement to jurisdictional rules, scalability demands, and performance constraints while maintaining consistent validation, disbursement, and auditability across Road User wallets 720 and Facility Owner wallets 721.

Embodiments of the present disclosure, for example, are described above with reference to block diagrams and operational illustrations of methods, systems, and computer program products according to embodiments of the disclosure. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

While certain embodiments of the disclosure have been described, other embodiments may exist. Furthermore, although embodiments of the present disclosure have been described as being associated with data stored in memory and other storage mediums, data can also be stored on or read from other types of computer-readable media, such as secondary storage devices (e.g., hard disks, solid-state storage devices, USB drives), optical media (e.g., CD-ROM, DVD), carrier waves from the Internet, or other forms of volatile and non-volatile memory.

In various embodiments, a Computing Device 1000 may be implemented as a physical device, a virtualized instance, or a cloud 930, fog 931, or edge-hosted service 932. The computing device may include at least one Processing Device 331, System Memory 322 (with ROM/RAM 323 and Operating System 324), Program Data 325, and modular Programming Modules 550 (including Road User 1500, Facility Owner 1600, Fuel Station 1400, ADL 913, RUC Rates Service 571, Services 929, and AI Activity 880).

Additional components may include Storage Devices 321 (with Removable Storage 326 and Non-Removable Storage 327), Output Devices 351, Input Devices 361, Other Computing Devices 328, and Communication Devices 311 supporting secure multi-protocol connectivity with DLT Node(s) 201. These nodes may participate in consensus, ledger synchronization, and smart contract execution across multiple distributed ledger types.

In some embodiments, the computing device may employ cryptographic hardware accelerators, post-quantum secure communication modules, AI-optimized processors, and distributed storage frameworks to ensure scalability, resilience, and secure execution of RUC-related operations. Furthermore, the disclosed methods' stages may be modified in any manner, including by reordering stages and inserting or deleting stages, without departing from the disclosure.

What is claimed is:

1. A computer-implemented method executed on a network-connected computing device comprising a processing unit, a communication interface, and a distributed ledger storage subsystem for facilitating collection of Road User Charges (RUC) by securely managing jurisdiction-specific digital currency transactions with bounded memory, latency, and cryptographic verification on a Distributed Ledger Technology (DLT) network selected from a blockchain, a directed acyclic graph (DAG), or a hashgraph, the method comprising:
A. receiving, by the computing device via the communication interface, Road User digital data from at least one Road User device associated with a cryptographically secure unique identifier, and Facility Owner digital data from at least one Facility Owner device associated with a cryptographically secure unique identifier, wherein the communication interface supports at least one wired or wireless protocol and secure transmission method;
B. creating, by the computing device, a Road User account and a Facility Owner account, each with a secure digital wallet stored in the distributed ledger storage subsystem, wherein the wallet is protected using cryptographic key management comprising multi-signature authentication, threshold cryptography, or secure enclave storage;
C. retrieving, by the computing device from at least one of a Trip Exchange platform or a fueling or charging station platform wallet, digital currency for the Road User wallet, including cryptographic verification through a DLT consensus mechanism comprising a Byzantine Fault Tolerant (BFT) protocol, and verifying inclusion of the digital currency transfer by a Merkle tree proof, Verkle proof, or vector commitment proof, wherein proof size is bounded to ≤S bytes to enable verification on constrained in-vehicle computing devices;
D. segmenting, by a Trip Manager executed on the computing device, a trip into jurisdictional segments using geospatial algorithms comprising Hidden Markov Model map-matching with Viterbi decoding over an R-tree-indexed road graph, Extended Kalman Filter sensor fusion combining GNSS signals, complementary Position, Navigation, and Timing (PNT) inputs, odometer data, and inertial measurement unit (IMU) updates executed at an IMU sampling rate of at least 100 Hz with GNSS corrections at least 1 Hz, and geofencing by point-in-polygon checks on tiled jurisdiction polygons with polygon clipping at boundary intersections, wherein the Trip Manager maintains a fixed-capacity circular buffer for segment metadata and prunes candidate map-matching states to a beam width B, thereby bounding working memory to ≤Q kilobytes and per-fix processing latency to ≤T milliseconds;
E. retrieving, by the computing device, segment-specific RUC rate data from a DLT-registered RUC Rates Service, wherein the rate data is cryptographically hashed and version-controlled in the ledger;
F. calculating, by a Coin Manager executed on the computing device and incorporating an artificial intelligence (AI) or machine learning (ML) module trained on transportation, traffic, and payment data, a digital currency amount for each segment based on at least one of distance traveled, vehicle class, environmental or traffic conditions, and dynamic pricing rules, wherein the AI or ML module executes under resource constraints of ≤Q kilobytes memory and ≤T milliseconds inference latency, thereby improving computational efficiency and accuracy on in-vehicle hardware;
G. generating, by a Contract Manager executed on the computing device, a smart contract for each segment encoded as a deterministic fixed-size data structure with bounded memory≤Q kilobytes and O(1) replay-check capability, comprising explicit fields including segment ID, geofence hash, route commitment encoded as a polyline hash or Merkle root, rate table version, calculated amount, timestamp, and nonce, wherein per-segment nonces are stored in a fixed-capacity circular buffer keyed by segment ID to enable O(1) replay checks, and wherein settlement accepts a single compact Merkle proof of the committed route instead of per-vertex data to reduce verification gas cost to ≤ G units, the contract digitally signed using an EIP-712 domain and configured with replay protection, access control, and reentrancy protection;
H. transmitting, by the computing device, each smart contract to a DLT node for execution over a secure channel, wherein each transaction is cryptographically signed and immutably recorded; and
I. adjusting wallet balances, by the computing device, for the Road User and each Facility Owner based on executed smart contract terms, and storing associated alerts and receipts on the DLT network as immutable records.

2. The method of claim 1, wherein the DLT network comprises a blockchain, and settlement verification is performed by validating inclusion of each transaction in a Merkle tree, Verkle tree, or vector commitment, thereby reducing gas verification cost to ≤G units compared to per-vertex storage.

3. The method of claim 1, wherein the DLT network comprises a DAG, and settlement finality is provided by milestone confirmations signed by a quorum of validator nodes, the computing device maintaining a bounded local snapshot storing only state commitments and milestone signatures to limit memory to ≤Z megabytes, thereby reducing transaction latency compared to block-based consensus.

4. The method of claim 1, wherein the DLT network comprises a hashgraph, and settlement is achieved using gossip-based transaction propagation and virtual voting to establish ordering and finality, with virtual-voting metadata compacted to ≤S bytes per round to reduce communication overhead and improve throughput.

5. The method of claim 1, wherein the computing device caches generated smart contracts locally in an encrypted format when DLT connectivity is unavailable, and authenticates and submits the cached contracts upon restoration of connectivity, wherein encryption is implemented using at least one symmetric or asymmetric cryptographic algorithm, and integrity is validated by cryptographic checksums with secure-boot verification prior to resubmission.

6. The method of claim 1, wherein the Trip Manager integrates with a navigation or route-planning system to dynamically re-segment a trip and recalculate RUC obligations when the Road User deviates from a planned route, executing recalculation with beam-search pruning of candidate map-matching states to a fixed beam width B to bound per-fix latency to ≤T milliseconds.

7. The method of claim 1, wherein the Trip Manager maintains a ring buffer of fixed capacity Q and prunes map-matching states to beam width B, thereby bounding memory and latency to ≤T milliseconds on in-vehicle hardware.

8. The method of claim 1, wherein the RUC Rates Service stores version-controlled rate tables published by Facility Owners, anchors each version with a cryptographic hash, and records an append-only, Facility-Owner-signed ledger entry including an effective-from timestamp to prevent rollbacks.

9. The method of claim 1, further comprising applying congestion pricing by retrieving live traffic or roadway condition data from external and onboard sources, processing the data through a machine-learning model implemented on an edge, fog, or cloud platform, the model comprising a recurrent neural network trained on historical and real-time roadway data to detect congestion events within ≤Δ seconds with false-positive rate≤ε.

10. The method of claim 1, wherein congestion prediction is executed by a Long Short-Term Memory (LSTM) neural network trained on historical and real-time traffic data, with inference latency≤T milliseconds and accuracy≥α %.

11. The method of claim 1, wherein roadway imaging inputs are processed by a convolutional neural network (CNN) trained on traffic-camera feeds.

12. The method of claim 1, wherein dynamic rate adjustment is optimized by a reinforcement learning agent with a jurisdiction-specific reward function.

13. The method of claim 1, wherein the Coin Manager predicts future RUC digital currency requirements by applying an AI module that analyzes historical trip data, fueling or charging behavior, or time-of-day usage patterns, and transmits a refill alert including a cryptographically signed forecast token-allocation record and expiry timestamp.

14. The method of claim 1, wherein each transaction incorporates a zero-knowledge proof to validate user identity and payment without revealing personally identifiable information, the proof comprising a zero-knowledge range proof on segment distance and amount verified by the DLT node prior to execution, wherein the proof is implemented with bounded disclosure size≤S bytes to reduce communication and processing overhead on in-vehicle hardware.

15. The method of claim 1, wherein the zero-knowledge proof comprises a zk-SNARK proof validated by the DLT node, executed with hardware acceleration to achieve inference latency≤T milliseconds.

16. The method of claim 1, wherein the zero-knowledge proof comprises a Bulletproofs range proof applied to segment distance and payment amount, wherein verification requires≤R computational steps, thereby constraining resource usage for validator nodes.

17. The method of claim 1, wherein the zero-knowledge proof comprises a zero-knowledge range proof that validates trip distance while reducing disclosure bandwidth to ≤S bytes per proof, with verifier confidence≥γ ensuring regulator-compliant attestation without revealing route-level details.

18. The method of claim 1, wherein smart-contract generation and validation are distributed across edge computing devices, fog computing nodes, and cloud computing infrastructure, with execution results cross-checked using Byzantine-fault-tolerant consensus and quorum-certified before ledger submission.

19. The method of claim 1, further comprising receiving manual trip submissions via an Approved Designated Location (ADL) interface, validating the submission, calculating the associated RUC cost, and generating a corresponding smart contract for DLT execution, wherein the submission is digitally signed using an ADL device certificate chained to a public key infrastructure trusted root.

20. The method of claim 1, wherein the Road User interface displays segment-level costs, digital currency balances, refill requirements, and transaction records retrieved from the DLT network, rendered by a tamper-resistant user interface component that validates integrity with cryptographic state-proofs prior to display and prevents rendering of unverified or manipulated data.

21. The method of claim 1, wherein the Facility Owner interface displays jurisdictional earnings, segment-level traffic data, and smart-contract execution logs retrieved from the DLT network, and exposes regulator-accessible zero-knowledge proof attestations validated against cryptographic state-proofs through an authenticated API, enabling compliance verification without disclosure of personally identifiable trip data.

22. The method of claim 1, wherein the Trip Manager interacts with a Rate Policy Manager to apply jurisdiction-specific rules including tax exemptions, vehicle class adjustments, and fuel-type considerations, triggered upon boundary crossing, and commits each applied rule as a digitally signed state transition anchored to the ledger.

23. The method of claim 1, wherein the RUC system supports payment initiation via fueling or charging station platforms, mobile applications, or ADL systems, with all transfers cryptographically signed and recorded on the DLT network, and validated with replay-protected transaction formats including per-transfer nonces.

24. The method of claim 1, further comprising integrating a Fuel Manager module to record fuel or energy volume, type, and estimated tax, and to calculate RUC token equivalents when no motor fuel tax is applied, wherein energy sources include petroleum fuels, biofuels, hydrogen, electricity, propane, natural gas, synthetic fuels, or future-compatible energy carriers, and wherein fueling events are logged as signed tuples (volume, type, tax) emitted by fueling-station controllers.

25. The method of claim 1, wherein the Trip Exchange platform converts fiat currency into RUC digital currency and vice versa, using cryptographic authentication to verify identities, and supports cross-chain settlement validated by proofs of inclusion or light-client state proofs.

26. The method of claim 1, wherein the computing device transmits a cryptographically signed transfer alert to both the Road User and Facility Owner upon execution of a smart contract, the alert including a transaction hash and a regulator-verifiable state proof.

27. The method of claim 1, wherein the DLT network comprises a permissioned blockchain, permissionless blockchain, or hybrid blockchain, each configured with pluggable consensus modules and proof mechanisms selected to meet latency≤T and throughput≥R transactions per second.

28. The method of claim 1, wherein the computing device employs time-series forecasting to estimate jurisdictional token distribution over a trip, pre-loading smart contracts with proportional payment rules before travel begins, and committing the forecast using predictive cryptographic commitments disclosed when settlement occurs.

29. The method of claim 1, wherein the Contract Manager includes a privacy-preserving audit field enabling regulators to verify compliance without accessing trip-level personal data, the audit field encoded using homomorphic encryption or zero-knowledge range proofs with verifier-specified confidence level≥γ.

30. The method of claim 1, wherein the Contract Manager encodes route commitments as fixed-size hashes and maintains per-segment nonces in a fixed-capacity buffer, enabling O(1) replay checks.

31. The method of claim 1, wherein settlement accepts a single compact Merkle proof for a route instead of per-vertex commitments, reducing verification gas to ≤G units.

32. A system for facilitating collection of Road User Charges (RUC) by securely executing jurisdiction-specific digital currency transactions with bounded memory, latency, and cryptographic verification over a Distributed Ledger Technology (DLT) network selected from a blockchain, a directed acyclic graph (DAG), or a hashgraph, improving computational efficiency and cryptographic verification throughput, the system comprising:
a network-connected computing device comprising a processing unit, a communication interface, a distributed ledger storage subsystem, and a secure execution environment;
a communication interface configured to:
(a) receive Road User digital data and Facility Owner digital data, each associated with cryptographically secure unique identifiers;
(b) support at least one wired or wireless communication protocol including cellular, Wi-Fi, telematics communication channels (including but not limited to LTE/5G/6G modem links), Cellular Vehicle-to-Everything (C-V2X), or 5G-V2X; and
(c) provide end-to-end secure transmission using TLS, IPSec, or authenticated encryption with associated data (AEAD);
a processing unit configured to execute instructions stored in memory to:
(a) create Road User and Facility Owner accounts, each account comprising a secure digital wallet protected by cryptographic key management including multi-signature authentication, threshold cryptography, and secure enclave storage;
(b) retrieve digital currency for the Road User wallet from a Trip Exchange or fueling/charging station platform with consensus validation using a Byzantine Fault Tolerant (BFT) protocol, proof-of-stake mechanism, DAG milestone confirmation, or hashgraph virtual voting round, and verify inclusion using a Merkle proof, Verkle proof, or vector commitment proof, each proof constrained to ≤S bytes for efficient validation on in-vehicle and edge hardware;
(c) segment trips into jurisdictional segments using a Trip Manager, wherein segmentation comprises Hidden Markov Model (HMM) map-matching with Viterbi decoding over an R-tree-indexed road graph, Extended Kalman Filter sensor fusion of GNSS, complementary Position, Navigation, and Timing (PNT) sources, odometer readings, and inertial measurement unit (IMU) updates sampled at ≥100 Hz with GNSS corrections at ≥1 Hz, and polygon-based geofencing with polygon clipping at jurisdictional boundaries;
(d) bound memory and latency during segmentation by pruning candidate map-matching states to a beam width B, maintaining a fixed-capacity ring buffer of segment metadata≤Q kilobytes, thereby achieving per-fix latency≤T milliseconds;
(e) retrieve segment-specific RUC rate data from a DLT-registered RUC Rates Service, wherein each rate table is cryptographically hashed, version-controlled, and digitally signed by a Facility Owner;
(f) calculate digital currency amounts for each segment using a Coin Manager comprising an artificial intelligence (AI) or machine learning (ML) module trained on transportation, traffic, and payment data, wherein models include LSTM for congestion prediction, CNN for traffic-camera imaging, reinforcement learning for dynamic pricing, and gradient boosting frameworks for rate adjustment, executed under memory≤Q kilobytes and latency≤T milliseconds constraints to optimize real-time rate prediction and congestion detection;
(g) generate, by a Contract Manager, a smart contract for each segment encoded as deterministic fixed-size data structures with O(1) replay protection and compact Merkle proof settlement≤G units, thereby reducing gas cost and verification latency on distributed nodes;
(h) digitally sign smart contracts using an EIP-712 domain with replay protection, access control, and reentrancy protection;
(i) transmit smart contracts over the communication interface to DLT nodes for execution, wherein each transaction is immutably recorded and cryptographically anchored by state proofs; and
(j) adjust wallet balances of the Road User and Facility Owner accounts upon smart-contract execution, and store receipts, regulator-facing proofs, and alerts on the DLT network as immutable records;
wherein the system further comprises:
(a) a Road User interface configured to render segment-level costs, balances, refill requirements, and transaction records through a tamper-resistant component that validates data integrity using cryptographic state-proofs prior to display; and
(b) a Facility Owner interface configured to display jurisdictional earnings, segment-level traffic data, and expose regulator-facing zero-knowledge attestations validated against cryptographic state-proofs, ensuring compliance without personal data disclosure.

33. A non-transitory computer-readable medium storing instructions that, when executed by a network-connected computing device comprising a processing unit, a communication interface, and a distributed ledger storage subsystem, cause the computing device to perform a method for facilitating collection of Road User Charges (RUC) by securely executing jurisdiction-specific digital currency transactions with bounded memory, latency, and cryptographic verification on a Distributed Ledger Technology (DLT) network selected from a blockchain, a directed acyclic graph (DAG), or a hashgraph, the method comprising:
a) receiving Road User and Facility Owner digital data associated with cryptographically secure unique identifiers;
b) creating secure digital wallets for the Road User and Facility Owner accounts, each wallet protected using cryptographic key management including multi-signature authentication, threshold cryptography, or secure enclave storage;
c) retrieving digital currency for the Road User wallet from a Trip Exchange or fueling/charging station platform with consensus validation by one of: a Byzantine Fault Tolerant (BFT) protocol, proof-of-stake mechanism, DAG milestone confirmation, or hashgraph gossip and virtual voting, and verifying inclusion using a Merkle proof, Verkle proof, or vector commitment proof, with proof structures bounded to ≤S bytes for verification on constrained in-vehicle devices;
d) segmenting a trip into jurisdictional segments using a Trip Manager executing Hidden Markov Model (HMM) map-matching with Viterbi decoding, Extended Kalman Filter sensor fusion combining GNSS, complementary PNT inputs, odometer readings, and IMU updates at ≥100 Hz with GNSS corrections at ≥1 Hz, and polygon-based geofencing with polygon clipping at jurisdictional boundaries, wherein candidate states are pruned to a beam width B and stored in a fixed-capacity ring buffer≤Q kilobytes to maintain per-fix latency≤T milliseconds;
e) retrieving cryptographically hashed and version-controlled RUC rate data from a DLT-registered RUC Rates Service;
f) calculating segment-specific digital currency amounts using a Coin Manager incorporating an AI/ML module trained on historical and real-time transportation, traffic, and payment data, wherein models comprise recurrent neural networks for congestion prediction, convolutional neural networks for roadway imaging, reinforcement learning agents for dynamic rate optimization, and gradient boosting frameworks for rate adjustment, each model constrained to inference≤T milliseconds and memory≤Q kilobytes to improve performance of in-vehicle hardware and reduce processing overhead;
g) generating smart contracts for each segment encoded as deterministic fixed-size data structures with explicit fields including segment ID, geofence hash, route commitment hash or Merkle root, rate version, calculated amount, timestamp, and nonce, wherein per-segment nonces are managed in a ring buffer enabling O(1) replay checks, and settlement accepts a compact Merkle proof of the committed route reducing verification gas to ≤G units;
h) digitally signing smart contracts using cryptographic signatures with replay protection, access control, and reentrancy protection;
i) transmitting smart contracts to the DLT network for execution and immutably recording results with consensus state proofs; and
j) adjusting wallet balances and recording regulator-facing audit trails, alerts, and receipts on the DLT network, wherein privacy-preserving attestations are encoded using homomorphic encryption or zero-knowledge proofs validated against cryptographic state-proofs, thereby preserving privacy while enabling regulator verification.
